(19) United States
(12) Patent Application Publication
(10) Pub. No.: US 2023/0097814 A1
(43) Pub. Date: Mar. 30, 2023

(54) COMPOSITIONS AND METHODS FOR THE RECOVERY OF OIL UNDER HARSH CONDITIONS

(71) Applicants: CHEVRON U.S.A. INC., San Ramon, CA (US); CHEVRON ORONITE COMPANY LLC, San Ramon, CA (US)

(72) Inventors: Gayani W. PINNAWALA, San Ramon, CA (US); Nabijan NIZAMIDIN, San Ramon, CA (US); Varadarajan DWARAKANATH, San Ramon, CA (US); Guo-Qing TANG, San Ramon, CA (US); Aaron WILHELM, San Ramon, CA (US); Scott P. WEST, San Ramon, CA (US)

(21) Appl. No.: 17/795,059

(22) PCT Filed: Jan. 25, 2021
(86) PCT No.: PCT/US2021/014911

§ 371 Date: Jul. 25, 2022

Related U.S. Application Data
(60) Provisional application No. 62/965,046, filed on Jan. 23, 2020.
(60) Provisional application No. 62/965,068, filed on Jan. 23, 2020.

(51) Int. Cl. C09K 8/584; C09K 23/02; C09K 23/34; C09K 23/56

(52) U.S. Cl. CPC C09K 8/584; C09K 23/02; C09K 23/34; C09K 23/56

(57) ABSTRACT

Described herein are surfactant compositions for use in oil and gas operations. The surfactant compositions are stable under harsh conditions, including in formations that exhibit high salinity, high temperature, and/or high H2S concentration. Also provided are methods of using these compositions. Specifically an aqueous composition comprising: (i) a surfactant package, wherein the surfactant package comprises: (a) a surfactant comprising a branched, unbranched, saturated, or unsaturated C6-C32:80(0-65):PO(0-65):EO(0-100)-X having a concentration within the aqueous composition of from 0.05%-5% by weight, based on the total weight of the aqueous composition, wherein there is at least one BO, PO, or EO group, and wherein X comprises a sulfonate, a disulfonate, a carboxylate, a dicarboxylate, a sulfosuccinate, a disulfosuccinate, or hydrogen: and (b) olefin sulfonate and/or a disulfonate; and (ii) water.

### CROSS REFERENCES TO RELATED APPLICATIONS

This application claims benefit of priority to U.S. Provisional Application No. 62/965,046 filed Jan. 23, 2020 and U.S. Provisional Application No. 62/965,068 filed Jan. 23, 2020, which is incorporated herein by reference herein in its entirety.

### TECHNICAL FIELD

The present disclosure generally relates to aqueous compositions that remain stable in harsh environments, and methods of injecting these aqueous compositions into a subterranean reservoir, for example, as part of an enhanced oil recovery operation.

### BACKGROUND

Reservoir systems, such as petroleum reservoirs, typically contain fluids such as water and hydrocarbons (such as oil and gas). To remove (“produce”) the hydrocarbons from the reservoir, different mechanisms can be utilized including primary, secondary or tertiary processes, fracturing, stimulation, etc. For example, in a primary recovery process, hydrocarbons are displaced from a reservoir through the high natural differential pressure between the reservoir and the bottom-hole pressure within a wellbore. In order to increase the production life of the reservoir, secondary or tertiary recovery processes can be used (“enhanced oil recovery” or EOR). Secondary recovery processes include water or gas well injection, while tertiary methods are based on injecting additional chemical compounds into the well, such as surfactants/solvents and polymers, for additional recovery. The surfactants/solvents free oil trapped in the pores of the reservoir rock, facilitate its production.

There remains a need for improved compositions and methods for the production of hydrocarbons, particularly in the case of recovery from formations that exhibit harsh conditions.

### SUMMARY

Described herein are aqueous compositions that remain stable in harsh environments, and methods of injecting these aqueous compositions into a subterranean reservoir, for example, as part of an enhanced oil recovery operation.

In some embodiments, provided herein are aqueous compositions comprising (i) a surfactant package and (ii) water.

In some embodiments, the surfactant package includes (a) a surfactant comprising a branched, unbranched, saturated, or unsaturated C6-C32:BO(0-65):PO(0-65):EO(0-100)-X having a concentration within the aqueous composition of from 0.05%-5% by weight, based on the total weight of the aqueous composition, wherein there is at least one BO, PO, or EO group, and wherein X comprises a sulfonate, a disulfonate, a carboxylate, a dicarboxylate, a sulfosuccinate, a disulfosuccinate, or hydrogen; and (b) olefin sulfonate having a concentration within the aqueous composition of from 0.05%-5% by weight, based on the total weight of the aqueous composition. In some embodiments, the aqueous composition comprises at least 5,000 ppm total dissolved solids (TDS) and exhibits a solubilization parameter of from 3 to 25 at an optimum salinity in response to contact with hydrocarbons comprising H₂S of at least 0.5 mol %.

In some embodiments, the aqueous composition further includes an alkyl aryl sulfonate, a cationic surfactant, a zwitterionic surfactant, an amphoteric surfactant, a gemini surfactant, an alkyl benzene sulfonate (ABS), a disulfonate surfactant, an alkyl polyglucoside, an alkyl polyglucoside carboxylate, a second olefin sulfonate, a second surfactant with branched, unbranched, saturated, or unsaturated C6-C32:BO(0-65):PO(0-65):EO(0-100)-X, or any combination thereof. In some embodiments, the aqueous composition comprises at least 30,000 ppm TDS and exhibits the solubilization parameter of from 3 to 25 at the optimum salinity in response to contact with the hydrocarbons comprising the H₂S of at least 0.5 mol %.

In some embodiments, the surfactant package includes (a) a surfactant comprising a branched, unbranched, saturated, or unsaturated C6-C32:BO(0-65):PO(0-65):EO(0-100)-X having a concentration within the aqueous composition of from 0.05%-5% by weight, based on the total weight of the aqueous composition, wherein there is at least one BO, PO, or EO group, and wherein X comprises a sulfonate, a disulfonate, a carboxylate, a dicarboxylate, a sulfosuccinate, a disulfosuccinate, or hydrogen; and (b) a disulfonate having a concentration within the aqueous composition of from 0.05%-5% by weight, based on a total weight of the aqueous composition, wherein the disulfonate is defined by the formula below:

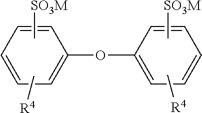

wherein

R⁴ is present in at least one ring;

R⁴ is, individually for each occurrence, a branched or unbranched, saturated or unsaturated, cyclic or non-cyclic, hydrophobic carbon chain having 6-32 carbon atoms; and

M represents a counterion.

In some other embodiments, the surfactant package includes (a) a surfactant comprising a branched, unbranched, saturated, or unsaturated C6-C32:BO(0-65):PO(0-65):EO(0-100)-X having a concentration within the aqueous composition of from 0.05%-5% by weight, based on the total weight of the aqueous composition, wherein there is at least one BO, PO, or EO group, and wherein X comprises a sulfonate, a disulfonate, a carboxylate, a dicarboxylate, a sulfosuccinate, a disulfosuccinate, or hydrogen; (b) olefin sulfonate having a concentration within the aqueous composition of from 0.05%-5% by weight, based on the total weight of the aqueous composition; and (c) a disulfonate having a concentration within the aqueous composition of from 0.05%-5% by weight, based on a total weight of the aqueous composition, wherein the disulfonate is defined by the formula below:

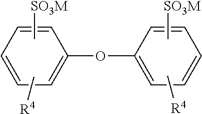

wherein

R⁴ is present in at least one ring;

R⁴ is, individually for each occurrence, a branched or unbranched, saturated or unsaturated, cyclic or non-cyclic, hydrophobic carbon chain having 6-32 carbon atoms; and

M represents a counterion.

In some embodiments, the aqueous composition comprises at least 30,000 ppm total dissolved solids (TDS) and exhibits a solubilization parameter of from 3 to 25 at an optimum salinity in response to contact with hydrocarbons comprising H₂S of at least 0.5 mol %

In some embodiments, the solubilization parameter of from 3 to 25 at the optimum salinity is at a temperature of at least 25° C.

In some embodiments, the surfactant comprises average BO groups of from 0-10, of from 0-15, of from 0-20, of from 0-25, of from 0-30, of from 0-35, of from 0-40, or of from 0-45, of from 0-50, of from 0-55, or of from 0-60; average PO groups of from 0-10, of from 0-15, of from 0-20, of from 0-25, of from 0-30, of from 0-35, of from 0-40, or of from 0-45, of from 0-50, of from 0-55, or of from 0-60; average EO groups of from 0-10, of from 0-15, of from 0-20, of from 0-25, of from 0-30, of from 0-35, of from 0-40, of from 0-45, of from 0-50, of from 0-55, of from 0-60, of from 0-65, of from 0-70, of from 0-75, of from 0-80, of from 0-85, of from 0-90, of from 0-95; or any combination thereof.

In some embodiments, aqueous composition further including an alkyl aryl sulfonate, a cationic surfactant, a zwitterionic surfactant, an amphoteric surfactant, a gemini surfactant, an alkyl benzene sulfonate (ABS), a second disulfonate surfactant with at least one different R⁴ group, an alkyl polyglucoside, an alkyl polyglucoside carboxylate, a second olefin sulfonate, a second surfactant with branched, unbranched, saturated, or unsaturated C6-C32:BO(0-65):PO(0-65):EO(0-100)-X, or any combination thereof.

In some embodiments, the TDS is from 5,000 ppm TDS-100,000 ppm TDS, from 5,000 ppm TDS-90,000 ppm TDS, from 5,000 ppm TDS-80,000 ppm TDS, from 5,000 ppm TDS-70,000 ppm TDS, from 5,000 ppm TDS-60,000 ppm TDS, from 5,000 ppm TDS-50,000 ppm TDS, from 5,000 ppm TDS-40,000 ppm TDS, from 5,000 ppm TDS-30,000 ppm TDS, from 5,000 ppm TDS-20,000 ppm TDS, from 5,000 ppm TDS-10,000 ppm TDS, from 5,000 ppm TDS-75,000 ppm TDS, from 5,000 ppm TDS-25,000 ppm TDS, from 50,000 ppm TDS-100,000 ppm TDS, or from 50,000 ppm TDS-80,000 ppm TDS.

In some embodiments, the TDS is from 30,000 ppm TDS-300,000 ppm TDS, from 50,000 ppm TDS-300,000 ppm TDS, from 75,000 ppm TDS-300,000 ppm TDS, from 100,000 ppm TDS-300,000 ppm TDS, from 125,000 ppm TDS-300,000 ppm TDS, from 150,000 ppm TDS-300,000 ppm TDS, from 175,000 ppm TDS-300,000 ppm TDS, from 200,000 ppm TDS-300,000 ppm TDS, from 250,000 ppm TDS-300,000 ppm TDS, from 175,000 ppm TDS-200,000 ppm TDS, from 150,000 ppm TDS-250,000 ppm TDS, from 175,000 ppm TDS-250,000 ppm TDS, from 200,000 ppm TDS-250,000 ppm TDS, from 100,000 ppm TDS-200,000 ppm TDS, or from 50,000 ppm TDS-250,000 ppm TDS.

In some embodiments, the water includes hard water, hard brine, sea water, brackish water, fresh water, flowback or produced water, wastewater, river water, lake or pond water, aquifer water, brine, or any combination thereof. In some embodiments, the water includes from 0 ppm to 25,000 ppm of divalent metal ions chosen from Ca²⁺, Mg²⁺, Sr²⁺, Ba²⁺, and combinations thereof. In some embodiments, the water includes at least 10 ppm, at least 100 ppm, at least 500 ppm, at least 1,000 ppm, at least 5,000 ppm, or at least 10,000 ppm of divalent metal ions chosen from Ca²⁺, Mg²⁺, Sr²⁺, Ba²⁺, and combinations thereof.

In some embodiments, the aqueous composition further comprises a water-soluble polymer, one or more co-solvents, a borate-acid buffer, or any combination thereof. In some embodiments, the one or more co-solvents include a C1-C5 alcohol, an ethoxylated C1-C5 alcohol, a glycol ether, or any combination thereof. In some embodiments, the one or more co-solvents have a concentration within the composition of from 0.02% to 5% by weight, based on the total weight of the aqueous composition.

In some embodiments, the borate-acid buffer is present in the aqueous composition in an amount of from 0.05% to 5% by weight, or of from 0.5% to 2% by weight, based on the total weight of the aqueous composition. In some embodiments, the borate-acid buffer exhibits a capacity to buffer at a pH below a point of zero charge of a subterranean formation comprising the hydrocarbons. In some embodiments, the borate-acid buffer exhibits a capacity to buffer at a pH of from 6.0 to 8.0, such as a pH of from 6.0 to 7.5, a pH of from 6.5 to 7.5, a pH of from 6.0 to 7.0, or a pH of from 6.5 to 7.0. In some embodiments, the borate-acid buffer comprises a borate compound and a conjugate base of an acid. In some embodiments, the borate compound comprises sodium tetraborate, calcium tetraborate, sodium borate, sodium metaborate, or any combination thereof. In some embodiments, the conjugate base comprises acetate, citrate, tartrate, succinate, or any combination thereof. In some embodiments, the borate compound and the conjugate base of the organic acid are present at a weight ratio of from 1:1 to 5:1.

In some embodiments, the borate-acid buffer comprises a boric acid and an alkali, wherein the alkali comprises an acetate salt, a citrate salt, a tartrate salt, a hydroxide salt, a succinate salt, or any combination thereof.

In some embodiments, the temperature of the formation is from 25° C.-150° C., from 30° C.-150° C., from 40° C.-150° C., from 50° C.-150° C., from 60° C.-150° C., from 70° C.-150° C., from 80° C.-150° C., from 90° C.-150° C., from 100° C.-150° C., from 110° C.-150° C., from 120° C.-150° C., from 130° C.-150° C., from 140° C.-150° C., from 25° C.-120° C., from 25° C.-100° C., or from 25° C.-50° C. In other embodiments, the temperature of the formation can be 120° C. or greater, 150° C. or greater, or 180° C. or greater.

In some embodiments, the concentration of H₂S is from 0.5 mol %-50 mol %, from 0.5 mol %-45 mol %, from 0.5 mol %-40 mol %, from 0.5 mol %-35 mol %, from 0.5 mol %-30 mol %, from 0.5 mol %-25 mol %, from 0.5 mol %-20 mol %, from 0.5 mol %-15 mol %, from 0.5 mol %-10 mol %, from 0.5 mol %-9 mol %, from 0.5 mol %-8 mol %, from 0.5 mol %-7 mol %; from 0.5 mol %-6 mol %, from 0.5 mol %-5 mol %, from 0.5 mol %-4 mol %, from 0.5 mol %-3 mol %, from 0.5 mol %-2 mol %, from 0.5 mol %-1 mol %, from 5 mol %-20 mol %, or from 5 mol %-25 mol %.

In some embodiments, the aqueous composition is aqueous stable, chemically stable, and/or thermally stable for at least 7 days.

In some embodiments, the aqueous composition is a single-phase fluid. In some embodiments, the aqueous composition comprises a foam. In some embodiments, the aqueous composition further comprises a friction reducer, a gelling agent, a crosslinker, a breaker, a pH adjusting agent, a non-emulsifier agent, an iron control agent, a corrosion inhibitor, a scale inhibitor, a biocide, a clay stabilizing agent, or any combination thereof. In some embodiments, the pH adjusting agent comprises an acid, a base, or any combination thereof. In some embodiments, the aqueous composition further comprises an acid, such as at least 10% acid by weight. In some embodiments, the aqueous composition comprises slickwater. In some embodiments, the aqueous composition further comprises a wettability alteration chemical. In some embodiments, the aqueous composition is below optimum salinity.

Also provided herein are methods for treating a subterranean formation, the method including injecting an aqueous composition described herein into a subterranean formation through a wellbore in fluid communication with the subterranean formation.

In some embodiments, the method further including adding a tracer to the aqueous composition prior to introducing or along with the aqueous composition or through the wellbore into the subterranean formation; recovering the tracer from fluids produced from the subterranean formation through the wellbore, fluids recovered from a different wellbore in fluid communication with the subterranean formation, or any combination thereof, and comparing the quantity of tracer recovered from the fluids produced to the quantity of tracer introduced.

In some embodiments, the subterranean formation comprises an unconventional subterranean formation. In some embodiments, the unconventional subterranean formation has a permeability of less than 25 mD, such as a permeability of from 25 mD to 1.0×10⁻⁶ mD, from 10 mD to 1.0×10⁻⁶ mD, or from 10 to 0.1 millidarcy (mD).

In some embodiments, the method comprises a method for stimulating the subterranean formation that includes (a) injecting the aqueous composition through the wellbore into the subterranean formation; (b) allowing the aqueous composition to imbibe into a rock matrix of the subterranean formation for a period of time; and (c) producing fluids from the subterranean formation through the wellbore. In some embodiments, the method further includes ceasing introduction of the aqueous composition through the wellbore into the subterranean formation before allowing step (b). In some embodiments, the period of time is from one day to six months, such as from two weeks to one month.

In some embodiments, the injection of the aqueous composition increases a relative permeability in a region of the subterranean formation proximate to the wellbore. In some embodiments, the injection of the aqueous composition releases hydrocarbons from pores in a rock matrix in a region of the subterranean formation proximate to the existing wellbore. In some embodiments, the method remediates near wellbore damage.

In some embodiments, the aqueous composition is substantially free of proppant. In some embodiments, the method comprises stimulating a naturally fractured region, previously fractured region, previously refractured region, or any combination thereof of the subterranean formation proximate to a new wellbore or an existing wellbore.

In some embodiments, the subterranean formation comprises naturally fractured carbonate, naturally fractured sandstone, or any combination thereof.

In some embodiments, the method includes a method for fracturing the subterranean formation that includes (a) injecting the aqueous composition into the subterranean formation through the wellbore at a sufficient pressure to create or extend at least one fracture in a rock matrix of the subterranean formation in fluid communication with the wellbore.

In some embodiments, the aqueous composition further includes a proppant, and wherein exclusive of the proppant, the aqueous composition has a maximum particle size of less than 0.1 micrometers in diameter in particle size distribution measurements performed at a temperature and salinity of the subterranean formation.

In some embodiments, the method includes performing a fracturing operation on a region of the subterranean formation proximate to a new wellbore or an existing wellbore. In some embodiments, the method comprises performing a refracturing operation on a previously fractured region of the subterranean formation proximate to a new wellbore or an existing wellbore. In some embodiments, the method comprises performing a fracturing operation on a naturally fractured region of the unconventional subterranean formation proximate to a new wellbore or an existing wellbore.

In some embodiments, the method further includes producing fluids from the subterranean formation through the wellbore, wherein the fluids include the hydrocarbons. In some embodiments, the subterranean formation has a permeability of from 26 millidarcy to 40,000 millidarcy.

In some embodiments, the wellbore comprises an injection wellbore, and wherein the method comprises a method for hydrocarbon recovery that includes (a) injecting the aqueous composition through the injection wellbore into the subterranean formation; and (b) producing fluids from a production wellbore spaced apart from the injection wellbore a predetermined distance and in fluid communication with the subterranean formation. In some embodiments, the injection of the aqueous composition increases a flow of hydrocarbons to the production wellbore. In some embodiments, the method comprises an enhanced oil recovery (EOR) operation. In some embodiments, the EOR operation comprises a surfactant flooding operation, an AS flooding operation, a SP flooding operation, an ASP flooding operation, a conformance control operation, or any combination thereof.

Also provided are methods for treating a subterranean formation including injecting an aqueous composition comprising (i) a surfactant package described herein and (ii) water into the subterranean formation through a wellbore in fluid communication with the subterranean formation. In some embodiments, the subterranean formation includes a temperature in a temperature range of from 80° C. to 150° C. In some embodiments, the water injected into the subterranean formation through the wellbore comprises a salinity in a salinity range of from 50,000 ppm TDS to 300,000 ppm TDS. In some embodiments, the surfactant package exhibits a solubilization parameter of from 3 to 25 at an optimum salinity in the salinity range in response to contact with hydrocarbons.

### DESCRIPTION OF THE DRAWINGS

FIG. 1 is a picture of a Schlumberger Phase Behavior PVT Cell.

FIG. 2 is a solubilization plot for formulation 1 using oil #1 and brine #1 at 95° C. Aqueous stability ˜80,000 ppm TDS.

FIG. 3 is a solubilization plot for formulation 2 using oil #1 and brine #1 at 95° C. Aqueous stability ˜70,000 ppm TDS.

FIG. 4 is a graph showing the effect of IOS ratio on S* and SP.

FIG. 5 is a solubilization plot for formulation 7 using oil #1 and brine #2 at 110° C. Aqueous stability ˜85,000 ppm TDS.

FIG. 6 is a solubilization plot for formulation 8 with oil #1 and brine #2 at 110° C. Aqueous stability ˜115,000 ppm TDS.

FIG. 7 is a solubilization plot for formulation 9 with crude oil #1 and brine #3 at 110° C. Aqueous stability ˜135,000 ppm TDS.

FIG. 8A-8B: (8A) is a solubilization plot (8B) is a picture of the phase behavior tubes for formulation 10 with crude oil #1 and brine #3 at 110° C. Aqueous stability ˜125,000 ppm TDS.

FIG. 9 HPLC data using ELSD detector for AEC after 7 days expose to H2S at 120° C.

FIG. 10 HPLC data using DAD detector for di-sulfonate after 7 days expose to H2S at 120° C.

FIG. 11 HPLC data using ELSD detector for IOS after 7 days expose to H2S at 120° C.

FIG. 12 HPLC data using ELSD detector for nonionic surfactant #1 after 7 days expose to H2S at 120° C.

FIG. 13 HPLC data using ELSD detector for nonionic surfactant #2 after 7 days expose to H2S at 120° C.

FIG. 14 HPLC data using ELSD detector AOS after 7 days expose to H2S at 120° C.

FIG. 15 is a picture of surfactant samples appearance before and after 7 days expose to H2S at 120° C.

FIG. 16 is a solubilization plot for formulation 12 at 2.33 WOR, 110° C. and ambient pressure. Aqueous stability ˜55,000 ppm TDS.

FIG. 17 are images of a Schlumberger PVT cell loaded (left) and mixed and equilibrated 24 hours (right) with surfactant formulation 12, at 57,000 ppm TDS at 110° C.

FIG. 18 is a solubilization plot for formulation 12 at 2.33 WOR, 110° C. and 4,000 psia with live oil with Methane.

FIG. 19 is a solubilization plot for Phase Behavior for formulation 12 at 2.33 WOR, 110° C. and 7,000 psia with live with Methane.

FIG. 20 is a solubilization plot for Phase Behavior for formulation 12 at 2.33 WOR, 110° C. and 10,000 psia with live oil with methane.

FIG. 21 is a solubilization ratio for formulation 12 with live oil with methane at 55,000 ppm TDS 2.33 WOR, 110° C. as a function of pressure.

FIG. 22 is a solubilization ratio for formulation 12 with live oil with methane and two different H2S concentration at optimum TDS 2.33 WOR, 110° C. as a function of pressure

FIG. 23 is a graph showing the pH changes of solution presence of 17% H2S and 83% CH4 with pressure at 120° C.

FIG. 24 is a solubilization plot for formulation 12 in presence of acid (pH=3-4) at 2.33 WOR, 110° C.

FIG. 25 is a plot showing the results of a high salinity coreflood study using a formulation that included 0.35% Guerbet alkoxylated carboxylate, 0.2% olefin sulfonate, 0.8% Disulfonate, and 0.5% Guerbet alkoxylated alcohol. The slug injection salinity was 132,000 TDS (using ˜80% of brine #3).

Reference will now be made in detail to various embodiments, where like reference numerals designate corresponding parts throughout the several views. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatuses have not been described in detail so as not to unnecessarily obscure aspects of the embodiments.

### DETAILED DESCRIPTION

Definitions: Unless otherwise indicated, the abbreviations used herein have their conventional meaning within the chemical and geophysical arts.

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) can includes 10% and also includes 20%, and includes percentages in between 10% and 20%, unless explicitly stated otherwise herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B). The phrases “combinations thereof” and “any combinations thereof are used synonymously herein.

The term “oil solubilization ratio” is defined as the volume of oil solubilized divided by the volume of surfactant in microemulsion. All the surfactant is presumed to be in the microemulsion phase. The oil solubilization ratio is applied for Winsor type I and type III behavior. The volume of oil solubilized is found by reading the change between initial aqueous level and excess oil (top) interface level. The oil solubilization ratio is calculated as follows:

$${σ}_{o} = \frac{{V}_{o}}{{V}_{s}}$$

where σₒ is the oil solubilization ratio, Vₒ is the volume of oil solubilized, and Vₛ is the volume of surfactant.

The term “water solubilization ratio” is defined as the volume of water solubilized divided by the volume of surfactant in microemulsion. All the surfactant is presumed to be in the microemulsion phase. The water solubilization ratio is applied for Winsor type III and type II behavior. The volume of water solubilized is found by reading the change between initial aqueous level and excess water (bottom) interface level. The water solubilization parameter is calculated as follows:

$${σ}_{w} = \frac{{V}_{w}}{{V}_{s}}$$

where σ_{w} is the water solubilization ratio, V_{w} is the volume of oil solubilized, and Vₛ is the volume of surfactant.

The optimum solubilization ratio occurs where the oil and water solubilization ratios are equal. The coarse nature of phase behavior screening often does not include a data point at optimum, so the solubilization ratio curves are drawn for the oil and water solubilization ratio data and the intersection of these two curves is defined as the optimum. The following is true for the optimum solubilization ratio:

σ_{O}=σ_{W}=σ*

where σ* is the optimum solubilization ratio.

The oil and water solubilization parameters (Vo/Vs and Vw/Vs) can be plotted for a salinity range (i.e., by varying the salinity of the water) to form a solubilization plot. The Solubilization Parameter at a salinity concentration where the Optimal Salinity (S*) is at a value where the oil and water solubilization ratios are equal (i.e., intersection of curves of the oil and water solubilization parameters).

“Aqueous stable,” as used herein, refers to a solution whose soluble components remain dissolved and is a single phase as opposed to precipitating as particulates or phase separating into 2 or more phases. As such, aqueous stable solutions are clear and transparent statically and when agitated. Conversely, solutions may be described as “aqueous unstable” when components precipitate from solution as particulates or phase separates into 2 or more phases. The aqueous stability of solutions can be assessed by evaluating whether the Tyndall Effect (light scattering by suspended particulates) is observed when monochromatic light is directed through the solution. If a sample exhibits the Tyndall effect, the solution may be characterized as “aqueous unstable.” Conversely, if a sample does not exhibit the Tyndall effect, the solution may be characterized as “aqueous stable.” Aqueous stability is discuss further in PCT/US2018/044715, filed Jul. 31, 2018 (Attorney Docket No. 10467-026WO1 (CVX Ref.: T-10666A), filed Jul. 31, 2018 entitled “Injection Fluids Comprising Anionic Surfactants for Treating Unconventional Formations”); PCT/US2018/044707, filed Jul. 31, 2018 (Attorney Docket No. 10467-028W01 (CVX Ref.: T-10666B), filed Jul. 31, 2018 entitled “Injection Fluids Comprising Non-Ionic Surfactants for Treating Unconventional Formations”); and PCT/US2018/044716, filed Jul. 31, 2018 (Attorney Docket No. 10467-030WO1 (CVX Ref.: T-10666C), filed Jul. 31, 2018 entitled “Injection Fluids for Stimulating Fractured Formations”), all of which are hereby incorporated by reference.

“Thermally stable,” as used herein, refers to an aqueous composition and/or surfactant package that does not substantially degrade (e.g., degrades less 10%) under testing temperature for the duration of the test (e.g., at least one week). HPLC, NMR, aqueous stability, or any combination thereof may be utilized to determine if an aqueous composition is thermally stable.

“Chemically stable,” as used herein, refers to an aqueous composition and/or surfactant composition that does not have substantial changes to the molecular structure (e.g., less 10% changes in the molecular structure) under testing conditions (e.g., temperature condition, pH condition, salinity condition, H2S condition, etc.) for the duration of the test (e.g., at least one week). HPLC, NMR, aqueous stability, or any combination thereof may be utilized to determine if an aqueous composition is chemically stable.

The term “hydrocarbon” refers to a compound containing only carbon and hydrogen atoms.

“Hydrocarbon-bearing formation” or simply “formation” refers to the rock matrix in which a wellbore may be drilled. For example, a formation refers to a body of rock that is sufficiently distinctive and continuous such that it can be mapped. It should be appreciated that while the term “formation” generally refers to geologic formations of interest, that the term “formation,” as used herein, may, in some instances, include any geologic points or volumes of interest (such as a survey area). Hydrocarbon-bearing formations can be “unconventional formations” or “conventional formations.”

An “unconventional formation” is a subterranean hydrocarbon-bearing formation that generally requires intervention in order to recover hydrocarbons from the reservoir at economic flow rates or volumes. For example, an unconventional formation includes reservoirs having an unconventional microstructure in which fractures are used to recover hydrocarbons from the reservoir at sufficient flow rates or volumes (e.g., an unconventional reservoir generally needs to be fractured under pressure or have naturally occurring fractures in order to recover hydrocarbons from the reservoir at sufficient flow rates or volumes).

In some embodiments, the unconventional formation can include a reservoir having a permeability of less than 25 millidarcy (mD) (e.g., 20 mD or less, 15 mD or less, 10 mD or less, 5 mD or less, 1 mD or less, 0.5 mD or less, 0.1 mD or less, 0.05 mD or less, 0.01 mD or less, 0.005 mD or less, 0.001 mD or less, 0.0005 mD or less, 0.0001 mD or less, 0.00005 mD or less, 0.00001 mD or less, 0.000005 mD or less, 0.000001 mD or less, or less). In some embodiments, the unconventional formation can include a reservoir having a permeability of at least 0.000001 mD (e.g., at least 0.000005 mD, at least 0.00001 mD, 0.00005 mD, at least 0.0001 mD, 0.0005 mD, 0.001 mD, at least 0.005 mD, at least 0.01 mD, at least 0.05 mD, at least 0.1 mD, at least 0.5 mD, at least 1 mD, at least 5 mD, at least 10 mD, at least 15 mD, or at least 20 mD).

The unconventional formation can include a reservoir having a permeability ranging from any of the minimum values described above to any of the maximum values described above. For example, in some embodiments, the unconventional formation can include a reservoir having a permeability of from 0.000001 mD to 25 mD (e.g., from 0.001 mD to 25 mD, from 0.001 mD to 10 mD, from 0.01 mD to 10 mD, from 0.1 mD to 10 mD, from 0.001 mD to 5 mD, from 0.01 mD to 5 mD, or from 0.1 mD to 5 mD).

A “conventional formation” refers to a subterranean hydrocarbon-bearing formation having a higher permeability, such as a permeability of from 25 millidarcy to 40,000 millidarcy.

The formation may include faults, fractures (e.g., naturally occurring fractures, fractures created through hydraulic fracturing, etc.), geobodies, overburdens, underburdens, horizons, salts, salt welds, etc. The formation may be onshore, offshore (e.g., shallow water, deep water, etc.), etc. Furthermore, the formation may include hydrocarbons, such as liquid hydrocarbons (also known as oil or petroleum), gas hydrocarbons, any combination of liquid hydrocarbons and gas hydrocarbons (e.g. including gas condensate), etc.

The formation, the hydrocarbons, or both may also include non-hydrocarbon items, such as pore space, connate water, brine, fluids from enhanced oil recovery, etc. The formation may also be divided up into one or more hydrocarbon zones, and hydrocarbons can be produced from each desired hydrocarbon zone.

The term formation may be used synonymously with the term reservoir. For example, in some embodiments, the reservoir may be, but is not limited to, a shale reservoir, a carbonate reservoir, a tight sandstone reservoir, a tight siltstone reservoir, a gas hydrate reservoir, a coalbed methane reservoir, etc. Indeed, the terms “formation,” “reservoir,” “hydrocarbon,” and the like are not limited to any description or configuration described herein.

“Wellbore” refers to a continuous hole for use in hydrocarbon recovery, including any openhole or uncased portion of the wellbore. For example, a wellbore may be a cylindrical hole drilled into the formation such that the wellbore is surrounded by the formation, including rocks, sands, sediments, etc. A wellbore may be used for injection. A wellbore may be used for production. A wellbore may be used for hydraulic fracturing of the formation. A wellbore even may be used for multiple purposes, such as injection and production. The wellbore may have vertical, inclined, horizontal, or any combination of trajectories. For example, the wellbore may be a vertical wellbore, a horizontal wellbore, a multilateral wellbore, or slanted wellbore. The wellbore may include a “build section.” “Build section” refers to practically any section of a wellbore where the deviation is changing. As an example, the deviation is changing when the wellbore is curving. The wellbore may include a plurality of components, such as, but not limited to, a casing, a liner, a tubing string, a heating element, a sensor, a packer, a screen, a gravel pack, etc. The wellbore may also include equipment to control fluid flow into the wellbore, control fluid flow out of the wellbore, or any combination thereof. For example, each wellbore may include a wellhead, a BOP, chokes, valves, or other control devices. These control devices may be located on the surface, under the surface (e.g., downhole in the wellbore), or any combination thereof. The wellbore may also include at least one artificial lift device, such as, but not limited to, an electrical submersible pump (ESP) or gas lift. Some non-limiting examples of wellbores may be found in U.S. Patent Application Publication No. 2014/0288909 (Attorney Dkt. No. T-9407) and U.S. Patent Application Publication No. 2016/0281494A1 (Attorney Dkt. No. T-10089), each of which is incorporated by reference in its entirety. The term wellbore is not limited to any description or configuration described herein. The term wellbore may be used synonymously with the terms borehole or well.

The term “enhanced oil recovery” refers to techniques for increasing the amount of unrefined petroleum (e.g., crude oil) that may be extracted from an oil reservoir (e.g., an oil field). Using EOR, 40-60% of the reservoir's original oil can typically be extracted compared with only 20-40% using primary and secondary recovery (e.g., by water injection or natural gas injection). Enhanced oil recovery may also be referred to as improved oil recovery or tertiary oil recovery (as opposed to primary and secondary oil recovery). Examples of EOR operations include, for example, miscible gas injection (which includes, for example, carbon dioxide flooding), chemical injection (sometimes referred to as chemical enhanced oil recovery (CEOR), and which includes, for example, polymer flooding, alkaline flooding, surfactant flooding, conformance control operations, as well as combinations thereof such as alkaline-polymer flooding or alkaline-surfactant-polymer flooding), microbial injection, and thermal recovery (which includes, for example, cyclic steam, steam flooding, and fire flooding). In some embodiments, the EOR operation can include a polymer (P) flooding operation, an alkaline-polymer (AP) flooding operation, a surfactant-polymer (SP) flooding operation, an alkaline-surfactant-polymer (ASP) flooding operation, a conformance control operation, or any combination thereof. The terms “operation” and “application” may be used interchangeability herein, as in EOR operations or EOR applications.

“Low particle size injection fluid” refers to an injection fluid having a maximum particle size of less than 0.1 micrometers in diameter in particle size distribution measurements performed at a temperature and salinity of the unconventional formation for which injection is to occur. For example, the low particle size injection fluid can be formed by mixing an aqueous-based injection fluid with a surfactant package described herein. Prior to being dosed with the surfactant package to form the low particle size injection fluid, the aqueous-based injection fluid may have been used as the injection fluid.

“Fracturing” is one way that hydrocarbons may be recovered (sometimes referred to as produced) from the formation. For example, hydraulic fracturing may entail preparing a fracturing fluid and injecting that fracturing fluid into the wellbore at a sufficient rate and pressure to open existing fractures and/or create fractures in the formation. The fractures permit hydrocarbons to flow more freely into the wellbore. In the hydraulic fracturing process, the fracturing fluid may be prepared on-site to include at least proppants. The proppants, such as sand or other particles, are meant to hold the fractures open so that hydrocarbons can more easily flow to the wellbore. The fracturing fluid and the proppants may be blended together using at least one blender. The fracturing fluid may also include other components in addition to the proppants.

The wellbore and the formation proximate to the wellbore are in fluid communication (e.g., via perforations), and the fracturing fluid with the proppants is injected into the wellbore through a wellhead of the wellbore using at least one pump (oftentimes called a fracturing pump). The fracturing fluid with the proppants is injected at a sufficient rate and pressure to open existing fractures and/or create fractures in the subsurface volume of interest. As fractures become sufficiently wide to allow proppants to flow into those fractures, proppants in the fracturing fluid are deposited in those fractures during injection of the fracturing fluid. After the hydraulic fracturing process is completed, the fracturing fluid is removed by flowing or pumping it back out of the wellbore so that the fracturing fluid does not block the flow of hydrocarbons to the wellbore. The hydrocarbons will typically enter the same wellbore from the formation and go up to the surface for further processing.

The equipment to be used in preparing and injecting the fracturing fluid may be dependent on the components of the fracturing fluid, the proppants, the wellbore, the formation, etc. However, for simplicity, the term “fracturing apparatus” is meant to represent any tank(s), mixer(s), blender(s), pump(s), manifold(s), line(s), valve(s), fluid(s), fracturing fluid component(s), proppants, and other equipment and non-equipment items related to preparing the fracturing fluid and injecting the fracturing fluid.

Other hydrocarbon recovery processes may also be utilized to recover the hydrocarbons. Furthermore, those of ordinary skill in the art will appreciate that one hydrocarbon recovery process may also be used in combination with at least one other recovery process or subsequent to at least one other recovery process. Moreover, hydrocarbon recovery processes may also include stimulation or other treatments.

“Fracturing fluid,” as used herein, refers to an injection fluid that is injected into the well under pressure in order to cause fracturing within a portion of the reservoir.

The term “interfacial tension” or “IFT” as used herein refers to the surface tension between test oil and water of different salinities containing a surfactant formulation at different concentrations. Typically, interfacial tensions are measured using a spinning drop tensiometer or calculated from phase behavior experiments.

The term “proximate” is defined as “near”. If item A is proximate to item B, then item A is near item B. For example, in some embodiments, item A may be in contact with item B. For example, in some embodiments, there may be at least one barrier between item A and item B such that item A and item B are near each other, but not in contact with each other. The barrier may be a fluid barrier, a non-fluid barrier (e.g., a structural barrier), or any combination thereof. Both scenarios are contemplated within the meaning of the term “proximate.”

The term “contacting” as used herein, refers to materials or compounds being sufficiently close in proximity to react or interact. For example, in methods of contacting a foam, an emulsion or any combination thereof with a breaking composition, the method can include combining the foam, the emulsion or any combination thereof with the breaking composition any suitable manner known in the art (e.g., pumping, injecting, pouring, releasing, displacing, spotting or circulating the breaking composition into a vessel, pipeline, holding tank, separator, pipe, wellbore, or formation containing the foam, the emulsion, or any combination thereof).

The terms “unrefined petroleum” and “crude oil” are used interchangeably and in keeping with the plain ordinary usage of those terms. “Unrefined petroleum” and “crude oil” may be found in a variety of petroleum reservoirs (also referred to herein as a “reservoir,” “oil field deposit” “deposit” and the like) and in a variety of forms including oleaginous materials, oil shales (i.e., organic-rich fine-grained sedimentary rock), tar sands, light oil deposits, heavy oil deposits, and the like. “Crude oils” or “unrefined petroleums” generally refer to a mixture of naturally occurring hydrocarbons that may be refined into diesel, gasoline, heating oil, jet fuel, kerosene, and other products called fuels or petrochemicals. Crude oils or unrefined petroleums are named according to their contents and origins, and are classified according to their per unit weight (specific gravity). Heavier crudes generally yield more heat upon burning, but have lower gravity as defined by the American Petroleum Institute (API) (i.e., API gravity) and market price in comparison to light (or sweet) crude oils. Crude oil may also be characterized by its Equivalent Alkane Carbon Number (EACN). The term “API gravity” refers to the measure of how heavy or light a petroleum liquid is compared to water. If an oil's API gravity is greater than 10, it is lighter and floats on water, whereas if it is less than 10, it is heavier and sinks. API gravity is thus an inverse measure of the relative density of a petroleum liquid and the density of water. API gravity may also be used to compare the relative densities of petroleum liquids. For example, if one petroleum liquid floats on another and is therefore less dense, it has a greater API gravity.

Crude oils vary widely in appearance and viscosity from field to field. They range in color, odor, and in the properties they contain. While all crude oils are mostly hydrocarbons, the differences in properties, especially the variation in molecular structure, determine whether a crude oil is more or less easy to produce, pipeline, and refine. The variations may even influence its suitability for certain products and the quality of those products. Crude oils are roughly classified into three groups, according to the nature of the hydrocarbons they contain. (i) Paraffin-based crude oils contain higher molecular weight paraffins, which are solid at room temperature, but little or no asphaltic (bituminous) matter. They can produce high-grade lubricating oils. (ii) Asphaltene based crude oils contain large proportions of asphaltic matter, and little or no paraffin. Some are predominantly naphthenes and so yield lubricating oils that are sensitive to temperature changes than the paraffin-based crudes. (iii) Mixed based crude oils contain both paraffin and naphthenes, as well as aromatic hydrocarbons. Most crude oils fit this latter category.

“Reactive” crude oil, as referred to herein, is crude oil containing natural organic acidic components (also referred to herein as unrefined petroleum acid) or their precursors such as esters or lactones. These reactive crude oils can generate soaps (carboxylates) when reacted with alkali. More terms used interchangeably for crude oil throughout this disclosure are hydrocarbons, hydrocarbon material, or active petroleum material. An “oil bank” or “oil cut” as referred to herein, is the crude oil that does not contain the injected chemicals and is pushed by the injected fluid during an enhanced oil recovery process. A “nonactive oil,” as used herein, refers to an oil that is not substantially reactive or crude oil not containing significant amounts of natural organic acidic components or their precursors such as esters or lactones such that significant amounts of soaps are generated when reacted with alkali. A nonactive oil as referred to herein includes oils having an acid number of less than 0.5 mg KOH/g of oil.

“Unrefined petroleum acids” as referred to herein are carboxylic acids contained in active petroleum material (reactive crude oil). The unrefined petroleum acids contain C₁₁-C₂₀ alkyl chains, including napthenic acid mixtures. The recovery of such “reactive” oils may be performed using alkali (e.g., NaOH or Na₂CO₃) in a surfactant composition. The alkali reacts with the acid in the reactive oil to form soap in situ. These in situ generated soaps serve as a source of surfactants minimizing the levels of added surfactants, thus enabling efficient oil recovery from the reservoir.

The term “polymer” refers to a molecule having a structure that essentially includes the multiple repetitions of units derived, actually or conceptually, from molecules of low relative molecular mass. In some embodiments, the polymer is an oligomer.

The term “solubility” or “solubilization” in general refers to the property of a solute, which can be a solid, liquid or gas, to dissolve in a solid, liquid or gaseous solvent thereby forming a homogenous solution of the solute in the solvent. Solubility occurs under dynamic equilibrium, which means that solubility results from the simultaneous and opposing processes of dissolution and phase joining (e.g., precipitation of solids). The solubility equilibrium occurs when the two processes proceed at a constant rate. The solubility of a given solute in a given solvent typically depends on temperature. For many solids dissolved in liquid water, the solubility increases with temperature. In liquid water at high temperatures, the solubility of ionic solutes tends to decrease due to the change of properties and structure of liquid water. In more particular, solubility and solubilization as referred to herein is the property of oil to dissolve in water and vice versa.

“Viscosity” refers to a fluid's internal resistance to flow or being deformed by shear or tensile stress. In other words, viscosity may be defined as thickness or internal friction of a liquid. Thus, water is “thin”, having a lower viscosity, while oil is “thick”, having a higher viscosity. More generally, the less viscous a fluid is, the greater its ease of fluidity.

The term “salinity” as used herein, refers to concentration of salt dissolved in an aqueous phases. Examples for such salts are without limitation, sodium chloride, magnesium and calcium sulfates, and bicarbonates. In more particular, the term salinity as it pertains to the present invention refers to the concentration of salts in brine and surfactant solutions.

The term “co-solvent,” as used herein, refers to a compound having the ability to increase the solubility of a solute (e.g., a surfactant as disclosed herein) in the presence of an unrefined petroleum acid. In some embodiments, the co-solvents provided herein have a hydrophobic portion (alkyl or aryl chain), a hydrophilic portion (e.g., an alcohol) and optionally an alkoxy portion. Co-solvents as provided herein include alcohols (e.g., C₁-C₆ alcohols, C₁-C₆ diols), alkoxy alcohols (e.g., C₁-C₆ alkoxy alcohols, C₁-C₆ alkoxy diols, and phenyl alkoxy alcohols), glycol ether, glycol and glycerol. The term “alcohol” is used according to its ordinary meaning and refers to an organic compound containing an —OH groups attached to a carbon atom. The term “diol” is used according to its ordinary meaning and refers to an organic compound containing two —OH groups attached to two different carbon atoms. The term “alkoxy alcohol” is used according to its ordinary meaning and refers to an organic compound containing an alkoxy linker attached to a —OH group

The phrase “surfactant package,” as used herein, refers to one or more surfactants which are present in a composition.

The term “alkyl,” as used herein, refers to saturated straight, branched, cyclic, primary, secondary or tertiary hydrocarbons, including those having 1 to 32 atoms. In some embodiments, alkyl groups will include C₁-C₃₂, C₇-C₃₂, C₇-C₂₈, C₁₂-C₂₈, C₁₂-C₂₂, C₁-C₁₂, C₁-C₁₀, C₁-C₈, C₁-C₆, C₁-C₅, C₁-C₄, C₁-C₃, C₁-C₂, or C₁ alkyl groups. Examples of C₁-C₁₀ alkyl groups include, but are not limited to, methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-I-methylpropyl, 1-ethyl-2-methylpropyl, heptyl, octyl, 2-ethylhexyl, nonyl and decyl groups, as well as their isomers. Examples of C1-C4-alkyl groups include, for example, methyl, ethyl, propyl, 1-methylethyl, butyl, 1-methylpropyl, 2-methylpropyl and 1,1-dimethylethyl groups.

Cyclic alkyl groups or “cycloalkyl” groups, as used herein, include cycloalkyl groups having from 3 to 10 carbon atoms. Cycloalkyl groups can include a single ring, or multiple condensed rings. In some embodiments, cycloalkyl groups include C₃-C₄, C₄-C₇, C₅-C₇, C₄-C₆, or C₅-C₆ cyclic alkyl groups. Non-limiting examples of cycloalkyl groups include adamantyl, cyclopropyl, cyclobutyl, cyclopentyl, cyclohexyl, cycloheptyl, cyclooctyl and the like.

Alkyl groups can be unsubstituted or substituted with one or more moieties selected from the group consisting of alkyl, alkenyl, halo, haloalkyl, hydroxyl, carboxyl, acyl, acyloxy, amino, alkyl- or dialkylamino, amido, arylamino, alkoxy, aryloxy, nitro, cyano, ester, aryl, or any other viable functional group that is permitted by valence and does not compromise stability.

Terms including the term “alkyl,” such as “alkylcycloalkyl,” “cycloalkylalkyl,” “alkylaryl,” or “arylalkyl,” will be understood to comprise an alkyl group as defined above linked to another functional group, where the group is linked to the compound through the last group listed, as understood by those of skill in the art.

The term “alkenyl,” as used herein, refers to both straight and branched carbon chains which have at least one carbon-carbon double bond. In some embodiments, alkenyl groups can include C₂-C₃₂ alkenyl groups. In other embodiments, alkenyl can include C₇-C₃₂, C₇-C₂₈, C₅-C₂₈, C₁₂-C₂₈, or C₁₂-C₂₂ alkenyl groups. In one embodiment of alkenyl, the number of double bonds is 1-3, in another embodiment of alkenyl, the number of double bonds is one or two. Other ranges of carbon-carbon double bonds and carbon numbers are also contemplated depending on the location of the alkenyl moiety on the molecule. “C₂-C₁₀-alkenyl” groups may include more than one double bond in the chain. The one or more unsaturations within the alkenyl group may be located at any position(s) within the carbon chain as valence permits. In some embodiments, when the alkenyl group is covalently bound to one or more additional moieties, the carbon atom(s) in the alkenyl group that are covalently bound to the one or more additional moieties are not part of a carbon-carbon double bond within the alkenyl group. Examples of alkenyl groups include, but are not limited to, ethenyl, 1-propenyl, 2-propenyl, 1-methyl-ethenyl, 1-butenyl, 2-butenyl, 3-butenyl, 1-methyl-1-propenyl, 2-methyl-1-propenyl, 1-methyl-2-propenyl, 2-methyl-2-propenyl; 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl and 1-ethyl-2-methyl-2-propenyl groups.

The term “aryl,” as used herein, refers to a monovalent aromatic carbocyclic group of from 6 to 14 carbon atoms. Aryl groups can include a single ring or multiple condensed rings. In some embodiments, aryl groups include C₆-C₁₀ aryl groups. Aryl groups include, but are not limited to, phenyl, biphenyl, naphthyl, tetrahydronaphtyl, phenylcyclopropyl and indanyl. Aryl groups may be unsubstituted or substituted by one or more moieties selected from alkyl, alkenyl, halo, haloalkyl, hydroxyl, carboxyl, acyl, acyloxy, amino, alkyl- or dialkylamino, amido, arylamino, alkoxy, aryloxy, nitro, cyano, ester, aryl, or any other viable functional group that is permitted by valence and does not compromise stability.

The term “alkylaryl,” as used herein, refers to an aryl group that is bonded to a parent compound through a diradical alkylene bridge, (—CH₂-)ₙ, where n is 1-12 and where “aryl” is as defined above.

The term “alkylcycloalkyl,” as used herein, refers to a cycloalkyl group that is bonded to a parent compound through a diradical alkylene bridge, (—CH₂-)ₙ, where n is 1-12 and where “cycloalkyl” is as defined above. The term “cycloalkylalkyl,” as used herein, refers to a cycloalkyl group, as defined above, which is substituted by an alkyl group, as defined above.

Injection fluid,” as used herein, refers to any fluid which is injected into a reservoir via a well. The injection fluid may include one or more of an acid, a polymer, a friction reducer, a gelling agent, a crosslinker, a scale inhibitor, a breaker, a pH adjusting agent, a non-emulsifier agent, an iron control agent, a corrosion inhibitor, a biocide, a clay stabilizing agent, a proppant, a wettability alteration chemical, a co-solvent (e.g., a C1-C5 alcohol, or an alkoxylated C1-C5 alcohol), or any combination thereof, to increase the efficacy of the injection fluid. In some embodiments, the injection fluid can be a low-particle size injection fluid as described below.

The phrase “surfactant package,” as used herein, refers to one or more surfactants which are present in a composition.

“Single-phase liquid or fluid,” as used herein, refers to a fluid which only has a single-phase, i.e. only a water phase. A single-phase fluid is not an emulsion. A single-phase fluid is in a thermodynamically stable state such that it does not macroscopically separate into distinct layers or precipitate out solid particles. In some embodiments, the single-phase liquid comprises a single-phase liquid surfactant package including one or more anionic and/or non-ionic surfactants.

“Slickwater,” as used herein, refers to water-based injection fluid comprising a friction reducer which is typically pumped at high rates to fracture a reservoir. Optionally when employing slickwater, smaller sized proppant particles (e.g., 40/70 or 50/140 mesh size) are used due to the fluid having a relatively low viscosity (and therefore a diminished ability to transport sizable proppants relative to more viscous fluids). In some embodiments, proppants are added to some stages of completion/stimulation during production of an unconventional reservoir. In some embodiments, slickwater is injected with a small quantity of proppant.

“Friction reducer,” as used herein, refers to a chemical additive that alters fluid rheological properties to reduce friction created within the fluid as it flows through small-diameter tubulars or similar restrictions (e.g., valves, pumps). Generally polymers, or similar friction reducing agents, add viscosity to the fluid, which reduces the turbulence induced as the fluid flows. Reductions in fluid friction of greater than 50% are possible depending on the friction reducer utilized, which allows the injection fluid to be injected into a wellbore at a much higher injection rate (e.g., between 60 to 100 barrels per minute) and also lower pumping pressure during proppant injection.

“Injection fluid,” as used herein, refers to any fluid which is injected into a reservoir via a well. The injection fluid may include one or more of an acid, a polymer, a friction reducer, a gelling agent, a crosslinker, a scale inhibitor, a breaker, a pH adjusting agent, a non-emulsifier agent, an iron control agent, a corrosion inhibitor, a biocide, a clay stabilizing agent, a proppant, a wettability alteration chemical, a co-solvent (e.g., a C1-C5 alcohol, or an alkoxylated C1-C5 alcohol), or any combination thereof, to increase the efficacy of the injection fluid. In some embodiments, the injection fluid can be a low-particle size injection fluid as described below.

Olefin Sulfonates and Methods for Making the Same

In some embodiments, the compositions described herein can include olefin sulfonates. These olefin sulfonates (e.g., internal olefin sulfonates) can be particularly useful in oil and gas operations, including hydrocarbon recovery. The olefin sulfonates can allow for greater recovery of hydrocarbons when used in techniques such as surfactant flooding, wettability alteration, hydraulic fracturing, and the like. This disclosure describes methods for making olefin sulfonates and for using the same in hydrocarbon recovery.

The olefin sulfonates described herein can be produced by the sulfonation of propylene oligomers, which in turn can be produced by the oligomerization of propylene monomers. Discussion of olefin sulfonates can be found in US App. No. 20090111717, U.S. Pat. Nos. 8,293,688, 4,597,879, 4,979,564, 8,513,168, 9,284,481, 10,184,076, US App. No. 20080171672, US App. No. 20140224490, US App. No. 20100282467, U.S. Pat. Nos. 8,403,044, 8,889,600, US App. No. 20160304767, US App. No. 20120097389, U.S. Pat. No. 7,770,641, US App. No. 20180230788, which are hereby incorporated by reference.

An olefin feedstock comprising propylene can come from many different sources and have a wide range of compositional attributes. The feedstock for use in preparing the propylene oligomers will typically contain propylene in an amount of at least about 50 wt %, 60 wt %, 70 wt %, 80 wt %, 90 wt %, or 95 wt % based on the total weight of the feedstock.

In some cases, the feedstock can contain relatively low amounts, if any (i.e., substantially free), of olefin(s) other than propylene. For example, the feedstock can contain less than about 10 wt %, such as 9 wt %, 8 wt %, 7 wt %, 6 wt %, 5 wt %, 4 wt %, 3 wt %, 2 wt %, or 1 wt % of butene. The feedstock can also contain relatively low amounts, typically less than about 10 wt %, such as 9 wt %, 8 wt %, 7 wt %, 6 wt %, 5 wt %, 4 wt %, 3 wt %, 2 wt %, or 1 wt % of non-reactive components such as alkanes, e.g., ethane, propane, butane, isobutane and the like.

The oligomerization process involves polymerization of propylene in the presence of a liquid phosphoric acid or ionic liquid catalyst to obtain propylene oligomer products suitable for making olefin sulfonates described herein. A more detailed description of phosphoric acid catalysts can be found in U.S. Pat. Nos. 2,592,428, 2,814,655, 3,887,634, and 8,183,192, which are hereby incorporated by reference. A more detailed discussion of ionic liquid catalysts can be found in U.S. Pat. No. 9,938,473, which is hereby incorporated by reference.

Suitable propylene oligomer products include propylene pentamer and propylene tetramer. A “propylene tetramer” or PP₄ is an olefin oligomer product resulting from the oligomerization of nominally 4 propylene monomers. A “propylene pentamer” or PP₅ is an olefin oligomer product resulting from the oligomerization of nominally 5 propylene monomers. An unrefined product of the oligomerization process typically includes a mixture of branched olefins with a carbon distribution ranging from about C₉ to about C₅₀. The unrefined product can be distilled to further isolate or purify the olefin oligomer product to the preferred carbon range. According to some embodiments, the olefin oligomer product can comprise at least about 50 wt %, such as 60 wt %, 70 wt %, 75 wt %, 80 wt %, 85 wt %, 90 wt %, or 95 Wt % C₁₂ to C₄₀ olefin oligomers (e.g., C₁₆ to C₃₀ olefin oligomers). According to some embodiments, the olefin oligomer product can comprise at least about 50 wt %, such as 60 wt %, 70 wt %, 75 wt %, 80 wt %, 85 wt %, 90 wt %, or 95 W % C₃₁ to C₅₀ olefin oligomers (e.g., C₃₁ to C₄₀ olefin oligomers).

The olefin oligomer can be dimerized to form dimers that are also suitable for sulfonation and subsequent use as surfactants. Examples of dimers include a dimer of propylene tetramer or (PP₄)₂ and a dimer of propylene pentamer or (PP₅)₂. The dimers can be sulfonated and subsequently used as surfactants.

As an illustrative example, the propylene oligomer product can be obtained by contacting a feedstock comprising a major amount of propylene with a liquid phosphoric acid catalyst in a reaction zone under oligomerization conditions. In general, the feedstock and liquid phosphoric acid catalyst are contacted in the reaction zone at conditions sufficient to maintain a normally gaseous feedstock in a liquid state. Typically, the temperature of the reaction zone can be maintained between about 75° C. to about 175° C., such as 85° C. to 150° C., 100° C. to 150° C., or 110° C. to 125° C. The pressure can be maintained between about 200 psig to about 1600 psig, such as 400 psig to 1000 psig, 500 psig to 850 psig, or 550 psig to 800 psig.

As mentioned above, the normally gaseous hydrocarbon mixture comprising propylene can be introduced in liquid phase and under an elevated pressure into a body of liquid phosphoric acid and vigorously mixed with the acid at elevated temperatures. Propylene may be contacted with the acid at a rate of at least 0.15 volumes of liquid propylene per volume of acid per hour, and conversion of propylene to liquid polymer product is substantially in excess of 50% in a single pass operation. Generally, the feedstock and liquid phosphoric acid catalyst are contacted for a time period ranging from about 5 minutes to about 45 minutes. The conversion rate of the propylene (weight percent oligomerized product/total weight of starting olefin) is at least about 50 wt %, such as 55 wt %, 60 wt %, 65 wt %, 70 wt %, 75 wt %, 80 wt %, 85 wt %, 90 wt %, or 95 wt %.

The phosphoric acid catalyst strength can vary, but should be sufficient to produce propylene oligomer with an initial boiling point of at least about 160° C. In some embodiments, the acid strength is above about 105%, such as 106%, 107%, 108%, 109%, 110%, or 111%. In some embodiments, the acid strength is below about 125%, such as 124%, 123%, 122%, 121%, 120%, 119%, 118%, 117%, 116%, 115%, 114%, or 113%. The isolated propylene oligomer can have an initial boiling point of about 160° C. (5% boiling point is about 180° C.) and a final boiling point of about 225° C. as measured by ASTM D86.

The strength of the phosphoric acid catalyst can be calculated by, for example, measuring the polyphosphoric acid peaks using NMR (nuclear magnetic resonance spectroscopy), and can be expressed as a percentage of P₂O₅ greater than that required for the hydrolysis reaction to make orthophosphoric acid (H₃PO₄). Orthophosphoric acid will have a strength of 100%, pyrophosphoric acid (H₄P₂O₇) will have a strength of 110%, and polyphosphoric acid H₄P₂O₇(HPO₃)n, will have a strength of 114% when n is 1 and a strength of 116% when n is 2.

As an illustrative example, ionic liquid catalysts are typically composed of at least two components that form a complex (e.g., a first component and a second component). The first component may comprise a Lewis Acid while the second component may comprise organic salt or mixture of salts. A co-catalyst (e.g., HCl, organic chlorides, hydrogen halides, etc.) may also be present.

The oligomerization via ionic liquid catalysts may be performed under a wide range of conditions. For example, the oligomerization reaction can be conducted under a pressure of about 100-1000 psig (689-6895 kPa). In certain embodiments, the oligomerization reaction is conducted under a pressure of about 350-700 psig (2413 kPa-4826 kPa). In certain embodiments, the oligomerization reaction is conducted under a pressure of 400-500 psig (2758 kPa-3447 kPa). In certain embodiments, the oligomerization reaction is conducted under a pressure of about 400 (2758 kPa), 450 (3103 kPa), 470 (3241 kPa) or 500 psig (3447 kPa). The oligomerization reaction temperature can range from about 10° C. to about 149° C., such as from about 24° C. to about 135° C., from about 38° C. to about 121° C. In one embodiment, the oligomerization temperature is about 38° C., 49° C., 50° C., 52° C., 54° C., or 66° C.

As alluded to above, the olefin oligomer may be dimerized prior to the sulfonation step. The dimerization process generally involves treating the olefin oligomers with one or more suitable catalysts.

In one embodiment, the dimerization catalyst is an acid catalyst including Brønsted acids such as hydrogen fluoride, phosphoric acid, and the like. Other acid catalysts include Lewis acids such as boron trifluoride, aluminum chloride, organoflourophosphonium salts, bismuth, and the like.

In some cases, the dimerization catalyst may be an inorganic or organometallic coordination complex based on nickel, group IV metals such as titanium, zirconium, and hafnium, aluminum, iridium, tantalum, tungsten, and the like.

In some cases, the dimerization catalyst may be an acidic clay such as montmorillonites, bentonites, or F-20X commercially available from BASF Corporation (Florham Park, N.J.) and F-24X commercially available BASF (Florham Park, N.J.). The dimerization catalyst may also be a solid supported acid catalyst such as Amberlyst™ A36 commercially available from Dow (Midland, Mich.), zeolite materials, alumina, and the like.

During the dimerization process, the olefin oligomer is typically charged with a catalyst whose loading can range from about 0.5 wt % to about 50 wt %, such as 1 wt % to 10 wt %, 11 wt % to 20 wt %, 21 wt % to 30 wt %, 31 wt % to 40 wt %, or 41 wt % to 50 wt %.

The olefin oligomer and catalyst are generally agitated by stirring, placed in an inert atmosphere like under nitrogen or argon and so forth, and then heated to the desired temperature. The temperature of the dimerization process can range from about 50° C. to about 300° C., such as 50° C. to 250° C., or 100° C. to 200° C. The dimerization process is typically heated from about 0.1 h to 300 h, such as 10 h to 250 h, 50 h to 200 h, or 100 h to 150 h. The dimerized olefin oligomer can be further isolated or purified by removing the unreacted oligomers by distillation.

In some cases, the dimerization can be conducted in a continuous unit, where the olefin is fed through a fixed bed solid acid catalyst. The temperature of the continuous dimerization process can range from about 50° C. to 300° C., such as 50° C. to 250° C., or 100° C. to 200° C. The dimerization process is typically heated from about 0.1 h to 300 h, such as 10 h to 250 h, 50 h to 200 h, or 100 h to 150 h. The dimerized olefin oligomer can be further isolated or purified by removing the unreacted oligomers by distillation.

A sulfonation process can involve treating olefin oligomers with SO₃ gas in the presence of air. Air/SO₃ sulfonation process is a direct process in which SO₃ gas is diluted with air and reacted directly with the olefin. The source of the SO₃ gas may be from various sources. These sources include sulfuric acid plant converter gas, SO₃ from boiling concentrated oleum, liquid SO₃, converting SO₂ into SO₃ via catalytic oxidation, and sulfur burning in equipment specifically designed to produce SO₃ gas for sulfonation.

For an industrial process, this process usually involves treating an organic feedstock with SO₃ that has been diluted with air in a reactor (typically film reactor). The air is typically dried and supplied by an air supply system. For isomerized and internal olefin sulfonates, the sulfonation reaction typically occurs at the alkene, and can take place at any place along the chain since its double bond is randomly distributed. In generally, process variables such as mole ratio of SO₃ to feedstock, temperature, and concentration can impact quality of product. For example, because sulfonation is a rapid exothermic reaction, optimizing the ratio of SO₃ to feedstock can help control the rate of reaction and minimize undesirable by-products.

With respect to process variables, any compatible range of parameters may be used. In some embodiments, the mole ratio of SO₃ to air can range from about 0.8 to about 1.6, such as 0.85 to 1.5, 0.9 to 1.2, or 0.95 to 1.15. The SO₃ inlet gas concentration can range from about 0.1% to about 10%, such as 0.5% to 9%, 1% to 8%, 2% to 7%, 3% to 6%, or 4% to 5%. The reaction temperature can range from about 0° C. to about 80° C., such as 10° C. to 60° C., 20° C. to 40° C., or 25° C. to 35° C.

After the initial treatment of the olefin oligomer with SO₃, the resulting mixture is neutralized with a base. Neutralization of the olefin sulfonic acid may be carried out in a continuous or batch process by any method known to one skilled in the art to produce the olefin sulfonate. Typically, an olefin sulfonic acid is neutralized by a base with a mono-covalent cation (e.g., an alkali metal such as sodium, lithium, potassium, ammonium or substituted ammonium ion). Aqueous 50% sodium hydroxide is a common neutralizing agent. Next the mixture can be hydrolyzed at ambient or elevated temperatures to convert any remaining sulfones to alkene sulfonates and hydroxy sulfonates. The neutralization can occur at temperatures from about 20° C. to about 100° C., such as 30° C. to 90° C., 40° C. to 80° C., or 50° C. to 70° C. This results in an aqueous solution of olefin sulfonates. Optionally, the neutralized olefin sulfonate may be further hydrolyzed with additional base or caustic.

The propylene oligomer products of the present invention can have an average carbon number between 9 to 50, 10 to 35, or 12 to 30. The propylene oligomer products of the present invention generally have higher branching compared to other internal olefin sulfonates or isomerized olefin sulfonates, which are based on ethylene oligomers. The propylene oligomerization process results in a more naturally branched material, which obviates the need for a separate isomerization process which is commonly needed for oligomerized ethylene olefins. A more detailed description of isomerized olefin sulfonates can be found in U.S. Pat. No. 8,993,798, which is hereby incorporated by reference.

¹H NMR can be employed to characterize the degree of branching or average number of branches per chain. Total branching is the sum of aliphatic branching and olefinic branching. Aliphatic branching is the degree of branching at the aliphatic carbons while olefinic branching is the degree of branching at the olefinic carbons. While most conventional internal/isomerized olefin sulfonates have an average total branching below 3, the present invention provides internal olefin sulfonates with higher branching levels. The higher branched internal olefin sulfonates may have physical properties that are more desirable in surfactant applications. A more detailed description of NMR branching analysis can be found in US Pat. No. 20080171672, which is hereby incorporated by reference.

Surfactant Packages

In some embodiments, the surfactant package can include a surfactant, and an olefin sulfonate. In some embodiments, the surfactant package can include a surfactant, and disulfonate. In some embodiments, the surfactant package can include a surfactant, an olefin sulfonate, and a disulfonate.

In some embodiments, the surfactant can include a branched, unbranched, saturated, or unsaturated C6-C32:BO(0-65):PO(0-65):EO(0-100)-X, wherein there is at least one BO, PO, or EO group, and wherein X includes a sulfonate, a disulfonate, a carboxylate, a dicarboxylate, a sulfosuccinate, a disulfosuccinate, or hydrogen. In some embodiments, the surfactant comprises average BO groups of from 0-10, of from 0-15, of from 0-20, of from 0-25, of from 0-30, of from 0-35, of from 0-40, or of from 0-45, of from 0-50, of from 0-55, or of from 0-60; average PO groups of from 0-10, of from 0-15, of from 0-20, of from 0-25, of from 0-30, of from 0-35, of from 0-40, or of from 0-45, of from 0-50, of from 0-55, or of from 0-60; average EO groups of from 0-10, of from 0-15, of from 0-20, of from 0-25, of from 0-30, of from 0-35, of from 0-40, of from 0-45, of from 0-50, of from 0-55, of from 0-60, of from 0-65, of from 0-70, of from 0-75, of from 0-80, of from 0-85, of from 0-90, of from 0-95; or any combination thereof.

In some embodiments, the surfactant can have a concentration within the aqueous composition of at least 0.05% by weight (e.g., at least 0.05% by weight, at least 0.1% by weight, at least 0.5% by weight, at least 1% by weight, at least 1.5% by weight, at least 2% by weight, at least 2.5% by weight, at least 3% by weight, at least 3.5% by weight, at least 4% by weight, or at least 4.5% by weight), based on the total weight of the aqueous composition. In some embodiments, the surfactant can have a concentration within the aqueous composition of 5% by weight or less (e.g., 4.5% by weight or less, 4% by weight or less, 3.5% by weight or less, 3% by weight or less, 2.5% by weight or less, 2% by weight or less, 1.5% by weight or less, 1% by weight or less, 0.5% by weight or less, or 0.1% by weight or less), based on the total weight of the aqueous composition.

The surfactant can have a concentration within the aqueous composition ranging from any of the minimum values described above to any of the maximum values described above. For example, in some embodiments, the surfactant can have a concentration within the aqueous composition of from 0.05% to 5% by weight (e.g., from 0.05% to 1% by weight, from 0.05% to 2% by weight, from 0.05% to 3% by weight, from 0.05% to 4% by weight, from 0.1% to 1% by weight, from 0.1% to 2% by weight, from 0.1% to 3% by weight, from 0.1% to 4% by weight, from 0.1% to 5% by weight, 0.5% to 1% by weight, from 0.5% to 2% by weight, from 0.5% to 3% by weight, from 0.5% to 4% by weight, from 0.5% to 5% by weight, from 1% to 2% by weight, from 1% to 3% by weight, from 1% to 4% by weight, 1% to 5% by weight, from 2% to 3% by weight, from 2% to 4% by weight, from 2% to 5% by weight, 3% to 4% by weight, from 3% to 5% by weight, or from 4% to 5% by weight), based on the total weight of the aqueous composition.

In some embodiments, the olefin sulfonate can be an “internal olefin sulfonate,” “isomerized olefin sulfonate,” or “IOS” in the context of co-surfactants present in addition to the olefin sulfonates described herein refers to an unsaturated hydrocarbon compound comprising at least one carbon-carbon double bond and at least one SO₃— group, or a salt thereof. As used herein, a “C20-C28 internal olefin sulfonate,” “a C20-C28 isomerized olefin sulfonate,” or “C20-C28 IOS” refers to an IOS, or a mixture of IOSs with an average carbon number of 20 to 28, or of 23 to 25. The C20-C28 IOS may comprise at least 80% of IOS with carbon numbers of 20 to 28, at least 90% of IOS with carbon numbers of 20 to 28, or at least 99% of IOS with carbon numbers of 20 to 28. As used herein, a “C15-C18 internal olefin sulfonate,” “C15-C18 isomerized olefin sulfonate,” or “C15-C18 IOS” refers to an IOS or a mixture of IOSs with an average carbon number of 15 to 18, or of 16 to 17. The C15-C18 IOS may comprise at least 80% of IOS with carbon numbers of 15 to 18, at least 90% of IOS with carbon numbers of 15 to 18, or at least 99% of IOS with carbon numbers of 15 to 18. The internal olefin sulfonates or isomerized olefin sulfonates may be alpha olefin sulfonates, such as an isomerized alpha olefin sulfonate. The internal olefin sulfonates or isomerized olefin sulfonates may also comprise branching. In certain embodiments, C15-18 IOS may be added to surfactant packages described herein when used for aqueous compositions intended for use in high temperature unconventional subterranean formations, such as formations above 130° F. (approximately 55° C.). The IOS may be at least 20% branching, 30% branching, 40% branching, 50% branching, 60% branching, or 65% branching. In some embodiments, the branching is between 20-98%, 30-90%, 40-80%, or around 65%. Examples of internal olefin sulfonates and the methods to make them are found in U.S. Pat. No. 5,488,148, U.S. Patent Application Publication 2009/0112014, and SPE 129766, all incorporated herein by reference.

In some embodiments, the olefin sulfonate can have a concentration within the aqueous composition of at least 0.05% by weight (e.g., at least 0.05% by weight, at least 0.1% by weight, at least 0.5% by weight, at least 1% by weight, at least 1.5% by weight, at least 2% by weight, at least 2.5% by weight, at least 3% by weight, at least 3.5% by weight, at least 4% by weight, or at least 4.5% by weight), based on the total weight of the aqueous composition. In some embodiments, the olefin sulfonate can have a concentration within the aqueous composition of 5% by weight or less (e.g., 4.5% by weight or less, 4% by weight or less, 3.5% by weight or less, 3% by weight or less, 2.5% by weight or less, 2% by weight or less, 1.5% by weight or less, 1% by weight or less, 0.5% by weight or less, or 0.1% by weight or less), based on the total weight of the aqueous composition.

The olefin sulfonate can have a concentration within the aqueous composition ranging from any of the minimum values described above to any of the maximum values described above. For example, in some embodiments, the olefin sulfonate can have a concentration within the aqueous composition of from 0.05% to 5% by weight (e.g., from 0.05% to 1% by weight, from 0.05% to 2% by weight, from 0.05% to 3% by weight, from 0.05% to 4% by weight, from 0.1% to 1% by weight, from 0.1% to 2% by weight, from 0.1% to 3% by weight, from 0.1% to 4% by weight, from 0.1% to 5% by weight, 0.5% to 1% by weight, from 0.5% to 2% by weight, from 0.5% to 3% by weight, from 0.5% to 4% by weight, from 0.5% to 5% by weight, from 1% to 2% by weight, from 1% to 3% by weight, from 1% to 4% by weight, 1% to 5% by weight, from 2% to 3% by weight, from 2% to 4% by weight, from 2% to 5% by weight, 3% to 4% by weight, from 3% to 5% by weight, or from 4% to 5% by weight), based on the total weight of the aqueous composition.

In some embodiments, the disulfonate can be defined by the formula below:

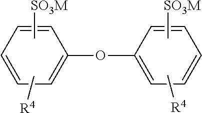

wherein

R⁴ is present in at least one ring;

R⁴ is, individually for each occurrence, a branched or unbranched, saturated or unsaturated, cyclic or non-cyclic, hydrophobic carbon chain having 6-32 carbon atoms; and

M represents a counterion; and

In some embodiments, the disulfonate can have a concentration within the aqueous composition of at least 0.05% by weight (e.g., at least 0.05% by weight, at least 0.1% by weight, at least 0.5% by weight, at least 1% by weight, at least 1.5% by weight, at least 2% by weight, at least 2.5% by weight, at least 3% by weight, at least 3.5% by weight, at least 4% by weight, or at least 4.5% by weight), based on the total weight of the aqueous composition. In some embodiments, the disulfonate can have a concentration within the aqueous composition of 5% by weight or less (e.g., 4.5% by weight or less, 4% by weight or less, 3.5% by weight or less, 3% by weight or less, 2.5% by weight or less, 2% by weight or less, 1.5% by weight or less, 1% by weight or less, 0.5% by weight or less, or 0.1% by weight or less), based on the total weight of the aqueous composition.

The disulfonate can have a concentration within the aqueous composition ranging from any of the minimum values described above to any of the maximum values described above. For example, in some embodiments, The disulfonate can have a concentration within the aqueous composition of from 0.05% to 5% by weight (e.g., from 0.05% to 1% by weight, from 0.05% to 2% by weight, from 0.05% to 3% by weight, from 0.05% to 4% by weight, from 0.1% to 1% by weight, from 0.1% to 2% by weight, from 0.1% to 3% by weight, from 0.1% to 4% by weight, from 0.1% to 5% by weight, 0.5% to 1% by weight, from 0.5% to 2% by weight, from 0.5% to 3% by weight, from 0.5% to 4% by weight, from 0.5% to 5% by weight, from 1% to 2% by weight, from 1% to 3% by weight, from 1% to 4% by weight, 1% to 5% by weight, from 2% to 3% by weight, from 2% to 4% by weight, from 2% to 5% by weight, 3% to 4% by weight, from 3% to 5% by weight, or from 4% to 5% by weight), based on the total weight of the aqueous composition.

For example, in some embodiments, the surfactant package comprises (a) a surfactant comprising a branched, unbranched, saturated, or unsaturated C6-C32:BO(0-65):PO(0-65):EO(0-100)-X having a concentration within the aqueous composition of from 0.05%-5% by weight, based on the total weight of the aqueous composition, wherein there is at least one BO, PO, or EO group, and wherein X comprises a sulfonate, a disulfonate, a carboxylate, a dicarboxylate, a sulfosuccinate, a disulfosuccinate, or hydrogen; and (b) olefin sulfonate having a concentration within the aqueous composition of from 0.05%-5% by weight, based on the total weight of the aqueous composition; and

For example, in some embodiments, the surfactant package comprises (a) a surfactant comprising a branched, unbranched, saturated, or unsaturated C6-C32:BO(0-65):PO(0-65):EO(0-100)-X having a concentration within the aqueous composition of from 0.05%-5% by weight, based on the total weight of the aqueous composition, wherein there is at least one BO, PO, or EO group, and wherein X comprises a sulfonate, a disulfonate, a carboxylate, a dicarboxylate, a sulfosuccinate, a disulfosuccinate, or hydrogen; (b) olefin sulfonate having a concentration within the aqueous composition of from 0.05%-5% by weight, based on the total weight of the aqueous composition; and (c) a disulfonate having a concentration within the aqueous composition of from 0.05%-5% by weight, based on a total weight of the aqueous composition, wherein the disulfonate is defined by the formula below:

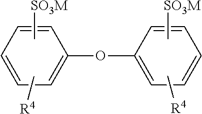

wherein

R⁴ is present in at least one ring;

R⁴ is, individually for each occurrence, a branched or unbranched, saturated or unsaturated, cyclic or non-cyclic, hydrophobic carbon chain having 6-32 carbon atoms; and

M represents a counterion.

In some embodiments, the disulfonate can have a concentration within the aqueous composition of at least 0.05% by weight (e.g., at least 0.05% by weight, at least 0.1% by weight, at least 0.5% by weight, at least 1% by weight, at least 1.5% by weight, at least 2% by weight, at least 2.5% by weight, at least 3% by weight, at least 3.5% by weight, at least 4% by weight, or at least 4.5% by weight), based on the total weight of the aqueous composition. In some embodiments, the disulfonate can have a concentration within the aqueous composition of 5% by weight or less (e.g., 4.5% by weight or less, 4% by weight or less, 3.5% by weight or less, 3% by weight or less, 2.5% by weight or less, 2% by weight or less, 1.5% by weight or less, 1% by weight or less, 0.5% by weight or less, or 0.1% by weight or less), based on the total weight of the aqueous composition.

The disulfonate can have a concentration within the aqueous composition ranging from any of the minimum values described above to any of the maximum values described above. For example, in some embodiments, The disulfonate can have a concentration within the aqueous composition of from 0.05% to 5% by weight (e.g., from 0.05% to 1% by weight, from 0.05% to 2% by weight, from 0.05% to 3% by weight, from 0.05% to 4% by weight, from 0.1% to 1% by weight, from 0.1% to 2% by weight, from 0.1% to 3% by weight, from 0.1% to 4% by weight, from 0.1% to 5% by weight, 0.5% to 1% by weight, from 0.5% to 2% by weight, from 0.5% to 3% by weight, from 0.5% to 4% by weight, from 0.5% to 5% by weight, from 1% to 2% by weight, from 1% to 3% by weight, from 1% to 4% by weight, 1% to 5% by weight, from 2% to 3% by weight, from 2% to 4% by weight, from 2% to 5% by weight, 3% to 4% by weight, from 3% to 5% by weight, or from 4% to 5% by weight), based on the total weight of the aqueous composition.

In some embodiments, the surfactant package comprises (a) a surfactant comprising a branched, unbranched, saturated, or unsaturated C6-C32:BO(0-65):PO(0-65):EO(0-100)-X having a concentration within the aqueous composition of from 0.05%-5% by weight, based on the total weight of the aqueous composition, wherein there is at least one BO, PO, or EO group, and wherein X comprises a sulfonate, a disulfonate, a carboxylate, a dicarboxylate, a sulfosuccinate, a disulfosuccinate, or hydrogen; and (b) olefin sulfonate having a concentration within the aqueous composition of from 0.05%-5% by weight, based on the total weight of the aqueous composition.

For example, in some embodiments, the surfactant package comprises (a) a surfactant comprising a branched, unbranched, saturated, or unsaturated C6-C32:BO(0-65):PO(0-65):EO(0-100)-X having a concentration within the aqueous composition of from 0.05%-5% by weight, based on the total weight of the aqueous composition, wherein there is at least one BO, PO, or EO group, and wherein X comprises a sulfonate, a disulfonate, a carboxylate, a dicarboxylate, a sulfosuccinate, a disulfosuccinate, or hydrogen; (b) olefin sulfonate having a concentration within the aqueous composition of from 0.05%-5% by weight, based on the total weight of the aqueous composition; and (c) a disulfonate having a concentration within the aqueous composition of from 0.05%-5% by weight, based on a total weight of the aqueous composition, wherein the disulfonate is defined by the formula below:

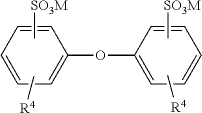

wherein

R⁴ is present in at least one ring;

R⁴ is, individually for each occurrence, a branched or unbranched, saturated or unsaturated, cyclic or non-cyclic, hydrophobic carbon chain having 6-32 carbon atoms; and

M represents a counterion.

In some embodiments, the surfactant and the olefin sulfonate can be present in the aqueous composition in a weight ratio of surfactant to the olefin sulfonate of from 1:10 to 10:1 (e.g., from 1:10 to 1:1, from 1:1 to 10:1, from 1:5 to 5:1, from 1:5 to 1:1, from 1:1 to 5:1, from 1:2.5 to 2.5:1, from 1:2.5 to 1:1, or from 1:1 to 2.5:1).

In some embodiments, the surfactant and the disulfonate can be present in the aqueous composition in a weight ratio of surfactant to the disulfonate of from 1:10 to 10:1 (e.g., from 1:10 to 1:1, from 1:1 to 10:1, from 1:5 to 5:1, from 1:5 to 1:1, from 1:1 to 5:1, from 1:2.5 to 2.5:1, from 1:2.5 to 1:1, or from 1:1 to 2.5:1).

In some embodiments, the composition can include an olefin sulfonate and a disulfonate, and the olefin sulfonate and the disulfonate can be present in the aqueous composition in a weight ratio of surfactant to the olefin sulfonate to the disulfonate of from 1:10 to 10:1 (e.g., from 1:10 to 1:1, from 1:1 to 10:1, from 1:5 to 5:1, from 1:5 to 1:1, from 1:1 to 5:1, from 1:2.5. to 2.5:1, from 1:2.5 to 1:1, or from 1:1 to 2.5:1).

Aqueous Compositions

Provided are aqueous compositions (also referred to as injection compositions) comprising a surfactant package described herein and water. These compositions can be used in oil and gas operations. In some embodiments, the aqueous composition can further include an alkyl aryl sulfonate, a cationic surfactant, a zwitterionic surfactant, an amphoteric surfactant, a gemini surfactant, an alkyl benzene sulfonate (ABS), a disulfonate surfactant, a second disulfonate surfactant with at least one different R⁴ group, an alkyl polyglucoside, an alkyl polyglucoside carboxylate, a second olefin sulfonate, a second surfactant with branched, unbranched, saturated, or unsaturated C6-C32:BO(0-65):PO(0-65):EO(0-100)-X, or any combination thereof. In some embodiments, the aqueous composition can have a salinity of at least 5,000 ppm. In other embodiments, the aqueous composition has a salinity of at least 30,000 ppm. In other embodiments, the aqueous composition has a salinity of at least 50,000 ppm. In other embodiments, the aqueous composition has a salinity of at least 100,000 ppm. In other embodiments, the aqueous composition has a salinity of at least 250,000 ppm. The total range of salinity (total dissolved solids in the brine) is 100 ppm to saturated brine (about 260,000 ppm). In some embodiments, the aqueous composition is below optimum salinity.

In some embodiments, the surfactant package can include an olefin sulfonate described herein and a surfactant described herein. For example, in some embodiments, the aqueous composition can include: (i) a surfactant package, wherein the surfactant package includes:

(a) a surfactant comprising a branched, unbranched, saturated, or unsaturated C6-C32:BO(0-65):PO(0-65):EO(0-100)-X having a concentration within the aqueous composition of from 0.05%-5% by weight, based on the total weight of the aqueous composition, wherein there is at least one BO, PO, or EO group, and wherein X comprises a sulfonate, a disulfonate, a carboxylate, a dicarboxylate, a sulfosuccinate, a disulfosuccinate, or hydrogen; and

(b) olefin sulfonate having a concentration within the aqueous composition of from 0.05%-5% by weight, based on the total weight of the aqueous composition; and

(ii) water; and

wherein the aqueous composition comprises at least 5,000 ppm total dissolved solids (TDS) and exhibits a solubilization parameter of from 3 to 25 at an optimum salinity in response to contact with hydrocarbons comprising H₂S of at least 0.5 mol %.

In some embodiments, the surfactant package can include a disulfonate described herein and a surfactant described herein. For example, in some embodiments, the aqueous composition can include: (i) a surfactant package, wherein the surfactant package includes:

(a) a surfactant comprising a branched, unbranched, saturated, or unsaturated C6-C32:BO(0-65):PO(0-65):EO(0-100)-X having a concentration within the aqueous composition of from 0.05%-5% by weight, based on the total weight of the aqueous composition, wherein there is at least one BO, PO, or EO group, and wherein X comprises a sulfonate, a disulfonate, a carboxylate, a dicarboxylate, a sulfosuccinate, a disulfosuccinate, or hydrogen; and

(b) a disulfonate having a concentration within the aqueous composition of from 0.05%-5% by weight, based on a total weight of the aqueous composition, wherein the disulfonate is defined by the formula below:

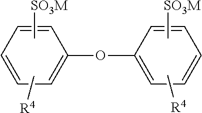

wherein

R⁴ is present in at least one ring;

R⁴ is, individually for each occurrence, a branched or unbranched, saturated or unsaturated, cyclic or non-cyclic, hydrophobic carbon chain having 6-32 carbon atoms; and M represents a counterion; and

(ii) water; and

wherein the aqueous composition comprises at least 5,000 ppm total dissolved solids (TDS) and exhibits a solubilization parameter of from 3 to 25 at an optimum salinity in response to contact with hydrocarbons comprising H₂S of at least 0.5 mol %.

In the embodiments above, the total dissolved solids TDS can be from 5,000 ppm TDS-100,000 ppm TDS, from 5,000 ppm TDS-90,000 ppm TDS, from 5,000 ppm TDS-80,000 ppm TDS, from 5,000 ppm TDS-70,000 ppm TDS, from 5,000 ppm TDS-60,000 ppm TDS, from 5,000 ppm TDS-50,000 ppm TDS, from 5,000 ppm TDS-40,000 ppm TDS, from 5,000 ppm TDS-30,000 ppm TDS, from 5,000 ppm TDS-20,000 ppm TDS, from 5,000 ppm TDS-10,000 ppm TDS, from 5,000 ppm TDS-75,000 ppm TDS, from 5,000 ppm TDS-25,000 ppm TDS, from 50,000 ppm TDS-100,000 ppm TDS, or from 50,000 ppm TDS-80,000 ppm TDS.

In some embodiments above, the aqueous composition can further include an alkyl aryl sulfonate, a cationic surfactant, a zwitterionic surfactant, an amphoteric surfactant, a gemini surfactant, an alkyl benzene sulfonate (ABS), a disulfonate surfactant, an alkyl polyglucoside, an alkyl polyglucoside carboxylate, a second olefin sulfonate, a second surfactant with branched, unbranched, saturated, or unsaturated C6-C32:BO(0-65):PO(0-65):EO(0-100)-X, or any combination thereof.

Such an aqueous composition can include at least 30,000 ppm total dissolved solids (TDS) and exhibits a solubilization parameter of from 3 to 25 at an optimum salinity in response to contact with hydrocarbons comprising H₂S of at least 0.5 mol %.

In some embodiments above, the total dissolved solids (TDS) can be from 30,000 ppm TDS-300,000 ppm TDS, from 50,000 ppm TDS-300,000 ppm TDS, from 75,000 ppm TDS-300,000 ppm TDS, from 100,000 ppm TDS-300,000 ppm TDS, from 125,000 ppm TDS-300,000 ppm TDS, from 150,000 ppm TDS-300,000 ppm TDS, from 175,000 ppm TDS-300,000 ppm TDS, from 200,000 ppm TDS-300,000 ppm TDS, from 250,000 ppm TDS-300,000 ppm TDS, from 175,000 ppm TDS-200,000 ppm TDS, from 150,000 ppm TDS-250,000 ppm TDS, from 175,000 ppm TDS-250,000 ppm TDS, from 200,000 ppm TDS-250,000 ppm TDS, from 100,000 ppm TDS-200,000 ppm TDS, or from 50,000 ppm TDS-250,000 ppm TDS.

In some embodiments, the surfactant package can include an olefin sulfonate described herein, a surfactant described herein, and a disulfonate described herein. For example, in some embodiments, the aqueous composition can include: (i) a surfactant package, wherein the surfactant package comprises:

(a) a surfactant comprising a branched, unbranched, saturated, or unsaturated C6-C32:BO(0-65):PO(0-65):EO(0-100)-X having a concentration within the aqueous composition of from 0.05%-5% by weight, based on the total weight of the aqueous composition, wherein there is at least one BO, PO, or EO group, and wherein X comprises a sulfonate, a disulfonate, a carboxylate, a dicarboxylate, a sulfosuccinate, a disulfosuccinate, or hydrogen;

(b) olefin sulfonate having a concentration within the aqueous composition of from 0.05%-5% by weight, based on the total weight of the aqueous composition; and

(c) a disulfonate having a concentration within the aqueous composition of from 0.05%-5% by weight, based on a total weight of the aqueous composition, wherein the disulfonate is defined by the formula below:

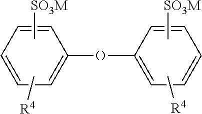

wherein

R⁴ is present in at least one ring;

R⁴ is, individually for each occurrence, a branched or unbranched, saturated or unsaturated, cyclic or non-cyclic, hydrophobic carbon chain having 6-32 carbon atoms; and M represents a counterion; and

(ii) water;

wherein the aqueous composition comprises at least 30,000 ppm total dissolved solids (TDS) and exhibits a solubilization parameter of from 3 to 25 at an optimum salinity in response to contact with hydrocarbons comprising H₂S of at least 0.5 mol %.

For example, the total dissolved solids (TDS) can be from 30,000 ppm TDS-300,000 ppm TDS, from 50,000 ppm TDS-300,000 ppm TDS, from 75,000 ppm TDS-300,000 ppm TDS, from 100,000 ppm TDS-300,000 ppm TDS, from 125,000 ppm TDS-300,000 ppm TDS, from 150,000 ppm TDS-300,000 ppm TDS, from 175,000 ppm TDS-300,000 ppm TDS, from 200,000 ppm TDS-300,000 ppm TDS, from 250,000 ppm TDS-300,000 ppm TDS, from 175,000 ppm TDS-200,000 ppm TDS, from 150,000 ppm TDS-250,000 ppm TDS, from 175,000 ppm TDS-250,000 ppm TDS, from 200,000 ppm TDS-250,000 ppm TDS, from 100,000 ppm TDS-200,000 ppm TDS, or from 50,000 ppm TDS-250,000 ppm TDS.

In some embodiments, the aqueous composition can further include an alkyl aryl sulfonate, a cationic surfactant, a zwitterionic surfactant, an amphoteric surfactant, a gemini surfactant, an alkyl benzene sulfonate (ABS), a second disulfonate surfactant with at least one different R⁴ group, an alkyl polyglucoside, an alkyl polyglucoside carboxylate, a second olefin sulfonate, a second surfactant with branched, unbranched, saturated, or unsaturated C6-C32:BO(0-65):PO(0-65):EO(0-100)-X, or any combination thereof.

In some embodiments, the surfactant package includes (a) a surfactant comprising a branched, unbranched, saturated, or unsaturated C6-C32:BO(0-65):PO(0-65):EO(0-100)-X having a concentration within the aqueous composition of from 0.05%-5% by weight, based on the total weight of the aqueous composition, wherein there is at least one BO, PO, or EO group, and wherein X comprises a sulfonate, a disulfonate, a carboxylate, a dicarboxylate, a sulfosuccinate, a disulfosuccinate, or hydrogen; and (b) olefin sulfonate having a concentration within the aqueous composition of from 0.05%-5% by weight, based on the total weight of the aqueous composition, wherein the aqueous composition comprises at least 50,000 ppm total dissolved solids (TDS) and exhibits a solubilization parameter of from 3 to 25 at an optimum salinity and at a temperature of at least 80° C. in response to contact with hydrocarbons.

In some embodiments, the aqueous composition further includes an alkyl aryl sulfonate, a cationic surfactant, a zwitterionic surfactant, an amphoteric surfactant, a gemini surfactant, an alkyl benzene sulfonate (ABS), a disulfonate surfactant, an alkyl polyglucoside, an alkyl polyglucoside carboxylate, a second olefin sulfonate, a second surfactant with branched, unbranched, saturated, or unsaturated C6-C32:BO(0-65):PO(0-65):EO(0-100)-X, or any combination thereof.

In some embodiments, the surfactant package includes (a) a surfactant comprising a branched, unbranched, saturated, or unsaturated C6-C32:BO(0-65):PO(0-65):EO(0-100)-X having a concentration within the aqueous composition of from 0.05%-5% by weight, based on the total weight of the aqueous composition, wherein there is at least one BO, PO, or EO group, and wherein X comprises a sulfonate, a disulfonate, a carboxylate, a dicarboxylate, a sulfosuccinate, a disulfosuccinate, or hydrogen; and (b) a disulfonate having a concentration within the aqueous composition of from 0.05%-5% by weight, based on a total weight of the aqueous composition, wherein the disulfonate is defined by the formula below:

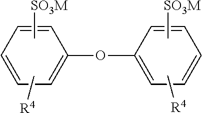

wherein

R⁴ is present in at least one ring;

R⁴ is, individually for each occurrence, a branched or unbranched, saturated or unsaturated, cyclic or non-cyclic, hydrophobic carbon chain having 6-32 carbon atoms; and

M represents a counterion;

wherein the aqueous composition comprises at least 50,000 ppm total dissolved solids (TDS) and exhibits a solubilization parameter of from 3 to 25 at an optimum salinity and at a temperature of at least 80° C. in response to contact with hydrocarbons

In some embodiments, the surfactant package can include an olefin sulfonate described herein, a surfactant described herein, and a disulfonate described herein. For example, in some embodiments, the surfactant package includes (a) a surfactant comprising a branched, unbranched, saturated, or unsaturated C6-C32:BO(0-65):PO(0-65):EO(0-100)-X having a concentration within the aqueous composition of from 0.05%-5% by weight, based on the total weight of the aqueous composition, wherein there is at least one BO, PO, or EO group, and wherein X comprises a sulfonate, a disulfonate, a carboxylate, a dicarboxylate, a sulfosuccinate, a disulfosuccinate, or hydrogen; (b) olefin sulfonate having a concentration within the aqueous composition of from 0.05%-5% by weight, based on the total weight of the aqueous composition; and (c) a disulfonate having a concentration within the aqueous composition of from 0.05%-5% by weight, based on a total weight of the aqueous composition, wherein the disulfonate is defined by the formula below:

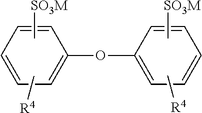

wherein

R⁴ is present in at least one ring;

R⁴ is, individually for each occurrence, a branched or unbranched, saturated or unsaturated, cyclic or non-cyclic, hydrophobic carbon chain having 6-32 carbon atoms; and

M represents a counterion,

wherein the aqueous composition comprises at least 50,000 ppm total dissolved solids (TDS) and exhibits a solubilization parameter of from 3 to 25 at an optimum salinity and at a temperature of at least 80° C. in response to contact with hydrocarbons.

In some embodiments, aqueous composition further including an alkyl aryl sulfonate, a cationic surfactant, a zwitterionic surfactant, an amphoteric surfactant, a gemini surfactant, an alkyl benzene sulfonate (ABS), a second disulfonate surfactant with at least one different R⁴ group, an alkyl polyglucoside, an alkyl polyglucoside carboxylate, a second olefin sulfonate, a second surfactant with branched, unbranched, saturated, or unsaturated C6-C32:BO(0-65):PO(0-65):EO(0-100)-X, or any combination thereof.

In some embodiments, the TDS is from 50,000 ppm TDS-300,000 ppm TDS, from 75,000 ppm TDS-300,000 ppm TDS, from 100,000 ppm TDS-300,000 ppm TDS, from 125,000 ppm TDS-300,000 ppm TDS, from 150,000 ppm TDS-300,000 ppm TDS, from 175,000 ppm TDS-300,000 ppm TDS, from 200,000 ppm TDS-300,000 ppm TDS, from 250,000 ppm TDS-300,000 ppm TDS, from 175,000 ppm TDS-200,000 ppm TDS, from 150,000 ppm TDS-250,000 ppm TDS, from 175,000 ppm TDS-250,000 ppm TDS, from 200,000 ppm TDS-250,000 ppm TDS, from 100,000 ppm TDS-200,000 ppm TDS, or from 50,000 ppm TDS-250,000 ppm TDS.

In some embodiments, the surfactant comprises average BO groups of from 0-10, of from 0-15, of from 0-20, of from 0-25, of from 0-30, of from 0-35, of from 0-40, or of from 0-45, of from 0-50, of from 0-55, or of from 0-60; average PO groups of from 0-10, of from 0-15, of from 0-20, of from 0-25, of from 0-30, of from 0-35, of from 0-40, or of from 0-45, of from 0-50, of from 0-55, or of from 0-60; average EO groups of from 0-10, of from 0-15, of from 0-20, of from 0-25, of from 0-30, of from 0-35, of from 0-40, of from 0-45, of from 0-50, of from 0-55, of from 0-60, of from 0-65, of from 0-70, of from 0-75, of from 0-80, of from 0-85, of from 0-90, of from 0-95; or any combination thereof.

In some embodiments, the hydrocarbons comprise H₂S. The H₂S can be present in an amount of at least 0.5 mol % (e.g., at least 1 mol %, at least 5 mol %, at least 10 mol %, at least 15 mol %, at least 20 mol %, at least 25 mol %, at least 30 mol %, at least 35 mol %, at least 40 mol %, at least 45 mol %). In some embodiments, the H₂S can be present in an amount of 50 mol % or less (e.g., 45 mol % or less, 40 mol % or less, 35 mol % or less, 30 mol % or less, 25 mol % or less, 20 mol % or less, 15 mol % or less, 10 mol % or less, 5 mol % or less, or 1 mol % or less).

The H₂S can be present in an amount ranging from any of the minimum values described above to any of the maximum values described above. For example, in some embodiments, the H₂S can be present in an amount of from 0.5% to 50% by weight (e.g., from 0.5 mol % to 45 mol %, of from 0.5 mol % to 40 mol %, of from 0.5 mol % to 35 mol %, of from 0.5 mol % to 30 mol %, of from 0.5 mol % to 25 mol %, of from 0.5 mol % to 20 mol %, of from 0.5 mol % to 15 mol %, of from 0.5 mol % to 10 mol %, of from 0.5 mol % to 9 mol %, of from 0.5 mol % to 8 mol %, of from 0.5 mol % to 7 mol %; of from 0.5 mol % to 6 mol %, of from 0.5 mol % to 5 mol %, of from 0.5 mol % to 4 mol %, of from 0.5 mol % to 3 mol %, of from 0.5 mol % to 2 mol %, of from 0.5 mol % to 1 mol %, of from 5 mol % to 20 mol %, or of from 5 mol % to 25 mol %). In some embodiments, the hydrocarbons comprise H₂S in an amount of from 0-0.5 mol %.

In example embodiments, the aqueous composition can comprise any type of water, treated or untreated, and can vary in salt content. For example, the aqueous composition can comprise hard water, hard brine, sea water, brackish water, fresh water, flowback or produced water, wastewater (e.g., reclaimed or recycled), river water, lake or pond water, aquifer water, brine (e.g., reservoir or synthetic brine), or any combination thereof. In some embodiments, the aqueous composition can comprise slickwater.

In some embodiments, the water comprises from 0 ppm to 25,000 ppm of divalent metal ions chosen from Ca²⁺, Mg²⁺, Sr²⁺, Ba²⁺, and combinations thereof. In some embodiments, the water can comprise hard water or hard brine. The hard water or hard brine comprises a divalent metal ion chosen from Ca²⁺, Mg²⁺, Sr²⁺, Ba²⁺, and any combination thereof. In certain embodiments, the hard water or hard brine can comprise at least 10 ppm at least 100 ppm, at least 500 ppm, at least 1,000 ppm, at least 5,000 ppm, or at least 10,000 ppm of divalent metal ions chosen from Ca²⁺, Mg²⁺, Sr²⁺, Ba²⁺, and any combination thereof. In certain examples, the hard water or hard brine can comprise from 100 ppm to 25,000 ppm of divalent metal ions chosen from Ca²⁺, Mg²⁺, Sr²⁺, Ba²⁺, and any combination thereof.

In some embodiments, the aqueous composition can include an acid, a polymer, a friction reducer, a gelling agent, a crosslinker, a breaker, a pH adjusting agent, a non-emulsifier agent, an iron control agent, a scale inhibitor, a corrosion inhibitor, a biocide, a clay stabilizing agent, a proppant, a wettability alteration chemical, a co-solvent (e.g., a C1-C5 alcohol, or an alkoxylated C1-C5 alcohol), or any combination thereof. In some embodiments, the pH adjusting agent comprises an acid, a base, or any combination thereof. In certain embodiments, the aqueous-based injection fluid can comprise an acid (e.g., at least 10% acid, such as from 10% to 20% by weight acid).

In some embodiments, the aqueous composition is substantially free of proppant. In certain embodiments, the aqueous composition can comprise a proppant. In some embodiments, the aqueous composition further includes a proppant, and wherein exclusive of the proppant, the aqueous composition has a maximum particle size of less than 0.1 micrometers in diameter in particle size distribution measurements performed at a temperature and salinity of the subterranean formation.

In some embodiments, the aqueous compositions can further include a co-solvent. Suitable co-solvents include alcohols, such as lower carbon chain alcohols such as isopropyl alcohol, ethanol, n-propyl alcohol, n-butyl alcohol, sec-butyl alcohol, n-amyl alcohol, sec-amyl alcohol, n-hexyl alcohol, sec-hexyl alcohol and the like; alcohol ethers, polyalkylene alcohol ethers, polyalkylene glycols, poly(oxyalkylene)glycols, poly(oxyalkylene)glycol ethers, ethoxylated phenol, or any other common organic co-solvent or any combination of any two or more co-solvents. In one embodiment, the co-solvent can comprise alkyl ethoxylate (C1-C6)-XEO X=1-30-linear or branched. In some embodiments, the co-solvent can comprise ethylene glycol butyl ether (EGBE), diethylene glycol monobutyl ether (DGBE), triethylene glycol monobutyl ether (TEGBE), ethylene glycol dibutyl ether (EGDE), polyethylene glycol monomethyl ether (mPEG), or any combination thereof. In some embodiments, the one or more co-solvents comprise a C1-C5 alcohol, an ethoxylated C1-C5 alcohol, a glycol ether, or any combination thereof.

The aqueous compositions provided herein may include more than one co-solvent. Thus, in embodiments, the aqueous composition includes a plurality of different co-solvents. Where the aqueous composition includes a plurality of different co-solvents, the different co-solvents can be distinguished by their chemical (structural) properties. For example, the aqueous composition may include a first co-solvent, a second co-solvent and a third co-solvent, wherein the first co-solvent is chemically different from the second and the third co-solvent, and the second co-solvent is chemically different from the third co-solvent. In embodiments, the plurality of different co-solvents includes at least two different alcohols (e.g., a C₁-C₆ alcohol and a C₁-C₄ alcohol). In embodiments, the aqueous composition includes a C₁-C₆ alcohol and a C₁-C₄ alcohol. In embodiments, the plurality of different co-solvents includes at least two different alkoxy alcohols (e.g., a C₁-C₆ alkoxy alcohol and a C₁-C₄ alkoxy alcohol). In embodiments, the aqueous composition includes a C₁-C₆ alkoxy alcohol and a C₁-C₄ alkoxy alcohol. In embodiments, the plurality of different co-solvents includes at least two co-solvents selected from the group consisting of alcohols, alkyl alkoxy alcohols and phenyl alkoxy alcohols. For example, the plurality of different co-solvents may include an alcohol and an alkyl alkoxy alcohol, an alcohol and a phenyl alkoxy alcohol, or an alcohol, an alkyl alkoxy alcohol and a phenyl alkoxy alcohol. The alkyl alkoxy alcohols or phenyl alkoxy alcohols provided herein have a hydrophobic portion (alkyl or aryl chain), a hydrophilic portion (e.g., an alcohol) and optionally an alkoxy (ethoxylate or propoxylate) portion. Thus, in embodiments, the co-solvent is an alcohol, alkoxy alcohol, glycol ether, glycol or glycerol. Suitable co-solvents are known in the art, and include, for example, co-surfactants described in U.S. Patent Application Publication No. 2013/0281327 which is hereby incorporated herein in its entirety.

The co-solvents can have a concentration within the aqueous composition of at least 0.01% by weight (e.g., at least 0.02% by weight, at least 0.03% by weight, at least 0.04% by weight, at least 0.05% by weight, at least 0.06% by weight, at least 0.07% by weight, at least 0.08% by weight, at least 0.09% by weight, at least 0.1% by weight, at least 0.15% by weight, at least 0.2% by weight, at least 0.25% by weight, at least 0.3% by weight, at least 0.35% by weight, at least 0.4% by weight, at least 0.45% by weight, at least 0.5% by weight, at least 0.55% by weight, at least 0.6% by weight, at least 0.65% by weight, at least 0.7% by weight, at least 0.75% by weight, at least 0.8% by weight, at least 0.85% by weight, at least 0.9% by weight, at least 0.95% by weight, at least 1% by weight, at least 1.25% by weight, at least 1.5% by weight, at least 1.75% by weight, at least 2% by weight, at least 2.5% by weight, at least 3% by weight, at least 3.5% by weight, at least 4% by weight, or at least 4.5% by weight), based on the total weight of the aqueous composition. In some embodiments, the co-solvents can have a concentration within the aqueous composition of 5% by weight or less (e.g., 4.5% by weight or less, 4% by weight or less, 3.5% by weight or less, 3% by weight or less, 2.5% by weight or less, 2% by weight or less, 1.75% by weight or less, 1.5% by weight or less, 1.25% by weight or less, 1% by weight or less, 0.95% by weight or less, 0.9% by weight or less, 0.85% by weight or less, 0.8% by weight or less, 0.75% by weight or less, 0.7% by weight or less, 0.65% by weight or less, 0.6% by weight or less, 0.55% by weight or less, 0.5% by weight or less, 0.45% by weight or less, 0.4% by weight or less, 0.35% by weight or less, 0.3% by weight or less, 0.25% by weight or less, 0.2% by weight or less, 0.15% by weight or less, 0.1% by weight or less, 0.09% by weight or less, 0.08% by weight or less, 0.07% by weight or less, 0.06% by weight or less, 0.05% by weight or less, 0.04% by weight or less, 0.03% by weight or less, or 0.02% by weight or less), based on the total weight of the aqueous composition.

The co-solvents can have a concentration within the aqueous composition ranging from any of the minimum values described above to any of the maximum values described above. For example, in some embodiments, the co-solvents can have a concentration within the aqueous composition of from 0.01% to 5% by weight (e.g., from 0.01% to 2.5% by weight, from 0.05% to 5% by weight, from 0.05% to 2.5% by weight, from 0.05% to 1% by weight, 0.02% to 5%, or from 0.05% to 0.5% by weight), based on the total weight of the aqueous composition.

In another aspect, the aqueous compositions as described herein can be formulated into injection compositions that further comprise a borate-acid buffer. The borate-acid buffer serves to buffer the pH of the composition. The composition can be buffered such that a minimal addition of an acid or base to the buffered composition will not substantially impact the pH of the composition. In some embodiments, the borate-acid buffer can exhibit a capacity to buffer at a pH of from at least 6 (e.g., a pH of at least 6.25, a pH of at least 6.5, a pH. of at least 6.75, a pH of at least 7, a pH of at least 7.25, a pH of at least 7.5, a pH, or of at least 7.75). In some embodiments, the borate-acid buffer can exhibit a capacity to buffer at a pH of 8.0 or less (e.g., a pH of 7.75 or less, a pH of 7.5 or less, a pH of 7.25 or less, a pH of 7 or less, a pH of 6.75 or less, a pH of 6.5 or less, or a pH of 6.25 or less).

The borate-acid buffer can exhibit a capacity to buffer at a pH ranging from any of the minimum values described above to any of the maximum values described above. For example, the borate-acid buffer can exhibit a capacity to buffer at a pH of from 6 to 8.0 (e.g., from 6.5 to 7.5, from 6 to 7.5, from 6.5 to 7, or from 6 to 7).

In certain embodiments, the borate-acid buffer can exhibit a capacity to buffer at a pH of less than 8. In certain embodiments, the borate-acid buffer can exhibit a capacity to buffer at a pH of less than 7.

In some cases, the borate-acid buffer can exhibit a capacity to buffer at a pH below a point of zero charge of a formation into which the composition will be injected as part of an oil and gas operation. In some embodiments, the borate-acid buffer exhibits a capacity to buffer at a pH below a point of zero charge of a subterranean formation comprising the hydrocarbons.

In some embodiments, the borate-acid buffer can comprise a borate compound and a conjugate base of an acid.

A variety of suitable boron compounds may be used. Examples of boron compounds include Borax, Sodium tetraborate decahydrate (Na₂B₄O₇.10H₂O), Borax pentahydrate (Na₂B₄O₇.5H₂O), Kernite (Na₂B₄O₇.4H₂O), Borax monohydrate (Na₂O.2B₂O₃.H₂O), Sodium metaborate tetrahydrate (NaBO₂.4H₂O or Na₂O.B₂O₃.8H₂O), Sodium metaborate dihydrate (NaBO₂.2H₂O or Na₂O.B₂O₃.4H₂O), Ezcurrite (2Na₂O.5.1B₂O₃.7H₂O), Auger's sodium borate/Nasinite (2Na₂O.5B₂O₃.5H₂O), Sodium pentaborate (Na₂O.5B₂O₃.10H₂O), Potassium metaborate (K₂O.B₂O₃.2.5H₂O), Potassium tetraborate (K₂O.2B₂O₃.8H₂O or 4H₂O), Auger's potassium pentaborate (2K₂O.5B₂O₃.5H₂O), Potassium pentaborate (K₂O.5B₂O₃.8H₂O), Lithium metaborate octahydrate (LiBO₂.8H₂O or Li₂O.B₂O₃.16H₂O), Lithium tetraborate trihydrate (Li₂O.2B₂O₃.3H₂O), Lithium pentaborate (Li₂O.5B₂O₃.10H₂O), Rubidium diborate (Rb₂O.2B₂O₃.5H₂O), Rubidium pentaborate (Rb₂O.5B₂O₃.8H₂O), Rubidium metaborate (Rb₂O.B₂O₃.3H₂O), Cesium Metaborate (Cs₂O.B₂O₃.7H₂O), Cesium diborate (Cs₂O.2B₂O₃.5H₂O), Cesium pentaborate (Cs₂O.5B₂O₃.8H₂O), Ammonium biborate ((NH₄)₂.2B₂O₃.4H₂O), Ammonium pentaborate ((NH₄)₂O.5B₂O₃.8H₂O), Larderellite, probably ((NH₄)₂O.5B₂O₃.4H₂O), Ammonioborite ((NH₄)₂O.5B₂O₃.5⅓H₂O), Kernite (Rasorite) (Na₂B₄O₂.4H₂O), Tincalconite (Mohavite) (Na₂B₄O₇.5H₂O), Borax (Tincal) (Na₂B₄O₇.10H₂O), Sborgite (Na₂B₁₀O₁₆.10H₂O), Ezcurrite (Na₄B₁₀O₁₇.7H₂O), Probertite (Kramerite) (NaCaB₅O₉.5H₂O), Ulxiete (Hayesine, Franklandite) (NaCaB₅O₉.8H₂O), Nobleite (CaB₆O₁₀.4H₂O), Gowerite (CaB₆O₁₀.5H₂O), Frolovite (Ca₂B₄O₈.7H₂O), Colemanite (Ca₂B₆O₁₁.5H₂O), Meyerhofferite (Ca₂B₆O₁₁.7H₂O), Inyoite (Ca₂B₆O₁₁.13H₂O), Priceite {(Pandermite) (Cryptomorphite)} (Ca₄B₁₀O₁₉.7H₂O), Tertschite (Ca₄B₁₀O₁₉.20H₂O), Ginorite (Ca₂B₁₄O₂₃.8H₂O), Pinnoite (MgB₂O₄.3H₂O), Paternoite (MgB₈O₁₃.4H₂O), Kurnakovite (Mg₂B₆O₁₁.15H₂O), Inderite (lesserite) (monoclinic) (Mg₂B₆O₁₁.15H₂O), Preobrazhenskite (Mg₃B₁₀O₁₈.4½H₂O), Hydroboracite (CaMgB₆O₁₁.6H₂O), Inderborite (CaMgB₆O₁₁.11H₂O), Kaliborite (Heintzite) (KMg₂BO₁₉.9H₂O), Larderellite ((NH₄)₂B₁₀O₁₆.4H₂O), Ammonioborite ((NH₄)₂B₁₀O₁₆5⅓H₂O), Veatchite (SrB₆O₁₀.2H₂O), p-Veatchite ((Sr,Ca)B₆O₁₀.2H₂O), Teepleite (Na₂B₂O₄.2Na₂Cl.4H₂O), Bandylite (CuB₂O₄.CuCl₂.4H₂O), Hilgardite (monocline) (3Ca₂B₆O₁₁.2CaCl₂.4H₂O), Parahilgardite (triclinic) (3Ca₂B₆O₁₁.2CaCl₂.4H₂O), Boracite (Mg₅B₁₄O₂₆MgCl₂), Fluoborite (Mg₃(BO₃)(F,OH)₃), Hambergite (Be₂(BO₃)(OH)), Sussexite ((Mn,Zn)(BO₂)(OH)), (Ascharite Camsellite) (Mg(BO₂)(OH)), Szaibelyite (Mg(BO₂)(OH)), Roweite ((Mn,Mg,Zn)Ca(BO₂)₂(OH)₂), Seamanite (Mn₃(PO₄)(BO₃).3H₂O), Wiserite (Mn₄B₂OS(OH,Cl)₄), Luneburgite (Mg₃B₂(OH)₆(PO₄)₂.6H₂O), Cahnite (Ca₂B(OH)₄(AsO₄)), Sulfoborite (Mg₆H₄(BO₃)₄(SO₄)₂.7H₂O), Johachidolite (H₆Na₂Ca₃Al₄F₅B₆O₂₀), Boric Acid, Sassolite (H₃BO₃), Jeremejewite (Eichwaldite) (AlBO₃), Kotoite (Mg₃(BO₃)₂), Nordenskioldine (CaSn(BO₃)₂), Rhodizite, Warwickite ((Mg,Fe)₃TiB₂O₆), Ludwigite (Ferro-ludwegite, Vonsenite) ((Mg,Fe^{II})₂Fe.^{III}BO₅), Paigeite ((Fe^{II},Mg)₂Fe.^{III}BO⁵), Pinakiolite (Mg₃Mn^{II}Mn₂^{III}B₂O₁₀), Axinite (2Al₂O₃.2(Fe,Mn)O.4CaO.H₂O.B₂O₃8SiO₂), Bakerite, Danburite (CaO.B₂O₃.2SiO₂), Datolite (2CaO.H₂O.B₂O₃.SiO₂), Dumortierite (8Al₂O₃.H₂OB₂O₃.6SiO₂), Grandidierite (11(Al,Fe,B)₂O₃.7(Mg,Fe,Ca)O.2(H,Na,K)_{2O}.7SiO₂), Homilite (2CaO.FeO.B₂O₃.2SiO₂), Howlite (4CaO.5H_{2O}.5B₂O₃.2SiO₂), Hyalotekite (16(Pb,Ba,Ca)O.F.2B₂O₃.2₄H₂O), Kornerupine, Manandonite (7Al₂O₃.2Li₂O.12H₂O.2B₂O₃.6SiO₂), Sapphirine, Searlesite (Na₂O.2H₂O.B₂O₃.4SiO₂), Serendibite (3Al₂O₃.2Ca.4MgO.B₂O₃.4SiO₂), and any combination thereof.

In certain embodiments, in boron compound can comprise a metaborate or a borax. In certain embodiments, the boron compound can comprise sodium tetraborate, calcium tetraborate, sodium borate, sodium metaborate, or any combination thereof. In embodiments, the boron compound comprises sodium metaborate. The term “sodium metaborate” as provided herein refers to the borate salt having the chemical formula NaBO₂4H₂O and in the customary sense, refers to CAS Registry No. 10555-76-7. In embodiments, the boron compound comprises borax. Other suitable compounds include, for example, barium borate or zinc borate.

The acid can comprise any suitable acid. For example, the acid can comprise acetic acid, citric acid, boric acid, tartaric acid, hydrochloric acid, succinic acid, or any combination thereof.

In some embodiments, the acid can comprise an organic acid. In some embodiment, the conjugate base of the acid comprises a chelator for a divalent metal ion (e.g., Mg²⁺ or Ca²⁺).

In some embodiments, the conjugate base of the acid comprises two or more heteroatoms (e.g., two or more oxygen atoms). In certain embodiments, the conjugate base comprises one or more carboxylate moieties. For example, the conjugate base can comprise acetate, citrate, tartrate, succinate, or any combination thereof.

The borate compound and the conjugate base of the organic acid can be present at a weight ratio of from 1:1 to 5:1 (e.g., from 1:1 to 3:1).

In some embodiments, the borate-acid buffer can comprise two or more different borate compounds, two or more conjugate bases of different acids, or any combination thereof. By way of illustration, the borate-acid buffer can be prepared by mixing two or more borate compounds with an acid, a borate compound with two or more acids, or two or more borate compounds with two or more acids.

In some embodiments, the borate-acid buffer comprises a borate compound, a conjugate base of a first acid, and a conjugate base of a second acid. In some cases, the first acid comprises acetic acid. In some cases, the second acid comprises an acid whose conjugate base has lower solubility in the aqueous composition than acetate. For example, the second acid can comprise citric acid.

In some embodiments, the borate-acid buffer can comprise a first borate compound, second borate compounds, and a conjugate base of an acid.

One of ordinary skill in the art will recognize that the borate-acid buffers described above can likewise be formed by combining boric acid with an alkali.

For example, borate-acid buffers can be formed by combining boric acid an alkali such as an acetate salt (e.g., sodium acetate, potassium acetate), a citrate salt (e.g., sodium citrate, potassium citrate), a tartrate salt (e.g., sodium tartrate, potassium tartrate, sodium potassium tartrate, potassium bitartrate), a hydroxide salt (e.g., sodium hydroxide, potassium hydroxide), a succinate salt (e.g., sodium succinate, potassium succinate), or any combination thereof.

In these examples, the alkali can form a conjugate acid that comprises a chelator for a divalent metal ion. In some cases, the conjugate acid can comprise two or more heteroatoms (e.g., two or more oxygen atoms). In certain cases, the conjugate acid can comprise one or more carboxylate moieties.

The borate-acid buffer can have a concentration within the aqueous composition of at least 0.05% by weight (e.g., at least 0.06% by weight, at least 0.07% by weight, at least 0.08% by weight, at least 0.09% by weight, at least 0.1% by weight, at least 0.15% by weight, at least 0.2% by weight, at least 0.25% by weight, at least 0.3% by weight, at least 0.35% by weight, at least 0.4% by weight, at least 0.45% by weight, at least 0.5% by weight, at least 0.55% by weight, at least 0.6% by weight, at least 0.65% by weight, at least 0.7% by weight, at least 0.75% by weight, at least 0.8% by weight, at least 0.85% by weight, at least 0.9% by weight, at least 0.95% by weight, at least 1% by weight, at least 1.25% by weight, at least 1.5% by weight, at least 1.75% by weight, at least 2% by weight, at least 2.5% by weight, at least 3% by weight, at least 3.5% by weight, at least 4% by weight, or at least 4.5% by weight), based on the total weight of the aqueous composition. In some embodiments, the borate-acid buffer can have a concentration within the aqueous composition of 5% by weight or less (e.g., 4.5% by weight or less, 4% by weight or less, 3.5% by weight or less, 3% by weight or less, 2.5% by weight or less, 2% by weight or less, 1.75% by weight or less, 1.5% by weight or less, 1.25% by weight or less, 1% by weight or less, 0.95% by weight or less, 0.9% by weight or less, 0.85% by weight or less, 0.8% by weight or less, 0.75% by weight or less, 0.7% by weight or less, 0.65% by weight or less, 0.6% by weight or less, 0.55% by weight or less, 0.5% by weight or less, 0.45% by weight or less, 0.4% by weight or less, 0.35% by weight or less, 0.3% by weight or less, 0.25% by weight or less, 0.2% by weight or less, 0.15% by weight or less, 0.1% by weight or less, 0.09% by weight or less, 0.08% by weight or less, 0.07% by weight or less, or 0.06% by weight or less), based on the total weight of the aqueous composition.

The borate-acid buffer can have a concentration within the aqueous composition ranging from any of the minimum values described above to any of the maximum values described above. For example, in some embodiments, the borate-acid buffer can have a concentration within the aqueous composition of from 0.05% to 5% by weight (e.g., from 0.05% to 5% by weight, from 0.05% to 2.5% by weight, from 0.05% to 1% by weight, or from 0.05% to 0.5% by weight), based on the total weight of the aqueous composition.

In some embodiments, the aqueous composition can have a temperature of at least 25° C. (e.g., at least 30° C., at least 40° C., at least 50° C., at least 60° C., at least 70° C., at least 80° C., at least 90° C., at least 100° C., or at least 110° C.). The aqueous composition can have a temperature of 150° C. or less (e.g., 140° C. or less, 130° C. or less, 120° C. or less, 110° C. or less, 100° C. or less, 90° C. or less, 80° C. or less, 70° C. or less, 60° C. or less, 50° C. or less, 40° C. or less, or 30° C. or less).

The aqueous composition can have a temperature ranging from any of the minimum values described above to any of the maximum values described above. For example, the aqueous composition can have a temperature of from 25° C. to 150° C. (e.g., from 30° C. to 150° C., of from 40° C. to 150° C., of from 50° C. to 150° C., of from 60° C. to 150° C., of from 70° C. to 150° C., of from 80° C. to 150° C., of from 90° C. to 150° C., of from 100° C. to 150° C., of from 110° C. to 150° C., of from 120° C. to 150° C., of from 130° C. to 150° C., of from 140° C. to 150° C., of from 25° C. to 120° C., of from 25° C. to 100° C., or of from 25° C. to 50° C.). In some embodiments, the temperature can be of from 80° C. to 150° C., of from 90° C. to 150° C., of from 100° C. to 150° C., of from 110° C. to 150° C., of from 120° C. to 150° C., of from 130° C. to 150° C., of from 140° C. to 150° C.

In some embodiments, the aqueous composition can have a viscosity of between 20 mPas and 100 mPas at 20° C. The viscosity of the aqueous solution may be increased from 0.3 mPas to 1, 2, 10, 20, 100 or even 1000 mPas by including a water-soluble polymer. The apparent viscosity of the aqueous composition may be increased with a gas (e.g., a foam forming gas) as an alternative to the water-soluble polymer. In some embodiments, the composition can have a viscosity of from 2 cP to 30 cP at room temperature (e.g., from 2 cP 10 cP).

In some embodiments, the aqueous compositions can further include a polymer, such as a water-soluble polymer. In some embodiments, the water-soluble polymer may be a biopolymer such as xanthan gum or scleroglucan, a synthetic polymer such as polyacryamide, hydrolyzed polyarcrylamide or co-polymers of acrylamide and acrylic acid, 2-acrylamido 2-methyl propane sulfonate or N-vinyl pyrrolidone, a synthetic polymer such as polyethylene oxide, or any other high molecular weight polymer soluble in water or brine. In some embodiments, the polymer is polyacrylamide (PAM), partially hydrolyzed polyacrylamides (HPAM), and copolymers of 2-acrylamido-2-methylpropane sulfonic acid or sodium salt or mixtures thereof, and polyacrylamide (PAM) commonly referred to as AMPS copolymer and mixtures of the copolymers thereof. In one embodiment, the water-soluble polymer is polyacrylamide or a copolymer of polyacrylamide. In one embodiment, the water-soluble polymer is a partially (e.g. 20%, 25%, 30%, 35%, 40%, 45%) hydrolyzed anionic polyacrylamide. Molecular weights of the polymers may range from about 10,000 Daltons to about 20,000,000 Daltons. In some embodiments, the water-soluble polymer is used in the range of about 100 to about 5000 ppm concentration, such as from about 1000 to 2000 ppm (e.g., in order to match or exceed the reservoir oil viscosity under the reservoir conditions of temperature and pressure). The polymer can be a powder polymer, a liquid polymer, or an emulsion polymer.

Some examples of polymers are discussed in the following: U.S. Pat. No. 9,909,053 (Docket No. T-9845A), U.S. Pat. No. 9,896,617 (Docket No. T-9845B), U.S. Pat. No. 9,902,894 (Docket No. T-9845C), U.S. Pat. No. 9,902,895 (Docket No. T-9846), U.S. Patent Application Publication No. 2017/0158947, U.S. Patent Application Publication No. 2017/0158948, and U.S. Patent Application Publication No. 2018/0155505, each of which is incorporated by reference in its entirety. More examples of polymers may be found in Dwarakanath et al., “Permeability Reduction Due to use of Liquid Polymers and Development of Remediation Options,” SPE 179657, SPE IOR Symposium in Tulsa, 2016, which is incorporated by reference in its entirety.

In some embodiments, the injection composition can further include a gas. For instance, the gas may be combined with the aqueous composition to reduce its mobility by decreasing the liquid flow in the pores of the solid material (e.g., rock). In some embodiments, the gas may be supercritical carbon dioxide, nitrogen, natural gas or mixtures of these and other gases.

In some embodiments, the aqueous composition may be a single-phase fluid.

In some embodiments, the aqueous composition comprises a foam. In some embodiments, the surfactant packages as described herein can be combined with one or more additional components to form a foamed composition.

In some embodiments, the surfactant package can have a concentration within the aqueous composition of 2.5% by weight or less (e.g., 2.25% by weight or less, 2% by weight or less, 1.75% by weight or less, 1.5% by weight or less, 1.25% by weight or less, 1% by weight or less, 0.95% by weight or less, 0.9% by weight or less, 0.85% by weight or less, 0.8% by weight or less, 0.75% by weight or less, 0.7% by weight or less, 0.65% by weight or less, 0.6% by weight or less, 0.55% by weight or less, 0.5% by weight or less, 0.45% by weight or less, 0.4% by weight or less, 0.35% by weight or less, 0.3% by weight or less, 0.25% by weight or less, 0.2% by weight or less, 0.15% by weight or less, 0.1% by weight or less, 0.09% by weight or less, 0.08% by weight or less, 0.07% by weight or less, 0.06% by weight or less, 0.05% by weight or less, 0.04% by weight or less, 0.03% by weight or less, or 0.02% by weight or less), based on the total weight of the aqueous composition.

The surfactant package can have a concentration within the aqueous composition ranging from any of the minimum values described above to any of the maximum values described above. For example, in some embodiments, the surfactant package can have a concentration within the aqueous composition of from 0.01% to 2.5% by weight (e.g., from 0.05% to 0.5% by weight), based on the total weight of the aqueous composition.

When present, the an alkyl aryl sulfonate, a cationic surfactant, a zwitterionic surfactant, an amphoteric surfactant, a gemini surfactant, an alkyl benzene sulfonate (ABS), a disulfonate, a second disulfonate surfactant with at least one different R⁴ group, an alkyl polyglucoside, an alkyl polyglucoside carboxylate, a second olefin sulfonate, a second surfactant with branched, unbranched, saturated, or unsaturated C6-C32:BO(0-65):PO(0-65):EO(0-100)-X, or any combination thereof can have a concentration within the aqueous composition of at least 0.001% by weight (e.g., at least 0.005% by weight, at least 0.01% by weight, at least 0.02% by weight, at least 0.03% by weight, at least 0.04% by weight, at least 0.05% by weight, at least 0.06% by weight, at least 0.07% by weight, at least 0.08% by weight, at least 0.09% by weight, at least 0.1% by weight, at least 0.15% by weight, at least 0.2% by weight, at least 0.25% by weight, at least 0.3% by weight, at least 0.35% by weight, at least 0.4% by weight, at least 0.45% by weight, at least 0.5% by weight, at least 0.55% by weight, at least 0.6% by weight, at least 0.65% by weight, at least 0.7% by weight, at least 0.75% by weight, at least 0.8% by weight, at least 0.85% by weight, at least 0.9% by weight, at least 0.95% by weight, at least 1% by weight, at least 1.25% by weight, at least 1.5% by weight, at least 1.75% by weight, at least 2% by weight, or at least 2.25% by weight), based on the total weight of the aqueous composition. In some embodiments, the an alkyl aryl sulfonate, a cationic surfactant, a zwitterionic surfactant, an amphoteric surfactant, a gemini surfactant, an alkyl benzene sulfonate (ABS), a disulfonate, a second disulfonate surfactant with at least one different R⁴ group, an alkyl polyglucoside, an alkyl polyglucoside carboxylate, a second olefin sulfonate, a second surfactant with branched, unbranched, saturated, or unsaturated C6-C32:BO(0-65):PO(0-65):EO(0-100)-X, or any combination thereof can have a concentration within the aqueous composition of 2.5% by weight or less (e.g., 2.25% by weight or less, 2% by weight or less, 1.75% by weight or less, 1.5% by weight or less, 1.25% by weight or less, 1% by weight or less, 0.95% by weight or less, 0.9% by weight or less, 0.85% by weight or less, 0.8% by weight or less, 0.75% by weight or less, 0.7% by weight or less, 0.65% by weight or less, 0.6% by weight or less, 0.55% by weight or less, 0.5% by weight or less, 0.45% by weight or less, 0.4% by weight or less, 0.35% by weight or less, 0.3% by weight or less, 0.25% by weight or less, 0.2% by weight or less, 0.15% by weight or less, 0.1% by weight or less, 0.09% by weight or less, 0.08% by weight or less, 0.07% by weight or less, 0.06% by weight or less, 0.05% by weight or less, 0.04% by weight or less, 0.03% by weight or less, 0.02% by weight or less, 0.01% by weight or less, or 0.005% by weight or less), based on the aqueous composition.

When present, the an alkyl aryl sulfonate, a cationic surfactant, a zwitterionic surfactant, an amphoteric surfactant, a gemini surfactant, an alkyl benzene sulfonate (ABS), a disulfonate, a second disulfonate surfactant with at least one different R⁴ group, an alkyl polyglucoside, an alkyl polyglucoside carboxylate, a second olefin sulfonate, a second surfactant with branched, unbranched, saturated, or unsaturated C6-C32:BO(0-65):PO(0-65):EO(0-100)-X, or any combination thereof can have a concentration within the aqueous composition ranging from any of the minimum values described above to any of the maximum values described above. For example, in some embodiments, the an alkyl aryl sulfonate, a cationic surfactant, a zwitterionic surfactant, an amphoteric surfactant, a gemini surfactant, an alkyl benzene sulfonate (ABS), a disulfonate, a second disulfonate surfactant with at least one different R⁴ group, an alkyl polyglucoside, an alkyl polyglucoside carboxylate, a second olefin sulfonate, a second surfactant with branched, unbranched, saturated, or unsaturated C6-C32:BO(0-65):PO(0-65):EO(0-100)-X, or any combination thereof can have a concentration within the aqueous composition of from 0.001% to 2.5% by weight (e.g., from 0.001% to 1.5% by weight, or from 0.05% to 0.5% by weight), based on the total weight of the aqueous composition.

In some embodiments, the surfactant package and the an alkyl aryl sulfonate, a cationic surfactant, a zwitterionic surfactant, an amphoteric surfactant, a gemini surfactant, an alkyl benzene sulfonate (ABS), a disulfonate, a second disulfonate surfactant with at least one different R⁴ group, an alkyl polyglucoside, an alkyl polyglucoside carboxylate, a second olefin sulfonate, a second surfactant with branched, unbranched, saturated, or unsaturated C6-C32:BO(0-65):PO(0-65):EO(0-100)-X, or any combination thereof can be present in the aqueous composition in a weight ratio of surfactant package to the an alkyl aryl sulfonate, a cationic surfactant, a zwitterionic surfactant, an amphoteric surfactant, a gemini surfactant, an alkyl benzene sulfonate (ABS), a disulfonate, a second disulfonate surfactant with at least one different R⁴ group, an alkyl polyglucoside, an alkyl polyglucoside carboxylate, a second olefin sulfonate, a second surfactant with branched, unbranched, saturated, or unsaturated C6-C32:BO(0-65):PO(0-65):EO(0-100)-X, or any combination thereof of at least 1:1 (e.g., at least 2:1, at least 2.5:1, at least 3:1, at least 4:1, at least 5:1, at least 6:1, at least 7:1, at least 8:1, or at least 9:1).

The surfactant package and the an alkyl aryl sulfonate, a cationic surfactant, a zwitterionic surfactant, an amphoteric surfactant, a gemini surfactant, an alkyl benzene sulfonate (ABS), a disulfonate, a second disulfonate surfactant with at least one different R⁴ group, an alkyl polyglucoside, an alkyl polyglucoside carboxylate, a second olefin sulfonate, a second surfactant with branched, unbranched, saturated, or unsaturated C6-C32:BO(0-65):PO(0-65):EO(0-100)-X, or any combination thereof can be present in the aqueous composition, the surfactant package, or both in a weight ratio ranging from any of the minimum values described above to any of the maximum values described above. For example, the surfactant package and the an alkyl aryl sulfonate, a cationic surfactant, a zwitterionic surfactant, an amphoteric surfactant, a gemini surfactant, an alkyl benzene sulfonate (ABS), a disulfonate, a second disulfonate surfactant with at least one different R⁴ group, an alkyl polyglucoside, an alkyl polyglucoside carboxylate, a second olefin sulfonate, a second surfactant with branched, unbranched, saturated, or unsaturated C6-C32:BO(0-65):PO(0-65):EO(0-100)-X, or any combination thereof can be present in the aqueous composition, the surfactant package, or both in a weight ratio of surfactant package to the an alkyl aryl sulfonate, a cationic surfactant, a zwitterionic surfactant, an amphoteric surfactant, a gemini surfactant, an alkyl benzene sulfonate (ABS), a disulfonate, a second disulfonate surfactant with at least one different R⁴ group, an alkyl polyglucoside, an alkyl polyglucoside carboxylate, a second olefin sulfonate, a second surfactant with branched, unbranched, saturated, or unsaturated C6-C32:BO(0-65):PO(0-65):EO(0-100)-X, or any combination thereof of from 1:1 to 10:1 (e.g., 1:1 to 5:1).

In some embodiments when the aqueous composition is being injected into a horizontal well, the total concentration of all surfactants in the aqueous composition can be from 0.01% to 1.5% by weight, from 0.01% to 1% by weight, or from 0.01% to 0.5% by weight).

In some embodiments when the aqueous composition is being injected into a vertical well, the total concentration of all surfactants in the aqueous composition can be from 0.01% to 5% by weight, from 0.01% to 1% by weight, from 0.5% to 5% by weight, from 0.5% to 2.5% by weight, from 0.5% to 1.5% by weight, from 0.5% to 1% by weight, from 1% to 5% by weight, from 1% to 2.5% by weight, from or 1% to 1.5% by weight).

In some embodiments, the surfactant package can be added to the water to form the aqueous composition. For example, the surfactant, olefin sulfonate, and optionally the disulfonate can be pre-mixed as components of the surfactant package. Alternatively, the surfactant, olefin sulfonate, and optionally the disulfonate can be separately combined with (e.g., sequentially added to) the water to form the aqueous composition. In other embodiments, the the surfactant, olefin sulfonate, and optionally the disulfonate can be added separately or together to water when preparing slickwater in a tank. In some embodiments, the the surfactant, olefin sulfonate, and optionally the disulfonate can be mixed with one or more additional components prior to combination with the aqueous-based injection fluid.

The surfactant package (and ultimately the aqueous composition) can be selected to improve hydrocarbon recovery. Specifically, the surfactant package can improve hydrocarbon recovery by increasing the aqueous stability of the aqueous composition at the temperature and salinity of the reservoir, decreasing the interfacial tension (IFT) of the aqueous composition with hydrocarbons in the reservoir, changing (e.g., increasing or decreasing the wettability of the reservoir, or any combination thereof.

In some embodiments, the surfactant package (and ultimately the aqueous composition) can increase the aqueous stability of the LPS injection fluid at the temperature and salinity of the reservoir. In some embodiments, the aqueous composition is aqueous stable, chemical stable, and thermal stable for at least 7 days.

Aqueous stable solutions can propagate further into a reservoir upon injection as compared to an injection fluid lacking aqueous stability. In addition, because injected chemicals remain soluble aqueous stable solutions, aqueous stable solutions do not precipitate particulates or phase separate within the formation which may obstruct or hinder fluid flow through the reservoir. As such, injection fluids that exhibit aqueous stability under reservoir conditions can largely eliminate formation damage associated with precipitation of injected chemicals. In this way, hydrocarbon recovery can be facilitated by the one or more surfactants in the surfactant package.

In some embodiments, the surfactant package (and ultimately the aqueous composition) can decrease the interfacial tension (IFT) of the aqueous composition with hydrocarbons in the reservoir. Reducing the IFT can decrease pressure required to drive an aqueous composition into the formation matrix. In addition, decreasing the IFT reduces water block during production, facilitating the flow of hydrocarbons from the formation to the wellbore (e.g., facilitating the flow of hydrocarbons back through the fractures and to the wellbore). In this way, hydrocarbon recovery can be facilitated by the surfactant package.

In some embodiments, the surfactant package (and ultimately the aqueous composition) can change the wettability of the reservoir. In particular, in embodiments where the reservoir is oil-wet or mixed-wet, the surfactant package (and ultimately the aqueous composition) can make the reservoir more water-wet. By increasing the water-wetness of the reservoir, the formation will imbibe injected aqueous composition into the formation matrix, leading to a corresponding flow of hydrocarbon from regions within the formation back to the fracture. In this way, hydrocarbon recovery can be facilitated by the surfactant package.

In some embodiments, the surfactant package can improve hydrocarbon recovery by increasing the aqueous stability of the aqueous composition at the temperature and salinity of the reservoir and decreasing the interfacial tension (IFT) of the aqueous composition with hydrocarbons in the reservoir. In some embodiments, the surfactant package can improve hydrocarbon recovery by decreasing the interfacial tension (IFT) of the aqueous composition with hydrocarbons in the reservoir and increasing the wettability of the reservoir. In some embodiments, the surfactant package can improve hydrocarbon recovery by increasing the aqueous stability of the aqueous composition at the temperature and salinity of the reservoir and increasing the wettability of the reservoir. In certain embodiments, the surfactant package can improve hydrocarbon recovery by increasing the aqueous stability of the aqueous composition at the temperature and salinity of the reservoir, decreasing the interfacial tension (IFT) of the aqueous composition with hydrocarbons in the reservoir, and changing the wettability of the reservoir.

In an embodiment, the surfactant package is tested by determining the mean particle size distribution through dynamic light scattering. In specific embodiments, the mean particle size distribution of the aqueous composition decreases after addition of the surfactant package. In embodiments, the average diameter of particle size of the aqueous composition is less than 0.1 micrometers. In an embodiment, when tested at the specific reservoir temperature and salinity, the average diameter of the aqueous composition is less than 0.1 micrometers. In specific embodiments, the average diameter in particle size distribution measurement of the aqueous composition is less than the average pore size of the unconventional reservoir rock matrix.

In some embodiments, the foamed composition can comprise a viscosity-modifying polymer. Examples of viscosity-modifying polymer are known in the art. Examples of suitable polymers include biopolymers such as polysaccharides. For example, polysaccharides can be xanthan gum, scleroglucan, guar gum, a mixture thereof (e.g., any modifications thereof such as a modified chain), etc. Indeed, the terminology “mixtures thereof” or “combinations thereof” can include “modifications thereof” herein. Examples of suitable synthetic polymers include polyacrylamides. Examples of suitable polymers include synthetic polymers such as partially hydrolyzed polyacrylamides (HPAMs or PHPAs) and hydrophobically-modified associative polymers (APs). Also included are co-polymers of polyacrylamide (PAM) and one or both of 2-acrylamido 2-methylpropane sulfonic acid (and/or sodium salt) commonly referred to as AMPS (also more generally known as acrylamido tertiobutyl sulfonic acid or ATBS), N-vinyl pyrrolidone (NVP), and the NVP-based synthetic may be single-, co-, or ter-polymers. In one embodiment, the synthetic polymer is polyacrylic acid (PAA). In one embodiment, the synthetic polymer is polyvinyl alcohol (PVA). Copolymers may be made of any combination or mixture above, for example, a combination of NVP and ATBS. In certain embodiments, the viscosity-modifying polymer can comprise an uncrosslinked polymer. In some embodiments, the viscosity-modifying polymer can be present in the foamed composition in an amount of from 0.1% to 25% by weight (e.g., from 0.1% to 10% by weight, or from 0.5% to 5% by weight) of the total weight of the foamed composition.

In some embodiments, the foamed composition can further comprise a foam stabilizer. Foam stabilizers are known in the art and include, for example, crosslinkers, particulate stabilizers, and any combination thereof.

In some embodiments, the foamed composition can further include a crosslinker, such as a borate crosslinking agent, a Zr crosslinking agent, a Ti crosslinking agent, an Al crosslinking agent, an organic crosslinker, or any combination thereof. When present, the viscosity-modifying polymer and the crosslinker can be present in a weight ratio of from 20:1 to 100:1.

In some embodiments, the foamed composition can further include a particulate stabilizer (e.g., nanoparticles or microparticles). Examples of suitable nanoparticles and microparticles are known in the art, and include, for example, nickel oxide, alumina, silica (surface-modified), a silicate, iron oxide (Fe₃O₄), titanium oxide, impregnated nickel on alumina, synthetic clay, natural clay, iron zinc sulfide, magnetite, iron octanoate, or any combination thereof. Other examples of suitable nanoparticles are described, for example, in U.S. Pat. No. 10,266,750, which is hereby incorporated by reference in its entirety.

Some compositions described herein may comprise a buffer. Embodiments of a buffer that may be utilized herein may be found in U.S. Provisional Patent Application No. 62/712,944 and U.S. patent application Ser. No. 16/528,183, and copies of these two patent applications accompany this disclosure. These two patent applications, Ser. Nos. 62/712,944 and Ser. No. 16/528,183, are incorporated by reference. U.S. patent application Ser. No. 16/528,183 is published as U.S. Patent Publication No. 2020/005608 and International Publication No. WO 2020/028567 is also incorporated by reference. Specific example embodiments include aqueous compositions comprising surfactant packages, and optional buffer, in the table below.

Specific example embodiments include aqueous compositions comprising the surfactant packages (and in some cases co-solvents) in the table below.

| | Surfactants and Co-Solvents in Aqueous Composition |
|---|---|
| Example | (in weight percent) |
| 1 | 0.2% alkoxylated C6-C16 alcohol |
| | 0.05% Alkyl alkoxy carboxylate |
| | 0.05% olefin sulfonate |
| 2 | 0.15% alkoxylated C6-C16 alcohol |
| | 0.05% Alkyl alkoxy carboxylate |
| | 0.05% olefin sulfonate |
| | 0.05% alkyl polyglucoside |
| 3 | 0.1% alkoxylated C6-C16 alcohol |
| | 0.05% Alkyl alkoxy carboxylate |
| | 0.05% olefin sulfonate |
| | 0.1% alkyl polyglucoside |
| 4 | 0.15% alkoxylated C6-C16 alcohol |
| | 0.07% Alkyl alkoxy carboxylate |
| | 0.03% olefin sulfonate |
| | 0.1% alkyl polyglucoside |
| 5 | 0.1% alkoxylated C6-C16 alcohol |
| | 0.04% Alkyl alkoxy carboxylate |
| | 0.05% olefin sulfonate |
| | 0.03% disulfonate |
| | 0.1% alkyl polyglucoside |
| 6 | 0.1% alkoxylated C6-C16 alcohol |
| | 0.04% Alkyl alkoxy carboxylate |
| | 0.06% disulfonate |
| | 0.1% alkyl polyglucoside |
| 7 | 0.15% alkoxylated C6-C16 alcohol |
| | 0.15% alkoxylated alkylphenol |
| | 0.1% olefin sulfonate |
| | 0.1% Guerbet alkoxylated carboxylate |
| 8 | 0.125% alkoxylated C6-C16 alcohol |
| | 0.175% alkoxylated alkylphenol |
| | 0.1% olefin sulfonate |
| | 0.1% Guerbet alkoxylated carboxylate |
| 9 | 0.1% alkoxylated C6-C16 alcohol |
| | 0.2% alkoxylated alkylphenol |
| | 0.1% olefin sulfonate |
| | 0.1% Guerbet alkoxylated carboxylate |
| 10 | 0.12% alkoxylated C6-C16 alcohol |
| | 0.22% alkoxylated alkylphenol |
| | 0.08% olefin sulfonate |
| | 0.08% Guerbet alkoxylated carboxylate |
| 11 | 0.15% alkoxylated C6-C16 alcohol |
| | 0.15% alkoxylated alkylphenol |
| | 0.08% olefin sulfonate |
| | 0.06% Guerbet alkoxylated carboxylate |
| | 0.06% carboxylate |
| 12 | 0.15% alkoxylated C6-C16 alcohol |
| | 0.15% alkoxylated alkylphenol |
| | 0.05% olefin sulfonate |
| | 0.1% Guerbet alkoxylated carboxylate |
| | 0.05% disulfonate |
| 13 | 0.5% olefin sulfonate |
| | 0.5% Guerbet alkoxylated carboxylate |
| | 0.55% glycosides or glucosides |
| 14 | 0.5% olefin sulfonate |
| | 0.5% Guerbet alkoxylated carboxylate |
| | 0.5% glycosides or glucosides |
| | 0.25% alkoxylated C6-C16 alcohol |
| 15 | 0.5% olefin sulfonate |
| | 0.5% Guerbet alkoxylated carboxylate |
| | 0.5% glycosides or glucosides |
| | 0.5% alkoxylated C6-C16 alcohol |
| 16 | 0.5% olefin sulfonate |
| | 0.5% Guerbet alkoxylated carboxylate |
| | 1% glycosides or glucosides |
| | 0.5% alkoxylated C6-C16 alcohol |
| 17 | 0.05% olefin sulfonate |
| | 0.05% Guerbet alkoxylated carboxylate |
| | 0.05% glycosides or glucosides |
| | 0.05% alkoxylated C6-C16 alcohol |
| 18 | 0.03% olefin sulfonate |
| | 0.04% Guerbet alkoxylated carboxylate |
| | 0.08% glycosides or glucosides |
| | 0.05% alkoxylated C6-C16 alcohol |
| 19 | 0.4% olefin sulfonate |
| | 0.4% Guerbet alkoxylated carboxylate |
| | 0.7% glycosides or glucosides |
| | 0.5% alkoxylated C6-C16 alcohol |
| 20 | 0.05% olefin sulfonate |
| | 0.1% glycosides or glucosides |
| | 0.05% alkoxylated C6-C16 alcohol |
| 21 | 0.05% olefin sulfonate |
| | 0.1% alkyl polyglucoside |
| | 0.05% alkoxylated C6-C16 alcohol |
| 22 | 0.05% olefin sulfonate |
| | 0.1% glycosides or glucosides |
| | 0.05% alkoxylated C6-C16 alcohol |
| 23 | 0.05% olefin sulfonate |
| | 0.1% alkyl polyglucoside |
| | 0.05% alkoxylated C6-C16 alcohol |
| 24 | 0.05% olefin sulfonate |
| | 0.1% alkyl polyglucoside |
| | 0.05% alkoxylated C6-C16 alcohol |
| 25 | 0.05% olefin sulfonate |
| | 0.05% glycosides or glucosides |
| | 0.05% alkoxylated C6-C16 alcohol |
| | 0.05% carboxylate |
| 26 | 0.05% olefin sulfonate |
| | 0.05% glycosides or glucosides |
| | 0.05% alkoxylated C6-C16 alcohol |
| | 0.05% carboxylate |
| 27 | 0.05% olefin sulfonate |
| | 0.05% alkyl polyglucoside |
| | 0.05% alkoxylated C6-C16 alcohol |
| 28 | 0.06% olefin sulfonate |
| | 0.05% alkyl polyglucoside |
| | 0.04% alkoxylated C6-C16 alcohol |
| 29 | 0.04% olefin sulfonate |
| | 0.08% glycosides or glucosides |
| | 0.05% alkoxylated C6-C16 alcohol |
| | 0.03% disulfonate |
| 30 | 0.035% olefin sulfonate |
| | 0.075% glycosides or glucosides |
| | 0.05% alkoxylated C6-C16 alcohol |
| | 0.04% disulfonate |
| 31 | 0.035% olefin sulfonate |
| | 0.07% glycosides or glucosides |
| | 0.045% alkoxylated C6-C16 alcohol |
| | 0.05% disulfonate |
| 32 | 0.1% alkoxylated C6-C16 alcohol |
| | 0.1% disulfonate |
| 33 | 0.25% Guerbet alkoxylated carboxylate |
| | 0.25% olefin sulfonate |
| | 0.5% glycosides or glucosides |
| | 0.5% co-solvent |
| 34 | 0.075% disulfonate |
| | 0.075% alkoxylated C6-C16 alcohol |
| 35 | 1% alkoxylated C6-C16 alcohol |
| | 0.5% disulfonate |
| 36 | 1% alkoxylated C6-C16 alcohol |
| 37 | 1% alkoxylated C6-C16 alcohol |
| | 2.25% sulfosuccinate |
| 38 | 0.25% Guerbet alkoxylated carboxylate |
| | 1% alkoxylated C6-C16 alcohol |
| | 2.25% sulfosuccinate |
| 39 | 0.25% Guerbet alkoxylated carboxylate |
| | 1% alkoxylated alkylphenol |
| | 2.25% sulfosuccinate |
| 40 | 0.25% Guerbet alkoxylated carboxylate |
| | 1% alkoxylated C6-C16 alcohol |
| 41 | 0.25% olefin sulfonate |
| | 1.0% alkoxylated C6-C16 alcohol |
| 42 | 0.15% olefin sulfonate |
| | 0.2% Guerbet alkoxylated carboxylate |
| | 0.92% carboxylate |
| 43 | 0.65% Alkyl alkoxy carboxylate |
| | 0.35% alkoxylated C6-C16 alcohol |
| | 1% olefin sulfonate |
| 44 | 1% alkoxylated alcohol |
| | 1% olefin sulfonate |
| 45 | 0.5% alkoxylated alcohol |
| | 0.5% olefin sulfonate |
| | 0.25% Alkyl alkoxy carboxylate |
| 46 | 0.6% co-solvent |
| | 0.6% olefin sulfonate |
| 47 | 0.6% co-solvent |
| | 0.3% disulfonate |
| | 0.3% olefin sulfonate |
| 48 | 0.6% Guerbet alkoxylated carboxylate |
| | 0.6% disulfonate |
| 49 | 0.6% co-solvent |
| | 0.4% disulfonate |
| | 0.2% olefin sulfonate |
| 50 | 0.5% alkoxylated C6-C16 alcohol |
| | 0.4% disulfonate |
| | 0.3% olefin sulfonate |
| 51 | 1% alkoxylated C6-C16 alcohol |
| 52 | 0.9% alkoxylated C6-C16 alcohol |
| | 0.6% disulfonate |
| 53 | 0.4% alkoxylated C6-C16 alcohol |
| | 0.35% disulfonate |
| | 0.25% olefin sulfonate |
| | 0.5% co-solvent |
| 54 | 0.25% Guerbet alkoxylated carboxylate |
| | 0.5% alkoxylated C6-C16 alcohol |
| | 0.35% disulfonate |
| | 0.15% olefin sulfonate |
| | 0.35% co-solvent |
| 55 | 0.25% Guerbet alkoxylated carboxylate |
| | 0.25% alkoxylated C6-C16 alcohol |
| | 0.25% olefin sulfonate |
| | 0.25% co-solvent |
| 56 | 0.25% Guerbet alkoxylated carboxylate |
| | 0.25% alkoxylated C6-C16 alcohol |
| | 0.25% olefin sulfonate |
| | 0.25% alkoxylated alcohol |
| 57 | 0.25% Guerbet alkoxylated carboxylate |
| | 0.35% olefin sulfonate |
| | 0.5% alkoxylated alcohol |
| 58 | 0.25% Guerbet alkoxylated carboxylate |
| | 0.25% alkoxylated C6-C16 alcohol |
| | 0.15% olefin sulfonate |
| | 0.1% disulfonate |
| | 0.25% co-solvent |
| 59 | 0.25% Guerbet alkoxylated carboxylate |
| | 0.25% alkoxylated C6-C16 alcohol |
| | 0.25% olefin sulfonate |
| | 0.25% glycosides or glucosides |
| | 0.25% co-solvent |
| | 0.15% disulfonate |
| 60 | 0.25% Guerbet alkoxylated carboxylate |
| | 0.25% olefin sulfonate |
| | 0.5% glycosides or glucosides |
| | 0.25% co-solvent |
| 61 | 0.075% alkoxylated C6-C132 Guerbet alcohol |
| | 0.075% disulfonate |
| 62 | 0.1% alkoxylated C6-C16 alcohol |
| | 0.1% disulfonate |
| | 0.1% Guerbet alkoxylated carboxylate |
| 63 | 0.65% Guerbet alkoxylated carboxylate |
| | 0.35% olefin sulfonate |
| | 0.33% alkoxylated alkylphenol |
| | 0.5% co-solvent |
| | 0.25% second co-solvent |
| | With or without 0.5-2% Borate buffer |
| 64 | 0.9% Guerbet alkoxylated carboxylate |
| | 1.2% olefin sulfonate |
| | 0.225% co-solvent |
| | With or without 0.5-2% Borate buffer |
| 65 | 0.9% Guerbet alkoxylated carboxylate |
| | 0.9% alkoxylated C6-C16 alcohol |
| | 1.2% olefin sulfonate |
| | 0.225% co-solvent |
| | With or without 0.5-2% Borate buffer |
| 66 | 1% alkoxylated C6-C16 alcohol |
| | 1% olefin sulfonate |
| 67 | 1% alkoxylated C6-C16 alcohol |
| | 0.75% olefin sulfonate |
| | 0.5% disulfonate |
| 68 | 1% alkoxylated C6-C16 alcohol |
| | 0.75% olefin sulfonate |
| | 0.3% disulfonate |
| 69 | 0.5% alkoxylated C6-C16 alcohol |
| | 0.85% olefin sulfonate |
| | 0.15% disulfonate |
| 70 | 0.9% Guerbet alkoxylated carboxylate |
| | 0.9% alkoxylated C6-C16 alcohol |
| | 1.2% olefin sulfonate |
| | 0.225% co-solvent |
| | With or without 0.5-2% Borate buffer |
| 71 | 1% alkoxylated C6-C16 alcohol |
| | 0.75% olefin sulfonate |
| | 0.3% disulfonate |
| 72 | 0.9% Guerbet alkoxylated carboxylate |
| | 0.9% alkoxylated C12-C22 alcohol |
| | 1.2% olefin sulfonate |
| | 0.225% co-solvent |
| | With or without 0.5-2% Borate buffer |
| 73 | 0.5% Guerbet alkoxylated carboxylate |
| | 0.5% alkoxylated C12-C22 alcohol |
| | 0.15% olefin sulfonate |
| | 0.35% disulfonate |
| | 0.5% alkoxylated alkylphenol |
| | 0.13% co-solvent |
| | With or without 0.5-2% Borate buffer |
| 74 | 0.5% Guerbet alkoxylated carboxylate |
| | 0.5% alkoxylated C12-C22 alcohol |
| | 0.5% disulfonate |
| | 0.5% alkoxylated alkylphenol |
| | 0.13% co-solvent |
| | With or without 0.5-2% Borate buffer |
| 75 | 0.5% Guerbet alkoxylated carboxylate |
| | 0.5% alkoxylated C6-C16 alcohol |
| | 0.5% olefin sulfonate |
| | 0.5% disulfonate |
| | With or without 0.5-2% Borate buffer |
| 76 | 0.5% C6-C16 alcohol alkoxylated carboxylate |
| | 0.25% alkoxylated C6-C16 alcohol |
| | 0.15% olefin sulfonate |
| | 0.35% disulfonate |
| | With or without 0.5-2% Borate buffer |
| 77 | 0.5% Guerbet alkoxylated carboxylate |
| | 0.25% C6-C16 alcohol alkoxylated carboxylate |
| | 0.5% alkoxylated C12-C22 alcohol |
| | 0.5% olefin sulfonate |
| | 0.1% disulfonate |
| | 0.5% co-solvent |
| | With or without 0.5-2% Borate buffer |
| 78 | 0.5% C6-C16 alcohol alkoxylated carboxylate |
| | 0.25% alkoxylated C6-C16 alcohol |
| | 0.15% olefin sulfonate |
| | 0.35% disulfonate |
| | 2% Borate buffer |
| | With or without 0.5-2% Borate buffer |
| 79 | 0.5% Guerbet alkoxylated carboxylate |
| | 0.5% alkoxylated C6-C16 alcohol |
| | 0.15% olefin sulfonate |
| | 0.35% disulfonate |
| | 0.25% cetyl betaine |
| | 2% borate buffer |
| | With or without 0.5-2% Borate buffer |
| 80 | 0.5% Guerbet alkoxylated carboxylate |
| | 0.25% C6-C16 alcohol alkoxylated carboxylate |
| | 0.5% alkoxylated C6-C16 alcohol |
| | 0.5% olefin sulfonate |
| | 0.1% disulfonate |
| | 0.5% co-solvent |
| | 0.02% cetyl Betaine |
| | With or without 0.5-2% Borate buffer |
| 81 | 0.5% olefin sulfonate |
| | 0.5% alkyl aryl sulfonate |
| | 0.5% disulfonate |
| 82 | 0.5% olefin sulfonate |
| | 0.5% alkyl aryl sulfonate |
| | 0.5% disulfonate |
| | 2% co-solvent |
| 83 | 0.5% olefin sulfonate |
| | 0.5% alkyl aryl sulfonate |
| | 0.5% disulfonate |
| | 2% co-solvent |
| 84 | 0.5% olefin sulfonate |
| | 0.5% alkyl aryl sulfonate |
| | 0.5% disulfonate |
| | 0.5% alkoxylated C6-C16 alcohol |
| | 0.5% co-solvent |
| 85 | 0.5% olefin sulfonate |
| | 0.5% alkyl aryl sulfonate |
| | 0.5% disulfonate |
| | 0.5% alkoxylated alkylphenol |
| 86 | 0.5% olefin sulfonate |
| | 0.5% alkyl aryl sulfonate |
| | 0.5% alkoxylated alkylphenol |
| 87 | 1% alkoxylated C6-C16 alcohol |
| | 1% olefin sulfonate mixture |
| | 0.28% co-solvent |
| 88 | 1% alkoxylated C6-C16 alcohol |
| | 0.75% olefin sulfonate |
| | 0.5% disulfonate |
| 89 | 1% alkoxylated C6-C16 alcohol |
| | 0.75% olefin sulfonate |
| | 0.5% disulfonate |
| | 0.43% co-solvent |
| 90 | 1% alkoxylated C6-C16 alcohol |
| | 0.75% olefin sulfonate |
| | 0.3% disulfonate |
| | With or without 0.5-2% Borate buffer |
| 91 | 1% alkoxylated C6-C16 alcohol |
| | 0.75% olefin sulfonate |
| | 0.3% disulfonate |
| | 0.43% co-solvent |
| 92 | 0.5% alkoxylated C6-C16 alcohol |
| | 0.85% olefin sulfonate |
| | 0.15% disulfonate |
| 93 | 0.5% alkoxylated C6-C16 alcohol |
| | 0.85% olefin sulfonate |
| | 0.15% disulfonate |
| | 0.5% co-solvent |
| | With or without 0.5-2% Borate buffer |
| 94 | 1% Guerbet alkoxylated carboxylate |
| | 1% alkoxylated C6-C16 alcohol |
| | 1% disulfonate |
| | 0.5% co-solvent |
| | With or without 0.5-2% Borate buffer |
| 95 | 0.5% alkoxylated C6-C16 alcohol |
| | 0.15% olefin sulfonate |
| | 0.35% disulfonate |
| | With or without 0.5-2% Borate buffer |
| 96 | 0.5% alkoxylated C6-C16 alcohol |
| | 0.15% olefin sulfonate |
| | 0.35% disulfonate |
| | 0.5% alkoxylated phenol co-solvent |
| | With or without 0.5-2% Borate buffer |
| 97 | 0.5% Guerbet alkoxylated carboxylate |
| | 0.5% alkoxylated C12-C22 alcohol |
| | 0.15% olefin sulfonate |
| | 0.35% disulfonate |
| | 0.25% cetyl betaine |
| | With or without 0.5-2% Borate buffer |
| 98 | 0.5% Guerbet alkoxylated carboxylate |
| | 0.25% C6-C16 alcohol alkoxylated carboxylate |
| | 0.5% alkoxylated C12-C22 alcohol |
| | 0.5% olefin sulfonate |
| | 0.1% disulfonate |
| | 0.5% co-solvent |
| | 0.02% cetyl Betaine |
| | With or without 0.5-2% Borate buffer |
| 100 | 0.5% Guerbet alkoxylated carboxylate |
| | 0.5% alkoxylated C12-C22 alcohol |
| | 0.25% olefin sulfonate |
| | 0.25% disulfonate |
| | 0.5% co-solvent |
| | With or without 0.5-2% Borate buffer |
| 101 | 0.5% Guerbet alkoxylated carboxylate |
| | 0.5% alkoxylated C12-C22 alcohol |
| | 0.25% olefin sulfonate mixture |
| | 0.35% disulfonate |
| | 0.5% co-solvent |
| | With or without 0.5-2% Borate buffer |
| 102 | 0.5% Guerbet alkoxylated carboxylate |
| | 0.25% alkoxylated C12-C22 alcohol |
| | 0.25% olefin sulfonate mixture |
| | 0.35% disulfonate |
| | 0.5% co-solvent |
| | With or without 0.5-2% Borate buffer |
| 103 | 0.5% Guerbet alkoxylated carboxylate |
| | 0.25% C6-C16 alcohol alkoxylated carboxylate |
| | 0.25% alkoxylated C12-C22 alcohol |
| | 0.1% olefin sulfonate |
| | 0.5% disulfonate |
| | 0.5% co-solvent |
| | With or without 0.5-2% Borate buffer |
| 104 | 1% Guerbet alkoxylated carboxylate |
| | 0.5% alkoxylated C12-C22 alcohol |
| | 0.0.5% olefin sulfonate |
| | 0.7% disulfonate |
| | 0.5% alkoxylated alkylphenol |
| | 0.8% co-solvent |
| | With or without 0.5-2% Borate buffer |
| 105 | 0.75% Guerbet alkoxylated carboxylate |
| | 0.25% alkoxylated C12-C22 alcohol |
| | 0.1% olefin sulfonate |
| | 0.5% disulfonate |
| | 0.5% co-solvent |
| | With or without 0.5-2% Borate buffer |
| 106 | 0.5% Guerbet alkoxylated carboxylate |
| | 0.25% alkoxylated C12-C22 alcohol |
| | 0.25% olefin sulfonate |
| | 0.35% disulfonate |
| | 0.5% co-solvent |
| | With or without 0.5-2% Borate buffer |
| 107 | 0.35% Guerbet alkoxylated carboxylate |
| | 0.25% alkoxylated C12-C22 alcohol |
| | 0.1% olefin sulfonate |
| | 0.4% disulfonate |
| | 0.23% co-solvent |
| | With or without 0.5-2% Borate buffer |
| 108 | 0.75% C6-C16 alcohol alkoxylated carboxylate |
| | 0.25% alkoxylated C12-C22 alcohol |
| | 0.1% olefin sulfonate |
| | 0.5% disulfonate |
| | 0.5% co-solvent |
| | With or without 0.5-2% Borate buffer |
| 109 | 1% Guerbet alkoxylated carboxylate |
| | 0.1% alkoxylated C12-C22 alcohol |
| | 0.4% C12-C22 alcohol alkoxylated carboxylate |
| | 0.5% olefin sulfonate |
| | 0.7% disulfonate |
| | 0.8% co-solvent |
| | With or without 0.5-2% Borate buffer |
| 110 | 0.8% Guerbet alkoxylated carboxylate |
| | 0.2% Guerbet alkoxylated alcohol |
| | 0.5% alkoxylated C12-C22 alcohol |
| | 0.5% olefin sulfonate |
| | 0.7% disulfonate |
| | With or without 0.5-2% Borate buffer |
| 111 | 0.6% Guerbet alkoxylated carboxylate |
| | 0.4% Guerbet alkoxylated alcohol |
| | 0.5% alkoxylated C12-C22 alcohol |
| | 0.5% olefin sulfonate |
| | 0.7% disulfonate |
| | With or without 0.5-2% Borate buffer |
| 112 | 0.4% Guerbet alkoxylated carboxylate |
| | 0.6% Guerbet alkoxylated alcohol |
| | 0.5% alkoxylated C12-C22 alcohol |
| | 0.5% olefin sulfonate |
| | 0.7% disulfonate |
| | With or without 0.5-2% Borate buffer |
| 113 | 1% Guerbet alkoxylated carboxylate |
| | 0.2% alkoxylated C12-C22 alcohol |
| | 0.3% C12-C22 alcohol alkoxylated carboxylate |
| | 0.5% olefin sulfonate |
| | 0.7% disulfonate |
| | 0.8% co-solvent |
| | With or without 0.5-2% Borate buffer |
| 114 | 1% Guerbet alkoxylated carboxylate |
| | 0.5% olefin sulfonate |
| | 0.7% disulfonate |
| | 1% alkoxylated alkylphenol |
| | With or without 0.5-2% Borate buffer |
| 115 | 1% Guerbet alkoxylated carboxylate |
| | 0.5% alkoxylated C6-C16 alcohol |
| | 0.5% olefin sulfonate |
| | 0.7% disulfonate |
| | With or without 0.5-2% Borate buffer |
| 116 | 1% Guerbet alkoxylated carboxylate |
| | 0.3% alkoxylated C12-C22 alcohol |
| | 0.2% C12-C22 alcohol alkoxylated carboxylate |
| | 0.5% olefin sulfonate |
| | 0.7% disulfonate |
| | 0.8% co-solvent |
| | With or without 0.5-2% Borate buffer |
| 117 | 1% Guerbet alkoxylated carboxylate |
| | 0.2% C12-C22 alcohol alkoxylated carboxylate |
| | 0.5% olefin sulfonate |
| | 0.7% disulfonate |
| | 0.8% co-solvent |
| | With or without 0.5-2% Borate buffer |
| 118 | 0.5% Guerbet alkoxylated carboxylate |
| | 0.25% alkoxylated C12-C22 alcohol |
| | 0.1% olefin sulfonate |
| | 0.5% disulfonate |
| | 0.5% co-solvent |
| | With or without 0.5-2% Borate buffer |
| 119 | 0.5% Guerbet alkoxylated carboxylate |
| | 0.25% alkoxylated C12-C22 alcohol |
| | 0.1% olefin sulfonate |
| | 0.5% disulfonate |
| | With or without 0.5-2% Borate buffer |
| 120 | 0.5% Guerbet alkoxylated carboxylate |
| | 0.1% olefin sulfonate |
| | 0.5% disulfonate |
| | With or without 0.5-2% Borate buffer |
| 121 | 0.35% Guerbet alkoxylated carboxylate |
| | 0.1% olefin sulfonate |
| | 0.55% disulfonate |
| | With or without 0.5-2% Borate buffer |
| 122 | 0.35% Guerbet alkoxylated carboxylate |
| | 0.1% olefin sulfonate |
| | 0.55% disulfonate |
| | 0.25% alkyl polyglucoside carboxylate |
| | With or without 0.5-2% Borate buffer |
| 123 | 0.35% Guerbet alkoxylated carboxylate |
| | 0.25% alkoxylated C12-C22 alcohol |
| | 0.1% olefin sulfonate |
| | 0.55% disulfonate mixture |
| | With or without 0.5-2% Borate buffer |
| 124 | 0.35% Guerbet alkoxylated carboxylate |
| | 0.1% olefin sulfonate |
| | 0.55% disulfonate mixture |
| | With or without 0.5-2% Borate buffer |
| 125 | 0.35% Guerbet alkoxylated carboxylate |
| | 0.1% olefin sulfonate |
| | 0.55% disulfonate |
| | With or without 0.5-2% Borate buffer |
| 126 | 0.35% Guerbet alkoxylated carboxylate |
| | 0.1% alkoxylated C12-C22 alcohol |
| | 0.1% olefin sulfonate |
| | 0.55% disulfonate mixture |
| | With or without 0.5-2% Borate buffer |
| 127 | 0.35% Guerbet alkoxylated carboxylate |
| | 0.1% alkoxylated C12-C22 alcohol |
| | 0.2% olefin sulfonate |
| | 0.55% disulfonate mixture |
| | With or without 0.5-2% Borate buffer |
| 128 | 0.35% Guerbet alkoxylated carboxylate |
| | 0.1% alkoxylated Guerbet alcohol |
| | 0.1% olefin sulfonate |
| | 0.55% disulfonate mixture |
| | With or without 0.5-2% Borate buffer |
| 129 | 0.35% Guerbet alkoxylated carboxylate |
| | 0.25% alkoxylated Guerbet alcohol |
| | 0.1% olefin sulfonate |
| | 0.55% disulfonate mixture |
| | With or without 0.5-2% Borate buffer |
| 130 | 0.35% Guerbet alkoxylated carboxylate |
| | 0.5% alkoxylated Guerbet alcohol |
| | 0.1% olefin sulfonate |
| | 0.55% disulfonate mixture |
| | With or without 0.5-2% Borate buffer |
| 131 | 0.35% Guerbet alkoxylated carboxylate |
| | 0.5% alkoxylated Guerbet alcohol |
| | 0.1% olefin sulfonate |
| | 0.55% disulfonate mixture |
| | 0.2% co-solvent |
| | With or without 0.5-2% Borate buffer |
| 132 | 1% Guerbet alkoxylated carboxylate |
| | 0.25% alkoxylated C12-C22 alcohol |
| | 0.5% olefin sulfonate mixture |
| | 0.7% disulfonate mixture |
| | With or without 0.5-2% Borate buffer |
| 133 | 1% Guerbet alkoxylated carboxylate |
| | 0.25% alkoxylated Guerbet alcohol |
| | 0.5% olefin sulfonate mixture |
| | 0.7% disulfonate mixture |
| | With or without 0.5-2% Borate buffer |
| 134 | 1% Guerbet alkoxylated carboxylate |
| | 0.2% C12-C22 alcohol alkoxylated carboxylate |
| | 0.5% olefin sulfonate |
| | 0.7% disulfonate |
| | 0.8% co-solvent |
| | With or without 0.5-2% Borate buffer |
| 135 | 1% Guerbet alkoxylated carboxylate |
| | 0.5% olefin sulfonate mixture |
| | 0.7% disulfonate mixture |
| | With or without 0.5-2% Borate buffer |
| 136 | 0.35% Guerbet alkoxylated carboxylate |
| | 0.1% olefin sulfonate |
| | 0.8% Di sulfonate |
| | 0.1% alkoxylated C6-C18 alcohol |
| | With and without Borate buffer |
| 137 | 0.35% Guerbet alkoxylated carboxylate |
| | 0.1% olefin sulfonate |
| | 0.8% Di sulfonate |
| | 0.25% alkoxylated Guerbet alcohol |
| | With and without Borate buffer |
| 138 | 0.35% alkoxylated Guerbet alcohol |
| | 0.15% olefin sulfonate |
| | 0.8% Disulfonate |
| 139 | 0.35% alkoxylated Guerbet alcohol |
| | 0.1% olefin sulfonate |
| | 0.8% Disulfonate |
| 140 | 0.35% alkoxylated Guerbet alcohol |
| | 0.2% olefin sulfonate |
| | 0.8% Disulfonate |
| 141 | 0.35% alkoxylated Guerbet alcohol |
| | 0.5% olefin sulfonate |
| | 0.8% Disulfonate |
| 142 | 0.25% alkoxylated Guerbet alcohol |
| | 0.25% alkoxylated C6-C18 alcohol |
| | 0.2% olefin sulfonate |
| | 0.8% Disulfonate |
| 143 | 0.25% alkoxylated Guerbet alcohol |
| | 0.25% alkoxylated C6-C18 alcohol |
| | 0.2% olefin sulfonate |
| | 0.7% Disulfonate |
| 144 | 0.25% alkoxylated C6-C18 alcohol |
| | 0.2% olefin sulfonate |
| | 0.55% Disulfonate |
| 145 | 0.35% alkoxylated Guerbet alcohol |
| | 0.5% olefin sulfonate |

Methods

Also provided are methods of using the compositions described herein in oil and gas operations. The oil and gas operation can comprise for example, an enhanced oil recovery (EOR) operation (e.g., an improved oil recovery (IOR) operation, a surfactant (S) flooding operation, an alkaline-surfactant (AS) flooding operation, a surfactant-polymer (SP) flooding operation, a alkaline-surfactant-polymer (ASP) flooding operation, a conformance control operation, or any combination thereof) a hydraulic fracturing operation, a wellbore clean-up operation, a stimulation operation, or any combination thereof. In certain examples, the surfactant compositions described herein can be used as an injection fluid, as a component of an injection fluid, as a hydraulic fracturing fluid, or as a component of a hydraulic fracturing fluid.

For example, provided herein are methods for treating a subterranean formation. The method including injecting an aqueous composition described herein into a subterranean formation through a wellbore in fluid communication with the subterranean formation. In some embodiments, the subterranean formation comprises an unconventional subterranean formation. In some embodiments, the compositions described herein can be used in treatment operations in an unconventional subterranean formation.

In some embodiments, the method further including: adding a tracer to the aqueous composition prior to introducing or along with the aqueous composition or through the wellbore into the subterranean formation; recovering the tracer from fluids produced from the subterranean formation through the wellbore, fluids recovered from a different wellbore in fluid communication with the subterranean formation, or any combination thereof, and comparing the quantity of tracer recovered from the fluids produced to the quantity of tracer introduced. The tracer can comprise a proppant tracer, an oil tracer, a water tracer, or any combination thereof. Example tracers are known in the art, and described, for example, in U.S. Pat. No. 9,914,872 and Ashish Kumar et al., Diagnosing Fracture-Wellbore Connectivity Using Chemical Tracer Flowback Data, URTeC 2902023, Jul. 23-25, 2018, page 1-10, Texas, USA.

In some embodiments, the method further comprises producing fluids from the subterranean formation through the wellbore. In some embodiments, the producing fluids include the hydrocarbons.

For example, the aqueous compositions (injection compositions) described herein can be used as part of a completion and/or fracturing operation. Accordingly, methods of treating the subterranean formation can comprise a fracturing operation. For example, the method can comprise injecting the aqueous fluid into the subterranean formation through the wellbore at a sufficient pressure to create or extend at least one fracture in a rock matrix of the subterranean formation in fluid communication with the wellbore.

In certain embodiments, the fracturing operation can comprise combining a surfactant package described herein with one or more additional components to form an aqueous composition; and injecting the aqueous composition through a wellbore and into the unconventional subterranean formation at a sufficient pressure and at a sufficient rate to fracture the unconventional subterranean formation. In some embodiments, the wellbore is a hydraulic fracturing wellbore associated with a hydraulic fracturing well, for example, that may have a substantially vertical portion only, or a substantially vertical portion and a substantially horizontal portion below the substantially vertical portion. In some embodiments, the fracturing operation can be performed in a new well (e.g., a well that has not been previously fractured). In other embodiments, the aqueous composition can be used in a fracturing operation in an existing well (e.g., in a refracturing operation).

In some embodiments, the method can comprise performing a fracturing operation on a region of the subterranean formation proximate to a new wellbore. In some embodiments, the method can comprise performing a fracturing operation on a region of the subterranean formation proximate to an existing wellbore. In some embodiments, the method can comprise performing a refracturing operation on a previously fractured region of the subterranean formation proximate to a new wellbore. In some embodiments, the method can comprise performing a refracturing operation on a previously fractured region of the subterranean formation proximate to an existing wellbore. In some embodiments, the method can comprise performing a fracturing operation on a naturally fractured region of the subterranean formation proximate to a new wellbore (e.g., an infill well). In some embodiments, the method can comprise performing a fracturing operation on a naturally fractured region of the subterranean formation proximate to an existing wellbore.

In cases where the fracturing method comprises a refracturing method, the previously fractured region of the unconventional reservoir can have been fractured by any suitable type of fracturing operation. For example, the fracturing operation may include hydraulic fracturing, fracturing using electrodes such as described in U.S. Pat. No. 9,890,627 (Attorney Dkt. No. T-9622A), U.S. Pat. No. 9,840,898 (Attorney Dkt. No. T-9622B), U.S. Patent Publication No. 2018/0202273 (Attorney Dkt. No. T-9622A-CIP), or fracturing with any other available equipment or methodology.

The aqueous composition can be used at varying points throughout a fracturing operation. For example, the aqueous compositions described herein can be used as an aqueous composition during the first, middle or last part of the fracturing process, or throughout the entire fracturing process. In some embodiments, the fracturing process can include a plurality of stages and/or sub-stages. For example, the fracturing process can involve sequential injection of fluids in different stages, with each of the stages employing a different aqueous-based injection fluid system (e.g., with varying properties such as viscosity, chemical composition, etc.). Example fracturing processes of this type are described, for example, in U.S. Patent Application Publication Nos. 2009/0044945 and 2015/0083420, each of which is hereby incorporated herein by reference in its entirely.

In these embodiments, the aqueous compositions described herein can be used as an injection fluid (optionally with additional components) during any or all of the stages and/or sub-stages. Stages and/or sub-stages can employ a wide variety of aqueous-based injection fluid systems, including linear gels, crosslinked gels, and friction-reduced water. Linear gel fracturing fluids are formulated with a wide array of different polymers in an aqueous base. Polymers that are commonly used to formulate these linear gels include guar, hydroxypropyl guar (HPG), carboxymethyl HPG (CMHPG), and hydroxyethyl cellulose (HEC). Crosslinked gel fracturing fluids utilize, for example, borate ions to crosslink the hydrated polymers and provide increased viscosity. The polymers most often used in these fluids are guar and HPG. The crosslink obtained by using borate is reversible and is triggered by altering the pH of the fluid system. The reversible characteristic of the crosslink in borate fluids helps them clean up more effectively, resulting in good regained permeability and conductivity. The surfactant packages described herein can be added to any of these aqueous-based injection fluid systems.

In some embodiments, the surfactant packages described herein can be combined with one or more additional components in a continuous process to form the aqueous compositions described herein (which is subsequently injected). In other embodiments, the surfactant package can be intermittently added to one or more additional components, thereby providing the injections compositions only during desired portions of the treatment operation (e.g., during one or more phases or stages of a fracturing operation). For example, the surfactant package could be added when injecting slickwater, when injecting fracturing fluid with proppant, during an acid wash, or during any combination thereof. In a specific embodiment, the surfactant package is continuously added to the one or more additional components after acid injection until completion of hydraulic fracturing and completion fluid flow-back. When intermittently dosed, the surfactant package can be added to the one or more additional components once an hour, once every 2 hours, once every 4 hours, once every 5 hours, once every 6 hours, twice a day, once a day, or once every other day, for example. In some embodiments when used in a fracturing operation, the aqueous composition can have a total surfactant concentration of from 0.01% to 1% by weight, based on the total weight of the aqueous composition.

In some embodiments, the aqueous compositions described herein can be used as part of a reservoir stimulation operation (also referred to as wellbore cleanup operations or near-wellbore cleanup operations). The stimulation operation can be performed on a conventional subterranean formation or an unconventional subterranean formation. The stimulation operation can be performed on a subterranean formation that is fractured (naturally fractured and/or previously fractured in a fracturing operation) or unfractured. The stimulation operation can be performed in a new wellbore or an existing wellbore.

In some operations, the fluid can be injected to alter the wettability of existing fractures within the formation (without further fracturing the formation significantly by either forming new fractures within the formation and/or extending the existing fractures within the formation). In such stimulation operations, no proppant is used, and fluid injection generally occurs at a lower pressure.

In some cases, the existing fractures can be naturally occurring fractures present within a formation. For example, in some embodiments, the formation can comprise naturally fractured carbonate or naturally fractured sandstone. The presence or absence of naturally occurring fractures within a subterranean formation can be assessed using standard methods known in the art, including seismic surveys, geology, outcrops, cores, logging, reservoir characterization including preparing grids, etc.

In some embodiments, methods for stimulating a subterranean formation with a fluid can comprise (a) injecting an aqueous composition (injection composition) as described herein through a wellbore into the subterranean formation; (b) allowing the aqueous composition to imbibe into a rock matrix of the subterranean formation for a period of time; and (c) producing fluids from the subterranean formation through the wellbore. In some embodiments, the method further comprises ceasing introduction of the aqueous composition through the wellbore into the subterranean formation before allowing step (b). The aqueous composition can comprise a surfactant package and one or more additional components as described herein. In these methods, the same wellbore can be used for both introducing the injection composition and producing fluids from the subterranean formation., the same wellbore can be used. In some embodiments, introduction of the injection composition can increase the production of hydrocarbons from the same wellbore, from a different wellbore in fluid communication with the subterranean formation, or any combination thereof.

In some embodiments, the stimulation operation can further comprise preparing the aqueous composition. For example, in some embodiments, the stimulation operation can further comprise combining a surfactant package described herein with one or more additional components to form an injection composition.

In some embodiments when used in a stimulation operation, the aqueous composition can have a total surfactant concentration of from 0.2% to 5% by weight, based on the total weight of the aqueous composition.

In some embodiments, introducing an aqueous composition as described herein through a wellbore into the subterranean formation can comprise injecting the aqueous composition through the wellbore and into the subterranean formation at a sufficient pressure and at a sufficient rate to stimulate hydrocarbon production from naturally occurring fractures in the subterranean formation.

The aqueous composition as described herein can be allowed to contact the rock matrix (e.g., to imbibe into the rock matrix) of the subterranean formation for varying periods of time depending on the nature of the rock matrix. The imbibing can occur during the introducing step, between the introducing and producing step, or any combination thereof. In some examples, the aqueous composition can be allowed to imbibe into the rock matrix of the subterranean formation for at least one day (e.g., at least two days, at least three days, at least four days, at least five days, at least six days, at least one week, at least two weeks, at least three weeks, at least one month, at least two months, at least three months, at least four months, or at least five months). In some examples, the aqueous composition can be allowed to imbibe into the rock matrix of the subterranean formation for six months or less (e.g., five months or less, four months or less, three months or less, two months or less, one month or less, three weeks or less, two weeks or less, one week or less, six days or less, five days or less, four days or less, three days or less, or two days or less).

The aqueous composition can be allowed to imbibe into the rock matrix of the subterranean formation for a period of time ranging from any of the minimum values described above to any of the maximum values described above. For example, in some embodiments, the aqueous composition can be allowed to imbibe into the rock matrix of the subterranean formation for a period of time of from one day to six months (e.g., from one week to one month, from two weeks to one month, from three weeks to one month, from one week to two months, from two weeks to two months, from three weeks to two months, from one week to three months, from one week to six months, from one month to two months, from one month to three months, from one month to four months, from one month to five months, from one month to six months, from two months to three months, from three months to four months, from four months to six months, from three months to six months)

In some embodiments, the wellbore used in the stimulation operation may have a substantially vertical portion only, or a substantially vertical portion and a substantially horizontal portion below the substantially vertical portion.

In some embodiments, the stimulation methods described herein can comprise stimulating a naturally fractured region of the subterranean formation proximate to a new wellbore (e.g., an infill well). In some embodiments, the stimulation methods described herein can comprise stimulating a naturally fractured region of the subterranean formation proximate to an existing wellbore.

In some embodiments, the stimulation methods described herein can comprise stimulating a previously fractured or previously refractured region of the subterranean formation proximate to a new wellbore (e.g., an infill well). In some embodiments, the stimulation methods described herein can comprise stimulating a previously fractured or previously refractured region of the subterranean formation proximate to an existing wellbore.

The previous refracturing operation may include hydraulic fracturing, fracturing using electrodes such as described in U.S. Pat. No. 9,890,627 (Attorney Dkt. No. T-9622A), U.S. Pat. No. 9,840,898 (Attorney Dkt. No. T-9622B), U.S. Patent Publication No. 2018/0202273 (Attorney Dkt. No. T-9622A-CIP), or refracturing with any other available equipment or methodology. In some embodiments, after a formation that has fractures, such as naturally occurring factures, fractures from a fracture operation, fractures from a refracturing operation, or any combination thereof, the fractured formation may be stimulated. For example, a formation may be stimulated after a sufficient amount of time has passed since the fracturing operation with electrodes or refracturing operation with electrodes occurred in that formation so that the electrical pulses utilized to fracture or refracture that formation do not substantially affect the aqueous composition.

In some embodiments, the subterranean formation can have a permeability of from 26 millidarcy to 40,000 millidarcy. In some embodiments, the unconventional subterranean formation can have a permeability of less than 25 mD, such as a permeability of from 25 mD to 1.0×10⁻⁶ mD, from 10 mD to 1.0×10⁻⁶ mD, or from 10 to 0.1 millidarcy (mD).

In some embodiments, the injection of the aqueous composition increases a relative permeability in a region of the subterranean formation proximate to the wellbore. In some embodiments, the injection of the aqueous composition releases hydrocarbons from pores in a rock matrix in a region of the subterranean formation proximate to the existing wellbore. In some embodiments, the method remediates near wellbore damage.

In some embodiments, the methods of treating the subterranean formation can comprise an EOR operation. For example, the wellbore can comprise an injection wellbore, and the method can comprise a method for hydrocarbon recovery that comprises (a) injecting the aqueous fluid (a surfactant composition) through the injection wellbore into the subterranean formation; and (b) producing fluids from a production wellbore spaced apart from the injection wellbore a predetermined distance and in fluid communication with the subterranean formation. The injection of the aqueous fluid can increase the flow of hydrocarbons to the production well.

Also provided are methods of displacing a hydrocarbon material in contact with a solid material. These methods can include contacting a hydrocarbon material with an aqueous composition (injection composition) described herein, wherein the hydrocarbon material is in contact with a solid material. The hydrocarbon material is allowed to separate from the solid material thereby displacing the hydrocarbon material in contact with the solid material.

In other embodiments, the hydrocarbon material is unrefined petroleum (e.g., in a petroleum reservoir). In some further embodiments, the unrefined petroleum is a light oil. A “light oil” as provided herein is an unrefined petroleum with an API gravity greater than 30. In some embodiments, the API gravity of the unrefined petroleum is greater than 30. In other embodiments, the API gravity of the unrefined petroleum is greater than 40. In some embodiments, the API gravity of the unrefined petroleum is greater than 50. In other embodiments, the API gravity of the unrefined petroleum is greater than 60. In some embodiments, the API gravity of the unrefined petroleum is greater than 70. In other embodiments, the API gravity of the unrefined petroleum is greater than 80. In some embodiments, the API gravity of the unrefined petroleum is greater than 90. In other embodiments, the API gravity of the unrefined petroleum is greater than 100. In some other embodiments, the API gravity of the unrefined petroleum is between 30 and 100.

In other embodiments, the hydrocarbons or unrefined petroleum can comprise crude having an H₂S concentration of at least 0.5%, a CO₂ concentration of 0.3%, or any combination thereof.

In some embodiments, the hydrocarbons or unrefined petroleum can comprise crude having an H₂S concentration of at least 0.5% (e.g., at least 1%, at least 1.5%, at least 2%, at least 2.5%, at least 3%, at least 3.5%, at least 4%, or at least 4.5%). In some embodiments, the hydrocarbons or unrefined petroleum can comprise crude having an H₂S concentration of 5% or less (4.5% or less, 4% or less, 3.5% or less, 3% or less, 2.5% or less, 2% or less, 1.5% or less, or 1% or less).

The hydrocarbons or unrefined petroleum can comprise crude having an H₂S concentration ranging from any of the minimum values described above. For example, in some embodiments, the hydrocarbons or unrefined petroleum can comprise crude having an H₂S concentration of from 0.5% to 5% (e.g., from 0.5% to 2.5%).

In some embodiments, the hydrocarbons or unrefined petroleum can comprise crude having a CO₂ concentration of at least 0.3% (e.g., at least 0.5%, at least 1%, at least 1.5%, at least 2%, at least 2.5%, at least 3%, at least 3.5%, at least 4%, or at least 4.5%). In some embodiments, the hydrocarbons or unrefined petroleum can comprise crude having a CO₂ concentration of 5% or less (4.5% or less, 4% or less, 3.5% or less, 3% or less, 2.5% or less, 2% or less, 1.5% or less, 1% or less, or 0.5% or less).

The hydrocarbons or unrefined petroleum can comprise crude having a CO₂ concentration ranging from any of the minimum values described above. For example, in some embodiments, the hydrocarbons or unrefined petroleum can comprise crude having a CO₂ concentration of from 0.3% to 5% (e.g., from 0.3% to 2.5%).

The solid material may be a natural solid material (i.e., a solid found in nature such as rock). The natural solid material may be found in a petroleum reservoir. In some embodiments, the method is an enhanced oil recovery method. Enhanced oil recovery methods are well known in the art. A general treatise on enhanced oil recovery methods is Basic Concepts in Enhanced Oil Recovery Processes edited by M. Baviere (published for SCI by Elsevier Applied Science, London and New York, 1991). For example, in an enhanced oil recovery method, the displacing of the unrefined petroleum in contact with the solid material is accomplished by contacting the unrefined with a surfactant composition provided herein, wherein the unrefined petroleum is in contact with the solid material. The unrefined petroleum may be in an oil reservoir. The composition can be pumped into the reservoir in accordance with known enhanced oil recovery parameters. Upon contacting the unrefined petroleum, the aqueous composition can form an emulsion composition with the unrefined petroleum.

In some embodiments, the natural solid material can be rock or regolith. The natural solid material can be a geological formation such as clastics or carbonates. The natural solid material can be either consolidated or unconsolidated material or mixtures thereof. The hydrocarbon material may be trapped or confined by “bedrock” above or below the natural solid material. The hydrocarbon material may be found in fractured bedrock or porous natural solid material. In other embodiments, the regolith is soil. In other embodiments, the solid material can be, for example, oil sand or tar sands.

In other embodiments, the solid material can comprise equipment associated with an oil and gas operation. For example, the solid material can comprise surface processing equipment, downhole equipment, pipelines and associated equipment, pumps, and other equipment which contacts hydrocarbons during the course of an oil and gas operation.

Surfactant packages as described herein (as well as the resulting aqueous compositions) can be optimized for each formation and/or for the desired oil and gas operation. For example, a surfactant package can be tested at a specific reservoir temperature and salinity, and with specific additional components. Actual native reservoir fluids may also be used to test the compositions.

In some embodiments, the subterranean formation can have a temperature of at least 75° F. (e.g., at least 80° F., at least 85° F., at least 90° F., at least 95° F., at least 100°, at least 105° F., at least 110° F., at least 115° F., at least 120° F., at least 125° F., at least 130° F., at least 135° F., at least 140° F., at least 145° F., at least 150° F., at least 155° F., at least 160° F., at least 165° F., at least 170° F., at least 175° F., at least 180° F., at least 190° F., at least 200° F., at least 205° F., at least 210° F., at least 215° F., at least 220° F., at least 225° F., at least 230° F., at least 235° F., at least 240° F., at least 245° F., at least 250° F., at least 255° F., at least 260° F., at least 265° F., at least 270° F., at least 275° F., at least 280° F., at least 285° F., at least 290° F., at least 295° F., at least 300° F., at least 305° F., at least 310° F., at least 315° F., at least 320° F., at least 325° F., at least 330° F., at least 335° F., at least 340° F., or at least 345° F.). In some embodiments, the subterranean formation can have a temperature of 350° F. or less (e.g., 345° F. or less, 340° F. or less, 335° F. or less, 330° F. or less, 325° F. or less, 320° F. or less, 315° F. or less, 310° F. or less, 305° F. or less, 300° F. or less, 295° F. or less, 290° F. or less, 285° F. or less, 280° F. or less, 275° F. or less, 270° F. or less, 265° F. or less, 260° F. or less, 255° F. or less, 250° F. or less, 245° F. or less, 240° F. or less, 235° F. or less, 230° F. or less, 225° F. or less, 220° F. or less, 215° F. or less, 210° F. or less, 205° F. or less, 200° F. or less, 195° F. or less, 190° F. or less, 185° F. or less, 180° F. or less, 175° F. or less, 170° F. or less, 165° F. or less, 160° F. or less, 155° F. or less, 150° F. or less, 145° F. or less, 140° F. or less, 135° F. or less, 130° F. or less, 125° F. or less, 120° F. or less, 115° F. or less, 110° F. or less, 105° F. or less, 100° F. or less, 95° F. or less, 90° F. or less, 85° F. or less, or 80° F. or less).

The subterranean formation can have a temperature ranging from any of the minimum values described above to any of the maximum values described above. For example, in some embodiments, the subterranean formation can have a temperature of from 75° F. to 350° F. (approximately 24° C. to 176° C.), from 150° F. to 250° F. (approximately 66° C. to 121° C.), from 110° F. to 350° F. (approximately 43° C. to 176° C.), from 110° F. to 150° F. (approximately 43° C. to 66° C.), from 150° F. to 200° F. (approximately 66° C. to 93° C.), from 200° F. to 250° F. (approximately 93° C. to 121° C.), from 250° F. to 300° F. (approximately 121° C. to 149° C.), from 300° F. to 350° F. (approximately 149° C. to 176° C.), from 110° F. to 240° F. (approximately 43° C. to 116° C.), or from 240° F. to 350° F. (approximately 116° C. to 176° C.).

In some embodiments, the salinity of subterranean formation can be at least 5,000 ppm TDS (e.g., at least 25,000 ppm TDS, at least 50,000 ppm TDS, at least 75,000 ppm TDS, at least 100,000 ppm TDS, at least 125,000 ppm TDS, at least 150,000 ppm TDS, at least 175,000 ppm TDS, at least 200,000 ppm TDS, at least 225,000 ppm TDS, at least 250,000 ppm TDS, or at least 275,000 ppm TDS). In some embodiments, the salinity of subterranean formation can be 300,000 ppm TDS or less (e.g., 275,000 ppm TDS or less, 250,000 ppm TDS or less, 225,000 ppm TDS or less, 200,000 ppm TDS or less, 175,000 ppm TDS or less, 150,000 ppm TDS or less, 125,000 ppm TDS or less, 100,000 ppm TDS or less, 75,000 ppm TDS or less, 50,000 ppm TDS or less, or 25,000 ppm TDS or less).

The salinity of subterranean formation can range from any of the minimum values described above to any of the maximum values described above. For example, in some embodiments, the salinity of subterranean formation can be from 5,000 ppm TDS to 300,000 ppm TDS (e.g., from 100,000 ppm to 300,000 ppm TDS).

In some embodiments, the subterranean formation can be oil-wet. In some embodiments, the subterranean formation can be water-wet. In some embodiments, the subterranean formation can be mixed-wet. In some embodiments, the subterranean formation can be intermediate-wet.

In some embodiments, the injection composition described herein can be introduced at a wellhead pressure of at least 0 PSI (e.g., at least 1,000 PSI, at least 2,000 PSI, at least 3,000 PSI, at least 4,000 PSI, at least 5,000 PSI, at least 6,000 PSI, at least 7,000 PSI, at least 8,000 PSI, at least 9,000 PSI, at least 10,000 PSI, at least 15,000 PSI, at least 20,000 PSI, or at least 25,000 PSI). In some embodiments, the injection composition can be introduced at a wellhead pressure of 30,000 PSI or less (e.g., 25,000 PSI or less, 20,000 PSI or less, 15,000 PSI or less, 10,000 PSI or less, 9,000 PSI or less, 8,000 PSI or less, 7,000 PSI or less, 6,000 PSI or less, 5,000 PSI or less, 4,000 PSI or less, 3,000 PSI or less, 2,000 PSI or less, or 1,000 PSI or less).

The aqueous composition (injection composition) described herein can be introduced at a wellhead pressure ranging from any of the minimum values described above to any of the maximum values described above. For example, in some embodiments, the injection composition can be introduced at a wellhead pressure of from 0 PSI to 30,000 PSI (e.g., from 6,000 PSI to 30,000 PSI, or from 5,000 PSI to 10,000 PSI. In some embodiments, the aqueous composition can be used in a reservoir stimulation operation, and the aqueous composition can be introduced at a wellhead pressure of from 0 PSI to 1,000 PSI.

In some embodiments, there is no need to drill the wellbore. In some embodiments, the wellbore has been drilled and completed, and hydrocarbon production has occurred from the wellbore. In other embodiments, methods described herein can optionally include one or more of drilling the wellbore, completing the wellbore, and producing hydrocarbons from the wellbore (prior to injection of the surfactant composition).

A number of embodiments of the disclosure have been described. Nevertheless, it will be understood that various modifications may be made without departing from the spirit and scope of the invention. Accordingly, other embodiments are within the scope of the following claims.

### EXAMPLES

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results.

### Example 1

Good phase behavior is useful for identifying high performance surfactant formulations for coreflood recovery. For conventional CEOR projects, good phase behavior entails high solubilization parameters, rapid equilibration to low viscosity microemulsions and aqueous stability of aqueous surfactant mixtures. There is often a desire for developing formulations with good phase behavior for reservoirs with harsh conditions (i.e., high temperature (>90° C.), high salinity (>50,000 ppm TDS), high divalent ions (>1500 ppm TDS), high GOR (>150) and presence of H₂S). Several carbonate reservoirs have conditions as outlined above and the scarcity of formulations that are stable in the above-described conditions makes surfactant applications challenging. Described herein are results that show the development of surfactant formulations that show good phase behavior under harsh conditions. The performance of these formulations is validated with a combination of phase behavior, thermal stability, and coreflood experiments and show that high-performance surfactants can be developed for harsh reservoir conditions.

### INTRODUCTION

Given the interest in chemical EOR and a large number of petroleum resources available for tertiary recovery in harsh reservoirs, efforts have been undertaken to develop new surfactants and surfactant formulations to extend the application of chemical EOR to high temperatures and salinities (i.e., temperatures ranging from 70° C. to more than 120° C. and brines with total dissolved-solid (TDS) content up to approximately 200,000 ppm with substantial hardness). Such extreme reservoir conditions make chemical selection challenging due to surfactant stability issues. Typical surfactant formulations are developed using NaCl as an electrolyte, pure hydrocarbons, and often experimental surfactants. Even though evaluation of surfactant formulations at high salinity conditions is well established, conducting surfactant phase behavior experiments at above 100° C. is challenging and requires specialized methods to minimize health and safety risks. Some studies have been performed using specialized pressure test tubes and autoclaves to evaluate phase behavior at up to 150° C. and 11 bars. However, typical phase behavior pipettes are made of borosilicate glass and are constrained to studies below 110° C. The situation is exacerbated in alkali-surfactant screening where the alkali can potentially dissolve the silica in glass pipettes and thereby increase health and safety risks. Because of these concerns, much of the literature data is clustered below 100° C. with limited phase behavior and aqueous stability measurements reported up to 120° C.

The primary objective of a good surfactant formulation for chemical EOR applications is to achieve ultra-low IFT (<10-3 dynes/cm) between injected fluid and crude oils with low microemulsion viscosity and good aqueous stability. Typical surfactant formulations for chemical EOR contain some combinations of sulfate, sulfonate, carboxylate, and nonionic surfactants. New processes to manufacture cheap, high performance Guerbet alkoxy sulfates and Guerbet alkoxy carboxylates have extended the application of chemical EOR to temperatures up to 120° C. The sulfates are typically only thermally stable at neutral pH below 65° C. but can be stable up to 100° C. under highly basic conditions (pH>10) achieved with the use of alkali in processes such as alkali surfactant polymer (ASP). Guerbet alkoxy carboxylates have shown good thermal stability up to 120° C. at neutral and alkaline pH with improved mono-valent and di-valent cation tolerance. Internal olefin sulfonates (IOS) showed excellent thermal stability at high temperatures up to 150° C. with good salt tolerance. A surfactant blend of Guerbet alkoxy carboxylates and IOSs showed good thermal stability and obtained ultralow IFT between clear aqueous surfactant solutions and variety of crude oils in harsh conditions such as optimum salinities up to 70,000 ppm TDS with some hardness and temperatures up to 120° C. All chemicals described above are commercially available or have been manufactured in industrial scale. A ternary surfactant formulation with an alkyl ether carboxylate (AEC), an IOS, and a laboratory synthesized very short hydrophobe carboxylate pushed the limit up to ˜90,000 ppm TDS optimum salinity at 80° C.

To extend the application of chemical EOR to salinities >50,000-70,000 ppm TDS and temperatures >100° C., various experimental and lab-synthesized surfactants have been evaluated in the literature which are not available commercially. The majority of the synthesized surfactants with high temperature and high salinity tolerant properties possess two or more charges, such as zwitterionic, gemini, and amphoteric surfactants. New anionic Gemini surfactants that showed extraordinary tolerance to salinity up to 20% NaCl and/or 5% CaCl₂) were synthesized and evaluated for chemical EOR applications. Lab synthesized alkoxyglycidylether sulfonates (AGESs) showed good thermal stability and phase behavior at 20% NaCl with n-Octane between 85-120° C. A Guerbet alkoxy betaine was synthesized and evaluated to be aqueously stable with brine with salinity up to 275,000 ppm TDS and temperature up to 120° C. When mixed with amidobetaine, the Guerbet alkoxy betaine showed ultralow IFT Winsor III middle phase microemulsion with crude oil with optimum salinity of ˜50,000 ppm TDS at 95° C. Typically, zwitterionic/amphoteric surfactants must be combined with other surfactants to achieve ultralow IFT. A ternary surfactant formulation consisting of IOS, AEC, and lauryl betaine has also been demonstrated to show ultralow IFT with crude oils and thermal stability at 100° C. However, the attraction between the positive charge on the betaine and negative charges on IOS and AEC resulted in cation-anion complex between the surfactants which led the surfactant blends to become more lipophilic with optimum salinity just slightly higher than seawater at 100° C. This complexion behavior between betaine and anionic surfactants did not lead to significant increase in aqueous stability and optimum salinity of the formulation even with the addition of very hydrophilic betaine.

Many carbonate reservoirs show the above-described harsh conditions, as well as, tendency to be preferentially oil-wet. In addition to achieving ultralow IFT and good aqueous stability in high temperature, high salinity environments, the ability to tailor the surfactant formulation to alter wettability of the reservoir from oil-wet to water-wet state is a significant advantage in terms of improved oil recovery in carbonate reservoirs. It has been demonstrated that low concentrations of some nonionic and anionic surfactants can successfully change oil-wet calcite, dolomite, and limestone plugs and cores to intermediate and water-wet states in harsh conditions, resulting in improved oil recoveries with static imbibition experiments.

Described is a workflow to develop surfactant formulations that show ultra-low IFT, good aqueous stability, favorable microemulsion rheology for temperatures >95° C. with high salinity hard brines. The technical limits of surfactant formulation development at harsh conditions have been extended successfully in this paper to temperatures up to 110° C. with optimum salinities up to 125,000 ppm TDS (including significant hardness) while only utilizing commercially available surfactants. Solubilization parameters (SP) were >8 for those formulations. Surfactant formulations with optimum salinities of up to 185,000 ppm TDS at 110° C. were also developed but with lower SP of 4-6. Techniques to include a nonionic surfactant that showed wettability alteration property to ultralow IFT formulations without suffering any negative impacts on IFT and aqueous stability are described. Many carbonate reservoirs contain H₂S naturally or induced by souring due to waterflooding. Since there is minimal information on the effect of H₂S on surfactant phase behavior in the literature, the effects of H₂S and pressure on surfactant phase behavior, thermal stability, and chemical stability have been investigated and analyzed.

Material and Methods

Chemicals and materials. Alkyl ether carboxylates, various isomerized olefin sulfonate (IOS) alkyl aryl sulfonate (AAS), nonionic surfactants with varying structures, di-sulfonate surfactants were obtained from various chemical companies or synthesized in house. Tri-ethylene glycol mono-butyl ether (TEGBE) co-solvent. Reagent grade salts and acids such as sodium carbonate, sodium chloride, calcium chloride dihydrate, magnesium chloride hexahydrate etc. were used to make synthetic brines in this study.

Microemulsion phase behavior and aqueous stability tests. The microemulsion phase behavior methodology used in this study to develop and test chemical formulations at high temperatures and high temperatures are described in multiple publications (see, for example, Levitt, et al., SPE/DOE Symposium on Improved Oil Recovery Symposium, SPE 100089, (2006) (“Levitt, et al., 2006”); Flaaten, et al., SPE Improved Oil Recovery Symposium, SPE 113469-PA (2008) (“Flaaten, et al., 2008”); and Zhao, et al., SPE Improved Oil Recovery Symposium, SPE 113432, (2008), each of which is hereby incorporated by reference). Briefly, aqueous surfactant solutions and oil (or hydrocarbons) were combined in glass pipettes (bottom sealed 5 mL graduated borosilicate glass pipettes marked in 1/10 ml increments), mixed, and maintained at a given temperature. Phase volumes were observed over time until they remained constant. The equilibrium phase volumes were then used to calculate oil and water solubilization ratios. Crude oil that was used in this study, referred to as oil #1, is an inactive oil (acid number <0.2 mg KOH/g oil). The oil fractions used in phase behavior experiments are 25% and 30%. Aqueous stability experiments were also performed in glass pipettes. Aqueous surfactant solutions were heated without oil to determine the aqueous stability limit (Aq), i.e., the maximum salinity possible before surfactant solutions become cloudy.

To evaluate the effect of H₂S on phase behavior and aqueous stability, live oil phase behavior and aqueous stability tests were run. Live oils were prepared by recombination of dead crude oil with synthetic solution gas. Methane (CH₄) and H₂S gas were used to make synthetic solution gas. Three different combinations of live oil and synthetic solution gas were used for phase behavior experiments.

1) Recombination of dead oil with CH₄

2) Recombination of dead oil with CH₄ and 8 mol % H₂S

3) Recombination of dead oil with CH₄ and 16 mol % H₂S.

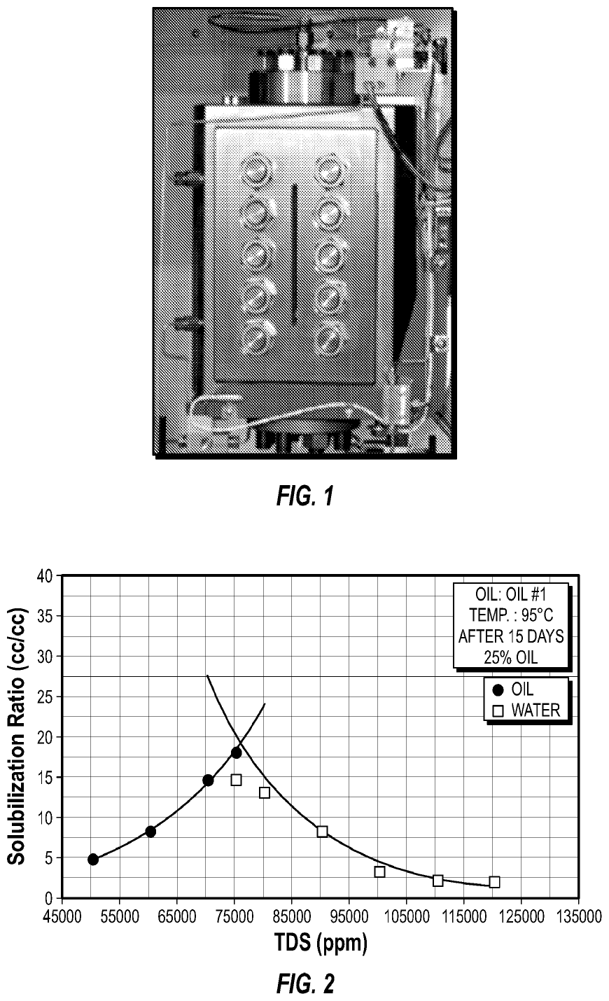

Live oil experiments were performed with 30% oil fraction and at three different pressures, i.e., 4000 psi, 7000 psi, and 10,000 psi. The equipment used to perform the live oil phase behavior experiments was the mercury-free visual PVT analysis system developed by Schlumberger shown in FIG. 1.

To observe surfactant stability in the presence of H₂S, after loading target surfactant solution into the PVT cell, gas mixture of 17 mol % H₂S and 83 mol % CH₄ was bubbled through the solution at solution gas ratio of 1:4. Samples were kept at 120° C. and 1800 psi for seven days. Control samples were placed in 120° C. oven without H₂S at ambient pressure. High-performance liquid chromatography (HPLC) was performed using target surfactant solution before and after H₂S exposure to quantify the chemical stability in the presence of H₂S.

Three different synthetic brines containing ˜50K, ˜95K and ˜160K ppm TDS were used as baseline brines for surfactant phase behavior. More concentrated versions of the baseline brine were first mixed in the lab. These solutions were appropriately diluted to achieve desired salinity. In some instances, buffer was added at a constant level to all the phase behavior evaluations. Tables 1 to 3 show the brine composition for each brine. To investigate the effect of pH on phase behavior, acid was added to some phase behavior solutions to obtain pH value ˜4.

TABLE 1
Brine formulation 1.

| Ionic species | ppm |
|---|---|
| Monovalent Cation | ~18,700 |
| Divalent Cation | ~1,100 |
| TDS | ~50,000 |

TABLE 2
Brine formulation 2.

| Ionic species | ppm |
|---|---|
| Monovalent Cation | ~36,000 |
| Divalent Cation | ~1,700 |
| TDS | ~95,500 |

TABLE 3
Brine formulation 3.

| Ionic species | ppm |
|---|---|
| Monovalent Cation | ~55,000 |
| Divalent Cation | ~7,000 |
| TDS | ~160,600 |

Results and Discussion

Surfactant formulation development for 50K to 80K at 95° C. A surfactant formulation consisting of IOS and AEC combination was developed at 95° C. to achieved optimum salinity of ˜75,000 ppm using 2× synthetic brine #1. The 2× brine was diluted to achieve ranges of concentrations. Additionally, for some formulations, 20,000 ppm of dissolved solids were added to the formulations in the form of pH buffer and the total dissolved solids are reflected as brine TDS in addition to contribution from buffer TDS. The initial experiments were conducted without adding non-ionic surfactant. Later, appropriate non-ionic surfactants were incorporated to the formulation to achieve wettability alteration of oil-wet porous media to water-wet state in addition to interfacial tension reduction.

TABLE 4
Surfactant formulations at 50-80K ppm TDS at 95° C.

| Formulation | Components |
|---|---|
| 1 | Alkyl ether carboxylate (AEC)-1 (high PO and EO) |
| | Low MW isomerized olefin sulfonate (IOS) |
| 2 | Alkyl ether carboxylate (AEC)-2 (high PO and EO) |
| | Low MW isomerized olefin sulfonate (IOS) |
| | High MW isomerized olefin sulfonate (IOS) |
| | Nonionic surfactant |

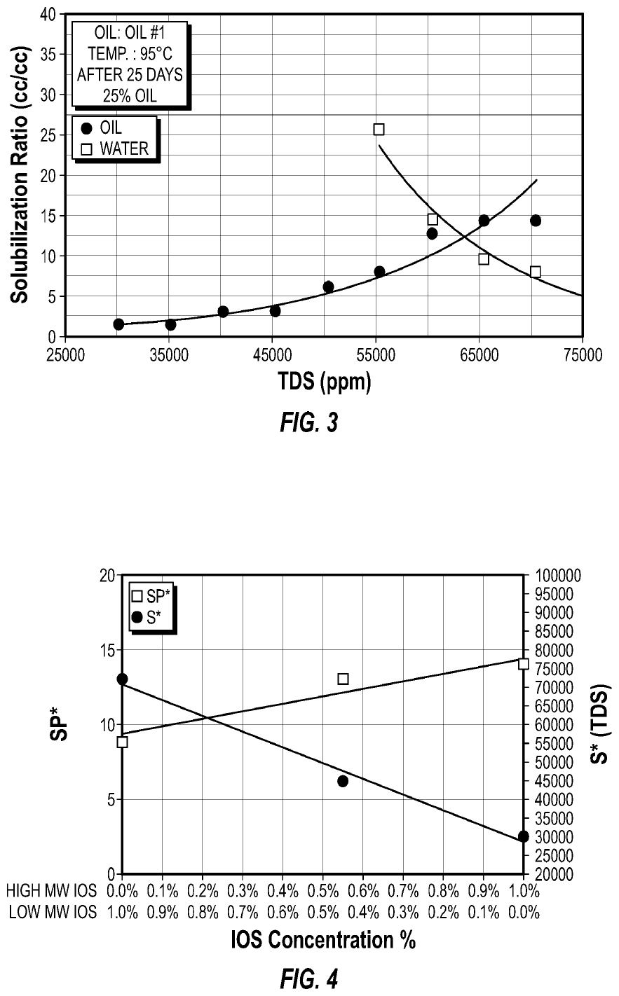

FIGS. 2 and 3 show the solubilization plots for formulations 1 and 2 respectively at 95° C. Formulation 1 has acceptable phase behavior and aqueous stability and does not show significant wettability alteration behavior. The addition of a nonionic surfactant allowed for wettability alteration of limestone plugs from oil-wet to water-wet state but greatly decreased solubilization parameters. Hence in formulation 2, a high molecular weight isomerized olefin sulfonate was used in conjunction with the nonionic surfactant to achieve wettability alteration and acceptable solubilization parameters of >10.

We further evaluated the effect of hydrophobe tail length on solubilization parameter and optimum salinity. Table 5 shows the formulation used to evaluate the effects of varying the ratio of low to high molecular weight IOS while keeping all the other components the same. FIG. 4 shows the effect of IOS ratio on optimum salinity (S*) and SP at 95° C. using brine #1 and NaCl.

TABLE 5
Surfactant formulations that used for evaluating
the effect of different IOS ratio.

| Formulation | Components |
|---|---|
| 3 | Alkyl ether carboxylate -1 (high PO and EO) |
| | 0%-1% high MW IOS |
| | 1%-0% low MW IOS |
| | Nonionic surfactant |

The lower molecular weight IOS increases optimal salinity while solubilization parameter decreases (See FIG. 4). For formulation 3, the optimal salinity can be tailored between 30,000 ppm to 70,000 ppm by altering the low to high molecular weight IOS. Such a variation also changes optimum solubilization parameters (SP) from ˜9 to 14.

Surfactant formulation development for 50K to 80K at 110° C. Since the low MW IOS in formulation 3 showed acceptable SP, it was used as the base surfactant for testing at 110° C. Table 6 shows the formulations tested at 110° C. As with the 95° C. experiments, the initial experiments were conducted without nonionic surfactants for establishing baseline behavior. Since a high propylene oxide (PO) and ethylene oxide (EO) alcohol ether carboxylate was used as a co-surfactant, we expect optimum salinity to decrease with increased temperature due to reduced surfactant solubility at higher temperatures. The results in Table 6 confirmed expected behavior of decreasing optimal salinity and reduced SP due to the addition of non-ionic surfactant in to the system. Table 7 shows the effect of temperature on phase behavior and aqueous stability for formulation 6 and confirms expected behavior of reduced optimal salinity.

TABLE 6
Phase behavior and aqueous stability results
using formulations 5 and 6 at 110° C.

| | | | | Aqueous |
|---|---|---|---|---|
| | | | S* | stability |
| formulation | Components | SP | (TDS) ppm | (TDS) ppm |
| 5 | Alkyl ether | 9 | 66,000 | 66,000 |
| | carboxylate -3 | | | |
| | (high PO and EO) | | | |
| | Low MW IOS | | | |
| 6 | Alkyl ether | 6 | 55,000 | 57,000 |
| | carboxylate -3 | | | |
| | (high PO and EO) | | | |
| | Low MW IOS | | | |
| | Nonionic surfactant | | | |

TABLE 7
effect of the temperature on Phase behavior
and aqueous stability for formulation 6.

| | | | Aqueous |
|---|---|---|---|
| | | S* | stability |
| Temperature ° C. | SP | (TDS) ppm | (TDS) ppm |
| 95 | 9 | 75,000 | 80,000 |
| 110 | 6 | 55,000 | 57,000 |

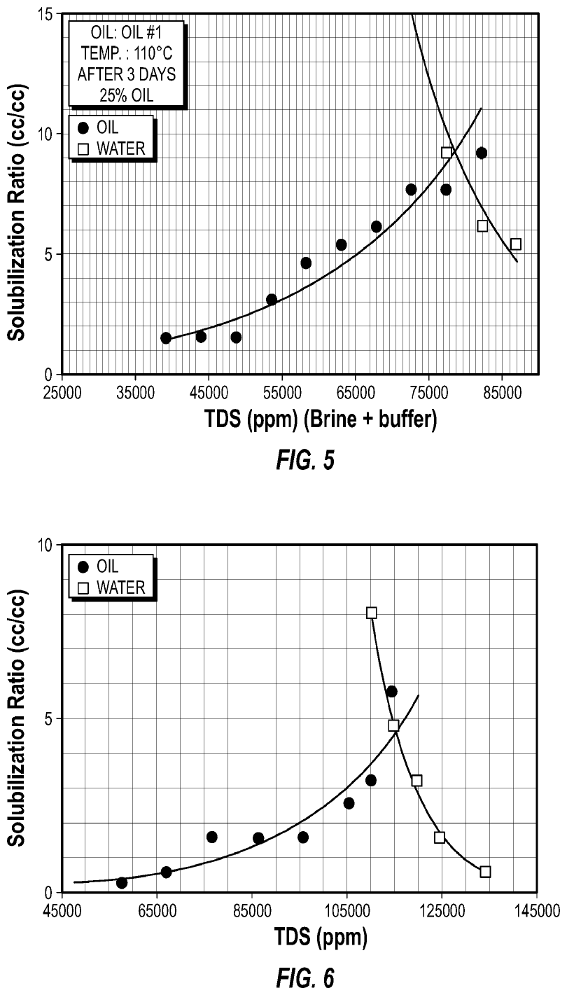

Buffers were introduced in the surfactant mixtures to improve phase behavior. Since all the brines that were used for the phase behavior experiment contain ˜1,000 ppm to 6,000 ppm di-valent cations, a pH of >8 would cause calcium hydroxide and magnesium hydroxide precipitations. Hence, we used a buffer mixture that targeted a pH between 7-8 to prevent precipitation while still maintaining the previously mentioned benefits. In formulation 7, we incorporated buffer to maintain the pH. We achieved an optimum salinity of ˜80,000 ppm TDS with ultralow IFT by using appropriate surfactant mixtures in Formulation 7. Formulation 7 included alkyl ether high PO and EO carboxylate −3, low MW IOS, nonionic surfactant, and buffer mixture. This formulation provided a SP ˜9 with aqueous stability of 85K ppm. FIG. 5 shows the solubilization plot for formulation 7 at 110° C. and salinity scan was done using brine #2.

Surfactant formulation development for higher than 90K at 110° C. We successfully formulated surfactant mixtures that were capable of handling 110° C. and ˜80K ppm TDS. Formulating at higher salinity conditions required the addition of highly hydrophilic di-sulfonate surfactants. The effect of di-sulfonate surfactant on optimum salinity and SP is tested in formulation 8. Formulation 8 consists of alkyl ether high PO and EO carboxylate (AEC)-4, di-sulfonate-1, high MW IOS, and nonionic surfactant. The addition of the di-sulfonate increased optimum salinity to ˜115K ppm TDS, aqueous stability to ˜115K and reduced SP to 5 with oil #1 and brine #2. FIG. 6 shows the solubilization plot for formulation 8.

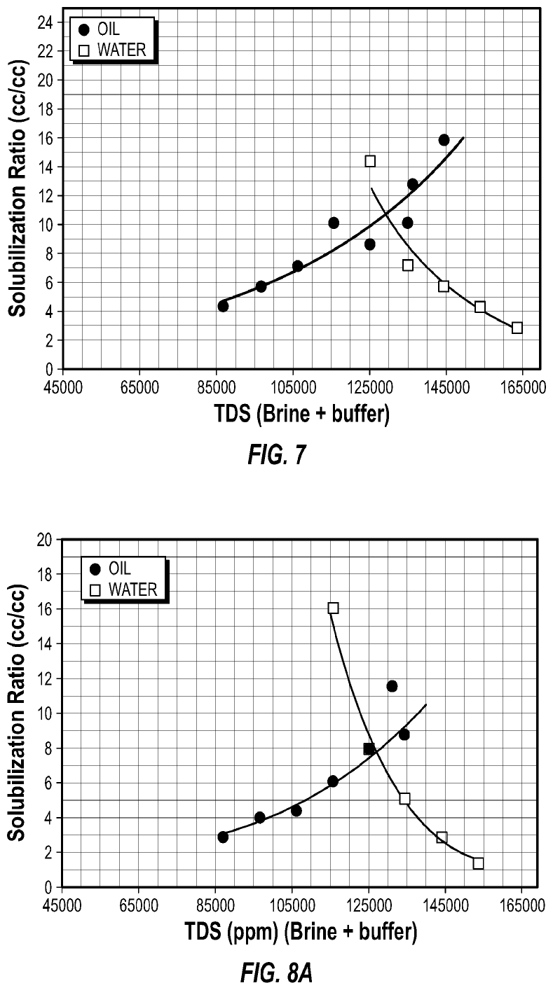

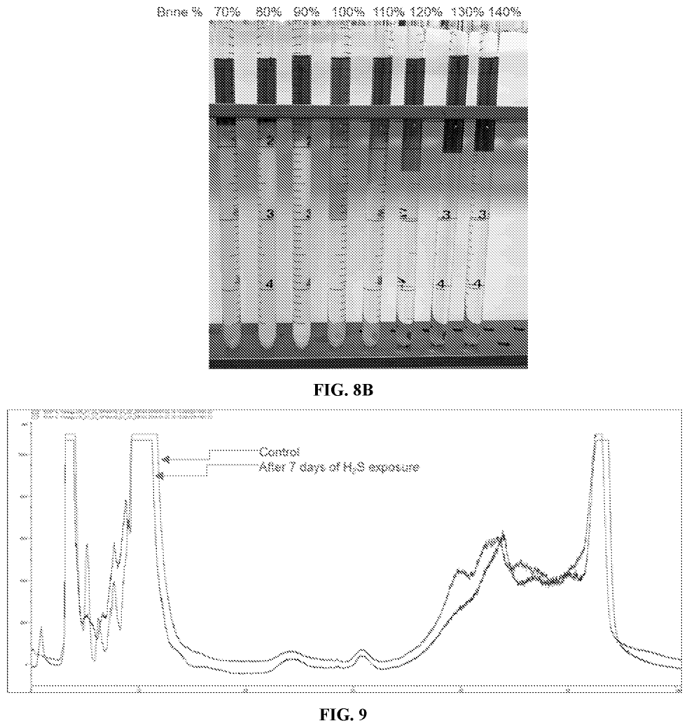

As an initial step, we successfully increased optimum salinity and aqueous stability. The second step is to increase SP. We achieved a higher SP by reducing the nonionic surfactant concentration. We also evaluated the sensitivity of surfactant concentration on optimum salinity and SP. Table 8 shows the results for these sensitivity studies for formulations 9 and 10. Reducing the nonionic surfactant and adding the di-sulfonate increased optimum salinity to >125K ppm TDS while maintain SP>8. It appears that doubling the surfactant concentrations, including the di-sulfonate does not increase optimum salinity further but leads to a reduction in SP, aqueous stability, and optimum salinity. Additional work to evaluate these findings is required. FIG. 7 shows the solubilization plots for formulation 9 and FIGS. 8 a and b show the solubilization plots and phase behavior tubes for formulation 10 using brine #2.

TABLE 8
Formulations 9 and 10 and their phase
behavior and aqueous stability results.

| | | | | Aqueous |
|---|---|---|---|---|
| | | S* | | stability |
| Formulation | components | (ppm) | SP | (ppm) |
| 9 | Alkyl ether | 130,000 | 10.5 | 135,000 |
| | carboxylate -3 | | | |
| | (high PO and EO) | | | |
| | Di-sulfonate-1 | | | |
| | Low MW IOS | | | |
| | Nonionic surfactant | | | |
| | Buffer | | | |
| 10 | 2x concentration of | 125,000 | 8 | 115,000 |
| | formulation 9 | | | |

We tested the effect of di-sulfonate surfactant on optimal salinity by evaluating di-sulfonate surfactant with varying molecular structures. By using di-sulfonate mixtures, we were able to increase the optimum salinity up to ˜180,000 ppm in the presence of ˜6000 ppm hardness. Adding the di-sulfonates greatly increased hydrophilicity and hence resulted in a reduction in SP. Table 9 shows the two formulations that give optimum salinity and aqueous stability higher than 150,000 ppm with brine #3 at 110° C. The results in Table 9 show that we can achieve optimum salinities >150K ppm TDS and up to 186K ppm TDS but with negative impact on SP i.e SP at optimum salinity of 4.3 at 186K ppm TDS.

TABLE 9
Formulations 10 and 11 with optimum salinity and
aqueous stability higher than 150,000 ppm.

| | | | | Aqueous |
|---|---|---|---|---|
| | | S* | | stability |
| Formulation | components | (ppm) | SP | (ppm) |
| 10 | Alkyl ether | 154,000 | 6 | 154,000 |
| | carboxylate -3 | | | |
| | (high PO and EO) | | | |
| | Di-sulfonate-1 | | | |
| | High MW IOS | | | |
| | Buffer | | | |
| 11 | Alkyl ether | 186,000 | 4.3 | 186,000 |
| | carboxylate -3 | | | |
| | (high PO and EO) | | | |
| | Di-sulfonate-1 | | | |
| | Di-sulfonate-2 | | | |
| | High MW IOS | | | |
| | Buffer | | | |

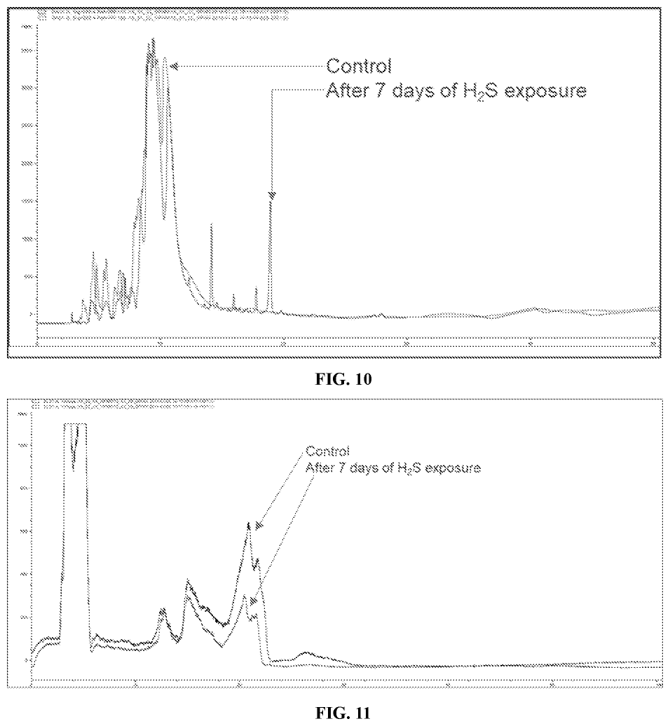

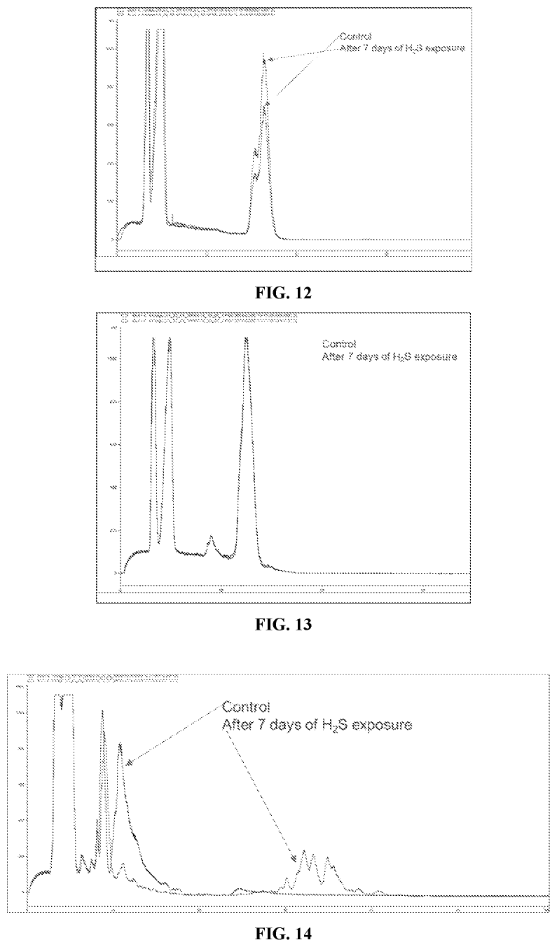

Surfactant stability in presence of H₂S. Given that many reservoirs contain significant quantity of H₂S, we tested the effect of surfactant stability in the presence of H₂S. We tested five surfactant classes i.e. alkyl ether carboxylate (AEC), di-sulfonate, IOS, AOS, and nonionic surfactant in the presence of 17 mol % of H₂S at 120° C. and 1800 psi for 7 days. Control samples were taken before conducting tests and kept under similar conditions to establish baselines. FIGS. 9, 10, 11, 12, and 13 show HPLC data acquired using an evaporative light scattering detector (ELSD) or diode array detector (DAD) for AEC, di-sulfonate, IOS and nonionic surfactants respectively after exposure to H₂S at 120° C. Based upon the HPLC chromatograms, all the surfactants showed minimal degradation except for AOS. The differences in the IOS and nonionic surfactant (FIGS. 11 and 12) is attributed to sample evaporation. Significant degradation was observed for the AOS surfactant in presence of H₂S (FIG. 14).

After running the H₂S stability test, pH of the solutions before degassing is ˜4-4.5. We believe that the low pH is due to the presence of residual H₂S and corresponding dissociated sulfide components in aqueous phase. For consistency, the surfactant samples were degassed and their physical appearance was compared to the initial samples.

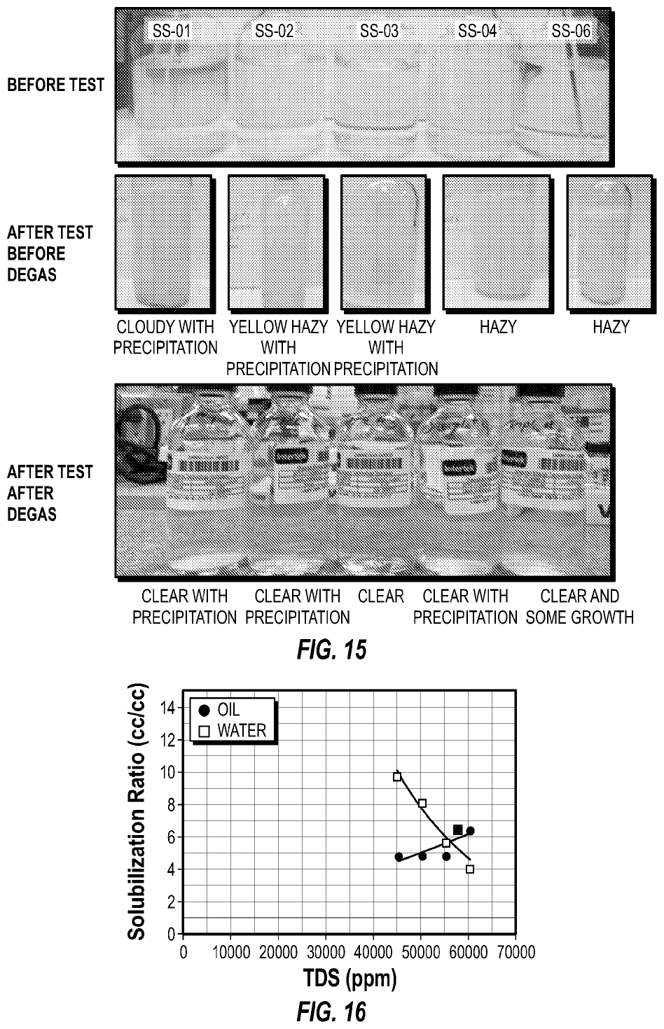

FIG. 15 shows pictures taken of surfactant samples before exposure to H₂S, after exposure without degassing, and finally after exposure with degassing. We believe that the cloudy solution (SS-1) observed is due to the low pH which inhibits carboxylate surfactant solubility with the need to investigate the cause of other hazy solutions. After degassing, solutions returned to their original clear appearance with some precipitates/growth observed in some samples. Table 10 shows the surfactants that corresponded to sample numbers.

TABLE 10
Surfactants that corresponded to sample numbers
used for stability tests with H2S.

| Sample # | surfactant |
|---|---|
| SS-1 | AEC + Di-sulfonate |
| SS-2 | IOS |
| SS-3 | AOS |
| SS-4 | Nonionic surfactant #1 |
| SS-6 | Nonionic surfactant #2 |

It is believed that precipitation is caused by interaction between H₂S and divalent ions in the brine since we do not see any evidence of surfactant degradation in the presence of H₂S with the exception of AOS. The higher the concentration of formation brine used, the more precipitation was observed, which confirms our conjecture. For nonionic samples, it is normal to see some growth in diluted samples after 3 to 4 weeks. Since it took around 4 weeks to get these samples back, it was expected to have some growth since samples did not contain any biocides.

Formulation used for live oil phase behavior experiments. Surfactant formulation 12 was used for all the live oil phase behavior and contains alkyl ether with high PO and EO carboxylate −3, low MW IOS, nonionic surfactant and co-solvent. The optimum salinity and SP is ˜55,000 ppm and 6 with Brine #1 at 110° C. The WOR was set at 2.33, temperature was set at 110° C. and the experiments were conducted at ambient pressure. FIG. 16 shows the solubilization plot for phase behavior with the formulation 12 after 2 days of equilibration.

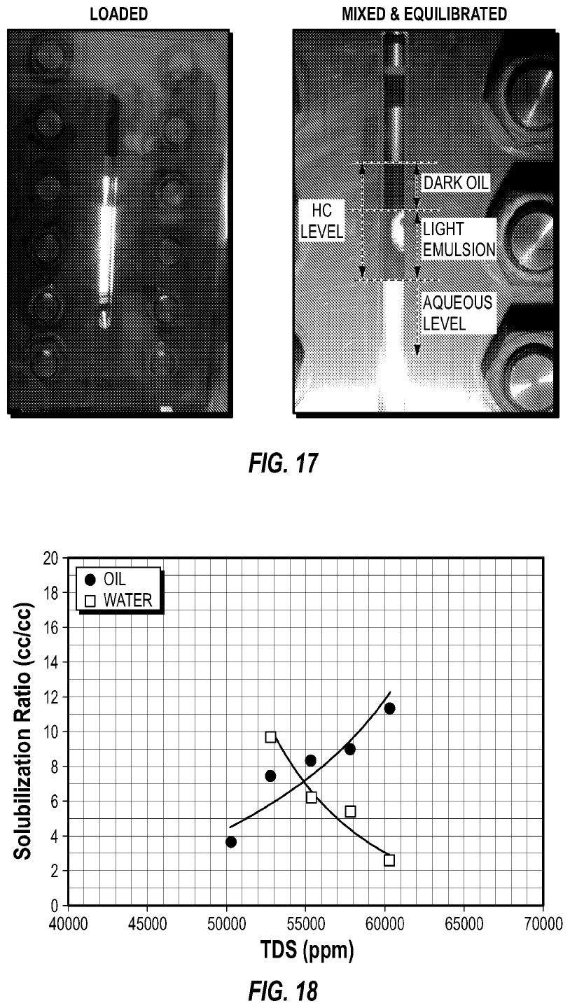

Live oil phase behavior with methane. Live oil phase behavior was conducted using the Schlumberger PVT cell and FIG. 17 shows the loaded PVT cell with surfactant solution and oil before mixing and after mixed at equilibrium.

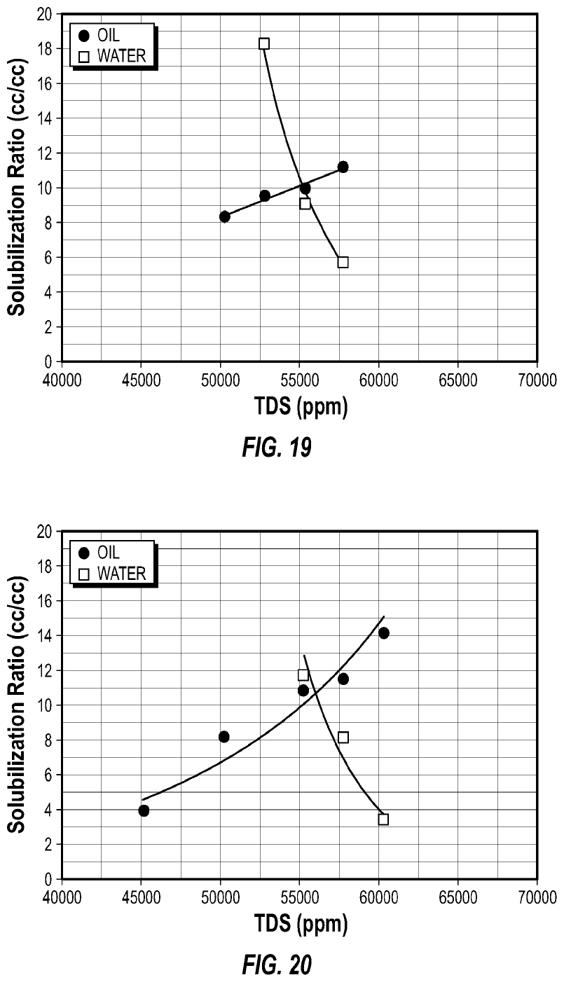

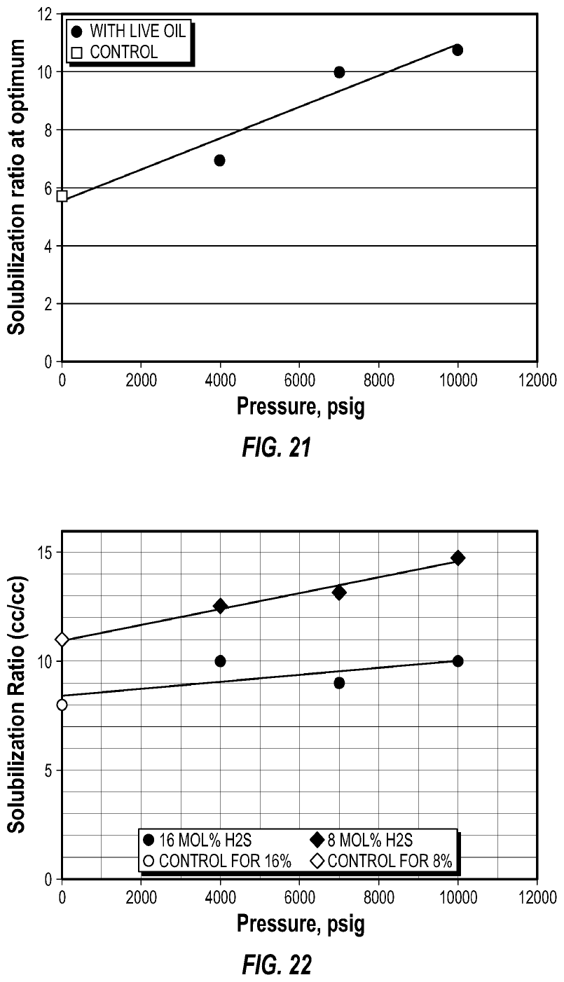

FIGS. 18, 19 and 20 show the solubilization plots for live oil phase behavior with methane at pressures of 4K, 7K and 10K psi, respectively. As expected from prior literature (Jang, et al., SPE Improved Oil Recovery Symposium, SPE-169169-MS, (2014) (“Jang, et al., 2014”)), increasing pressure has minimal effect on optimum salinity and has a positive effect on SP. FIG. 21 shows that SP increases from 7 at ambient pressure to 11 at a pressure of 10,000 psig.

Live oil phase behavior with methane and H₂S. Similar live oil phase behavior experiments were run with gas containing CH₄ and two different fractions of H₂S (8 mol % and 16 mol %). The WOR was 2.33 and temperature was 110° C. for the live phase behavior experiments. Adding H₂S to the live oil phase behavior reduces optimal salinity by 20-30% for both the 8 mol % and 16 mol % H₂S experiments (see Table 11). As with the CH₄ cases only, the SP increases with pressure (see FIG. 22).

TABLE 11
S* and percentage of S* reduction at different pressure compered
to control experiment with the two different H₂S level.

| | | % of S* | | % of S* |
|---|---|---|---|---|
| | | reduction | S* with | reduction |
| Pressure | S* with CH₄ | with CH₄ | CH₄ and | with CH₄ |
| (psig) | and 8% H₂S | and 8% H₂S | 16% H₂S | and 16% H₂S |
| Control | 50,000 | N/A | 50,000 | N/A |
| (ambient) | | | | |
| 4000 | 38,000 | 24 | 35,000 | 30 |
| 7000 | 35,000 | 30 | 35,000 | 30 |
| 10000 | 40,000 | 20 | 40,000 | 20 |

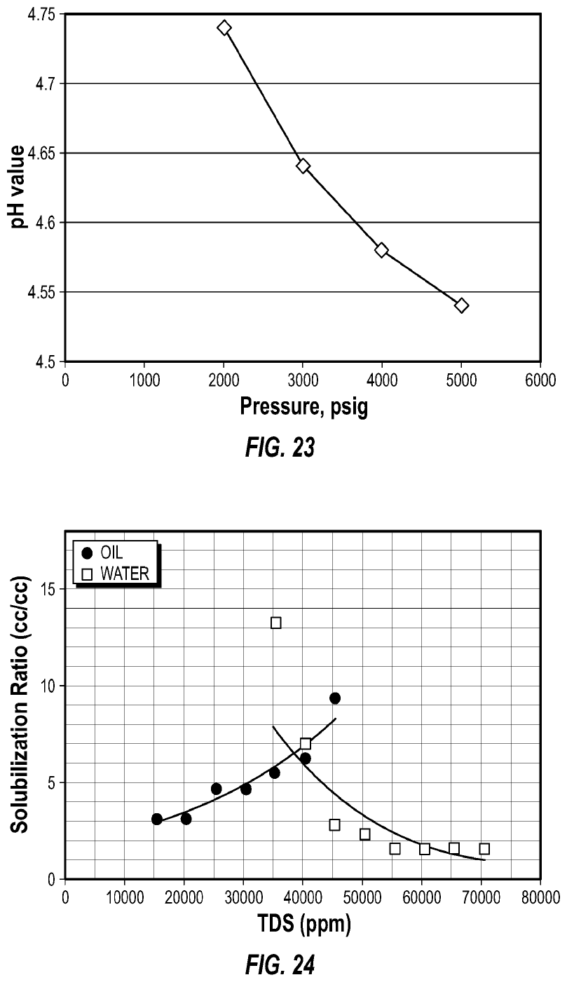

The slight changes in SP for the baseline samples are within experimental error and variations expected due to the use of different surfactant batches. The reduction in optimal salinity is attributed to a reduction in pH as shown in FIG. 23. The dissociation constant (pKa) of anionic surfactants have been estimated to be ˜5 for carboxylate and <2 for sulfate and sulfonates (Haftka et al., 2015). The change in pH affects the dissociation of the alkyl ether carboxylate and protonates some fraction of the surfactants, leading to increased hydrophobicity of the formulation and thereby alters optimal salinity. The drop in pH as a function of pressure can be attributed to increased H₂S partitioning in aqueous phase due to higher pressures.

We validated our conjecture by testing phase behavior of formulation 12 with lower pH (3-4) by using acid. With lower pH, a lower optimum salinity of ˜-40,000 ppm TDS is observed (FIG. 24), which is similar to the lower optimum salinity values of 35,000-40,000 ppm TDS observed with formulation 12 in presence of pressurized live oil with H₂S (Table 11). These results confirm that the presence of H₂S will potentially lower optimal salinity of some surfactant formulations due to partitioning into aqueous phase and resulting pH reduction.

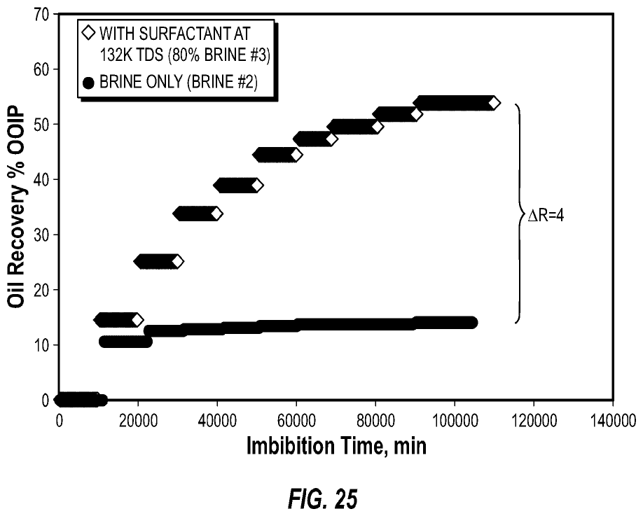

High Salinity Coreflood Study. FIG. 25 is a plot showing the results of a high salinity coreflood study using a formulation that included 0.35% Guerbet alkoxylated carboxylate, 0.2% olefin sulfonate, 0.8% Disulfonate, and 0.5% Guerbet alkoxylated alcohol. The slug injection salinity was 132,000 TDS (using ˜80% of brine #3).

### CONCLUSIONS

We have demonstrated the ability to develop high performance surfactant formulations between 50K to 186K ppm TDS. These formulations contained a mixture of IOS, alcohol ether carboxylates, nonionic surfactants and di-sulfonates. We were able to extend optimal salinity to ˜125K ppm TDS with the addition of nonionics surfactants and di-sulfonates while maintaining a SP of >8. The nonionic surfactants impart some wettability alteration properties to the formulation. Using just di-sulfonates without nonionic surfactants, we were able to extend optimal salinity to 186K ppm TDS with loss of SP to 4-5 at ambient pressure. For the oil evaluated, Methane alone had minimal impact on optimal salinity. As expected from literature review, increasing pressure had a mild, increasing effect on SP. Alkyl ether carboxylates, IOS, nonionic surfactants and di-sulfonates were shown to be resistant to H₂S and AOS was degraded by H₂S. The effect of H₂S on SP and optimum salinity was driven by pH reduction and validated by phase behavior tests conducted at pH of 3-4. In summary, we have shown that developing high performance surfactant formulations at high temperature (>100° C.), high pressure (>2500 psi) and high salinity (>75K ppm TDS) is feasible. We have identified multiple families that are resistant to H₂S and the results can be used to develop EOR formulations for field applications with harsh conditions.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

1. An aqueous composition comprising:
(i) a surfactant package, wherein the surfactant package comprises:
(a) a surfactant comprising a branched, unbranched, saturated, or unsaturated C6-C32:BO(0-65):PO(0-65):EO(0-100)-X having a concentration within the aqueous composition of from 0.05%-5% by weight, based on the total weight of the aqueous composition, wherein there is at least one BO, PO, or EO group, and wherein X comprises a sulfonate, a disulfonate, a carboxylate, a dicarboxylate, a sulfosuccinate, a disulfosuccinate, or hydrogen; and
(b) olefin sulfonate having a concentration within the aqueous composition of from 0.05%-5% by weight, based on the total weight of the aqueous composition; and
(ii) water; and
wherein the aqueous composition comprises at least 5,000 ppm total dissolved solids (TDS) and exhibits a solubilization parameter of from 3-25 at an optimum salinity in response to contact with hydrocarbons comprising H₂S of at least 0.5 mol %.

2. The aqueous composition of claim 1, wherein the TDS is of from 5,000 ppm TDS-100,000 ppm TDS, of from 5,000 ppm TDS-90,000 ppm TDS, of from 5,000 ppm TDS-80,000 ppm TDS, of from 5,000 ppm TDS-70,000 ppm TDS, of from 5,000 ppm TDS-60,000 ppm TDS, of from 5,000 ppm TDS-50,000 ppm TDS, of from 5,000 ppm TDS-40,000 ppm TDS, of from 5,000 ppm TDS-30,000 ppm TDS, of from 5,000 ppm TDS-20,000 ppm TDS, of from 5,000 ppm TDS-10,000 ppm TDS, of from 5,000 ppm TDS-75,000 ppm TDS, of from 5,000 ppm TDS-25,000 ppm TDS, of from 50,000 ppm TDS-100,000 ppm TDS, or of from 50,000 ppm TDS-80,000 ppm TDS.

3. The aqueous composition of claim 2, further comprising an alkyl aryl sulfonate, a cationic surfactant, a zwitterionic surfactant, an amphoteric surfactant, a gemini surfactant, an alkyl benzene sulfonate (ABS), a disulfonate surfactant, an alkyl polyglucoside, an alkyl polyglucoside carboxylate, a second olefin sulfonate, a second surfactant with branched, unbranched, saturated, or unsaturated C6-C32:BO(0-65):PO(0-65):EO(0-100)-X, or any combination thereof.

4. The aqueous composition of claim 3, wherein the aqueous composition comprises at least 30,000 ppm TDS and exhibits the solubilization parameter of from 3 to 25 at the optimum salinity in response to contact with the hydrocarbons comprising the H₂S of at least 0.5 mol %.

5. An aqueous composition comprising:
(i) a surfactant package, wherein the surfactant package comprises:
(a) a surfactant comprising a branched, unbranched, saturated, or unsaturated C6-C32:BO(0-65):PO(0-65):EO(0-100)-X having a concentration within the aqueous composition of from 0.05%-5% by weight, based on the total weight of the aqueous composition, wherein there is at least one BO, PO, or EO group, and wherein X comprises a sulfonate, a disulfonate, a carboxylate, a dicarboxylate, a sulfosuccinate, a disulfosuccinate, or hydrogen;
(b) olefin sulfonate having a concentration within the aqueous composition of from 0.05%-5% by weight, based on the total weight of the aqueous composition; and
(c) a disulfonate having a concentration within the aqueous composition of from 0.05%-5% by weight, based on a total weight of the aqueous composition, wherein the disulfonate is defined by the formula below: 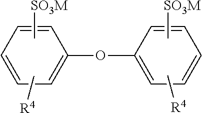
wherein
R⁴ is present in at least one ring;
R⁴ is, individually for each occurrence, a branched or unbranched, saturated or unsaturated, cyclic or non-cyclic, hydrophobic carbon chain having 6-32 carbon atoms; and
M represents a counterion; and
(ii) water; and
wherein the aqueous composition comprises at least 30,000 ppm total dissolved solids (TDS) and exhibits a solubilization parameter of from 3 to 25 at an optimum salinity in response to contact with hydrocarbons comprising H₂S of at least 0.5 mol %.

6. The aqueous composition of claim 1, wherein the solubilization parameter of from 3 to 25 at the optimum salinity is at a temperature of at least 25° C.

7. The aqueous composition of claim 1, wherein the surfactant comprises
average BO groups of from 0-10, of from 0-15, of from 0-20, of from 0-25, of from 0-30, of from 0-35, of from 0-40, of from 0-45, of from 0-50, of from 0-55, or of from 0-60;
average PO groups of from 0-10, of from 0-15, of from 0-20, of from 0-25, of from 0-30, of from 0-35, of from 0-40, of from 0-45, of from 0-50, of from 0-55, or of from 0-60;
average EO groups of from 0-10, of from 0-15, of from 0-20, of from 0-25, of from 0-30, of from 0-35, of from 0-40, of from 0-45, of from 0-50, of from 0-55, of from 0-60, of from 0-65, of from 0-70, of from 0-75, of from 0-80, of from 0-85, of from 0-90, or of from 0-95; or any combination thereof.

8. The aqueous composition of claim 5, further comprising an alkyl aryl sulfonate, a cationic surfactant, a zwitterionic surfactant, an amphoteric surfactant, a gemini surfactant, an alkyl benzene sulfonate (ABS), a second disulfonate surfactant with at least one different R⁴ group, an alkyl polyglucoside, an alkyl polyglucoside carboxylate, a second olefin sulfonate, a second surfactant with branched, unbranched, saturated, or unsaturated C6-C32:BO(0-65):PO(0-65):EO(0-100)-X, or any combination thereof.

9. The aqueous composition of claim 3, wherein the TDS is of from 30,000 ppm TDS-300,000 ppm TDS, of from 50,000 ppm TDS-300,000 ppm TDS, of from 75,000 ppm TDS-300,000 ppm TDS, of from 100,000 ppm TDS-300,000 ppm TDS, of from 125,000 ppm TDS-300,000 ppm TDS, of from 150,000 ppm TDS-300,000 ppm TDS, of from 175,000 ppm TDS-300,000 ppm TDS, of from 200,000 ppm TDS-300,000 ppm TDS, of from 250,000 ppm TDS-300,000 ppm TDS, of from 175,000 ppm TDS-200,000 ppm TDS, of from 150,000 ppm TDS-250,000 ppm TDS, of from 175,000 ppm TDS-250,000 ppm TDS, of from 200,000 ppm TDS-250,000 ppm TDS, of from 100,000 ppm TDS-200,000 ppm TDS, or of from 50,000 ppm TDS-250,000 ppm TDS.

10. An aqueous composition comprising:
(i) a surfactant package, wherein the surfactant package comprises:
(a) a surfactant comprising a branched, unbranched, saturated, or unsaturated C6-C32:BO(0-65):PO(0-65):EO(0-100)-X having a concentration within the aqueous composition of from 0.05%-5% by weight, based on the total weight of the aqueous composition, wherein there is at least one BO, PO, or EO group, and wherein X comprises a sulfonate, a disulfonate, a carboxylate, a dicarboxylate, a sulfosuccinate, a disulfosuccinate, or hydrogen; and
(b) a disulfonate having a concentration within the aqueous composition of from 0.05%-5% by weight, based on a total weight of the aqueous composition, wherein the disulfonate is defined by the formula below: 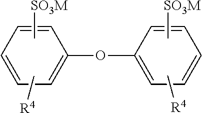
wherein
R⁴ is present in at least one ring;
R⁴ is, individually for each occurrence, a branched or unbranched, saturated or unsaturated, cyclic or non-cyclic, hydrophobic carbon chain having 6-32 carbon atoms; and
M represents a counterion; and
(ii) water; and
wherein the aqueous composition comprises at least 30,000 ppm total dissolved solids (TDS) and exhibits a solubilization parameter of from 3 to 25 at an optimum salinity in response to contact with hydrocarbons comprising H₂S of at least 0.5 mol %.

11. The aqueous composition of claim 1, wherein the water comprises hard water, hard brine, sea water, brackish water, fresh water, flowback or produced water, wastewater, river water, lake or pond water, aquifer water, brine, or any combination thereof.

12. The aqueous composition of claim 1, wherein the water comprises from 0 ppm to 25,000 ppm of divalent metal ions chosen from Ca²⁺, Mg²⁺, Sr²⁺, Ba²⁺, and combinations thereof.

13. (canceled)

14. The aqueous composition of claim 1, wherein the aqueous composition further comprises a water-soluble polymer, one or more co-solvents, a borate-acid buffer, or any combination thereof;
wherein the one or more co-solvents comprise a C1-C5 alcohol, an ethoxylated C1-C5 alcohol, a glycol ether, or any combination thereof, wherein the one or more co-solvents have a concentration within the composition of from 0.02% to 5% by weight, based on the total weight of the aqueous composition.

15. The aqueous composition of claim 14, wherein the borate-acid buffer is present in the aqueous composition in an amount of from 0.05% to 5% by weight, or of from 0.5% to 2% by weight, based on the total weight of the aqueous composition,
wherein the borate-acid buffer exhibits a capacity to buffer at a pH below a point of zero charge of a subterranean formation comprising the hydrocarbons,
wherein the borate-acid buffer exhibits a capacity to buffer at a pH of from 6.0 to 8.0, such as a pH of from 6.0 to 7.5, a pH of from 6.5 to 7.5, a pH of from 6.0 to 7.0, or a pH of from 6.5 to 7.0.

16. The aqueous composition of claim 14, wherein the borate-acid buffer comprises a borate compound and a conjugate base of an acid,
wherein the borate compound comprises sodium tetraborate, calcium tetraborate, sodium borate, sodium metaborate, or any combination thereof,
wherein the conjugate base comprises acetate, citrate, tartrate, succinate, or any combination thereof,
wherein the borate compound and the conjugate base of the organic acid are present at a weight ratio of from 1:1 to 5:1.

17. The aqueous composition of claim 16, wherein the borate-acid buffer comprises a boric acid and an alkali, wherein the alkali comprises an acetate salt, a citrate salt, a tartrate salt, a hydroxide salt, a succinate salt, or any combination thereof.

18. The aqueous composition of claim 1, wherein the temperature is of from 25° C.-150° C., of from 30° C.-150° C., of from 40° C.-150° C., of from 50° C.-150° C., of from 60° C.-150° C., of from 70° C.-150° C., of from 80° C.-150° C., of from 90° C.-150° C., of from 100° C.-150° C., of from 110° C.-150° C., of from 120° C.-150° C., of from 130° C.-150° C., of from 140° C.-150° C., of from 25° C.-120° C., of from 25° C.-100° C., or of from 25° C.-50° C.

19. The aqueous composition of claim 1, wherein the concentration of H₂S is from 0.5 mol %-50 mol %, of from 0.5 mol %-45 mol %, of from 0.5 mol %-40 mol %, of from 0.5 mol %-35 mol %, of from 0.5 mol %-30 mol %, of from 0.5 mol %-25 mol %, of from 0.5 mol %-20 mol %, of from 0.5 mol %-15 mol %, of from 0.5 mol %-10 mol %, of from 0.5 mol %-9 mol %, of from 0.5 mol %-8 mol %, of from 0.5 mol %-7 mol %; of from 0.5 mol %-6 mol %, of from 0.5 mol %-5 mol %, of from 0.5 mol %-4 mol %, of from 0.5 mol %-3 mol %, of from 0.5 mol %-2 mol %, of from 0.5 mol %-1 mol %, of from 5 mol %-20 mol %, or of from 5 mol %-25 mol %.

20. The aqueous composition of claim 1, wherein the aqueous composition is aqueous stable, chemical stable, and thermal stable for at least 7 days.

21. A method for treating a subterranean formation, the method comprising:
injecting an aqueous composition of claim 1 into a subterranean formation through a wellbore in fluid communication with the subterranean formation.

22-49. (canceled)
